(19) United States
(12) Patent Application Publication
(10) Pub. No.: US 2025/0358025 A1
(43) Pub. Date: Nov. 20, 2025

(54) JAMMING RESILIENCE FOR RIS AND REPEATER

(71) Applicant: QUALCOMM Incorporated, San Diego, CA (US)

(72) Inventors: Narayan PRASAD, Westfield, NJ (US); Navid ABEDINI, Basking Ridge, NJ (US); Tao LUO, San Diego, CA (US); Junyi LI, Greentown, PA (US)

(21) Appl. No.: 18/669,441

(22) Filed: May 20, 2024

(51) Int. Cl. H04B 17/20; H04B 17/27

(52) U.S. Cl. CPC H04B 17/204; H04B 17/27

(57) ABSTRACT

The apparatus may be an intermediate wireless device comprising an array of configurable elements (e.g., an array of configurable reflective elements or a plurality of configurable antenna elements) that may be configured to obtain, based on a decreased signal quality at a user equipment (UE), a first set of configurations of a plurality of configurable elements of the intermediate wireless device for a first interference-direction sensing operation, perform, based on the first set of configurations of the plurality of configurable elements, the first interference-direction sensing operation, and obtain an indication of a configuration of the plurality of configurable elements for a subsequent communication between a network device and the UE based on the first interference-direction sensing operation.

### TECHNICAL FIELD

The present disclosure relates generally to communication systems, and more particularly, to wireless communication via an intermediary device.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be an intermediate wireless device comprising an array of configurable elements (e.g., an array of configurable reflective elements or a plurality of configurable antenna elements) that may be configured to obtain, based on a decreased signal quality at a user equipment (UE), a first set of configurations of a plurality of configurable elements of the intermediate wireless device for a first interference-direction sensing operation, perform, based on the first set of configurations of the plurality of configurable elements, the first interference-direction sensing operation, and obtain an indication of a configuration of the plurality of configurable elements for a subsequent communication between a network device and the UE based on the first interference-direction sensing operation.

In an aspect of the disclosure, a method, a computer-readable medium, and an apparatus are provided. The apparatus may be a network device configured to output, based on a decreased signal quality at a UE, a first set of configurations of a plurality of configurable elements of an intermediate wireless device for a first interference-direction sensing operation, obtain, based on the first interference-direction sensing operation, information regarding a directionality of an interfering signal associated with the decreased signal quality at the UE, and output, based on the information regarding the directionality of the interfering signal, an indication of a configuration of the plurality of configurable elements for a subsequent communication between the network device and the UE via the intermediate wireless device.

In an aspect of the disclosure, a method, a computer-readable medium, and an apparatus are provided. The apparatus may be a UE or wireless device configured to obtain, based on a decreased signal quality at the UE, a first set of configurations of a plurality of configurable elements of an intermediate wireless device for a first interference-direction sensing operation, measure, based on the first set of configurations and during the first interference-direction sensing operation, a received signal quality of a communication associated with the first set of configurations, where the communication is between a network device and the UE via the intermediate wireless device, and output an indication of the received signal quality.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating a blockage between a base station and a UE, in accordance with some aspects of the disclosure.

FIG. 4B is a diagram illustrating a communication via a RIS between a base station and a UE associated with a blockage in accordance with some aspects of the disclosure.

FIG. 4C is a diagram illustrating a communication via an NCR between a base station and a UE associated with a blockage in accordance with some aspects of the disclosure.

FIG. 5 illustrates an example in which the RIS includes multiple subsets of multiple RIS elements.

FIG. 6 is a diagram illustrating a repeater in accordance with various aspects of the present disclosure.

FIG. 7 is a diagram illustrating a RIS in the presence of a jamming device in accordance with some aspects of the disclosure.

FIG. 8 is a diagram illustrating an NCR in the presence of a jamming device in accordance with some aspects of the disclosure.

FIG. 9A is diagram illustrating a communication between a base station and a UE via a RIS that is interfered with by a signal from a jamming device in accordance with some aspects of the disclosure.

FIG. 9B is a diagram illustrating a first interference-direction sensing operation triggered by the decreased signal quality in FIG. 9A in accordance with some aspects of the disclosure.

FIG. 9C is a diagram illustrating a second interference-direction sensing operation based on the first interference-direction sensing operation illustrated in FIG. 9B in accordance with some aspects of the disclosure.

FIG. 9D is a diagram illustrating an interference mitigating RIS configuration based on the first interference-direction sensing operation and the second interference-direction sensing operation in accordance with some aspects of the disclosure.

FIG. 10A is diagram illustrating a communication between a base station and a UE via a RIS that is interfered with by a signal from a jamming device in accordance with some aspects of the disclosure.

FIG. 10B is a diagram illustrating a first interference-direction sensing operation triggered by the decreased signal quality in FIG. 10A in accordance with some aspects of the disclosure.

FIG. 10C is a diagram illustrating a second interference-direction sensing operation based on the first interference-direction sensing operation illustrated in FIG. 10B in accordance with some aspects of the disclosure.

FIG. 10D is a diagram illustrating an interference mitigating RIS configuration based on the first interference-direction sensing operation and the second interference-direction sensing operation in accordance with some aspects of the disclosure.

FIG. 11A is diagram illustrating a communication between a base station and a UE via an NCR that is interfered with by a signal from a jamming device in accordance with some aspects of the disclosure.

FIG. 11B is a diagram illustrating a first interference-direction sensing operation based on detecting (at one of the base station, the network, the UE, or the NCR controller) the interfering signal as described in relation to FIG. 11A in accordance with some aspects of the disclosure.

FIG. 11C is a diagram illustrating an interference mitigating NCR configuration based on the first interference-direction sensing operation in accordance with some aspects of the disclosure.

FIG. 12A is diagram illustrating a communication between a base station and a UE via an NCR that is interfered with by a signal from a jamming device in accordance with some aspects of the disclosure.

FIG. 12B is a diagram illustrating a first interference-direction sensing operation based on detecting (at one of the base station, the network, the UE, or the NCR controller) the interfering signal as described in relation to FIG. 12A in accordance with some aspects of the disclosure.

FIG. 12C is a diagram illustrating an interference mitigating NCR configuration based on the first interference-direction sensing operation in accordance with some aspects of the disclosure.

FIG. 12D is a diagram illustrating the use of disjoint resources for the first interference-direction sensing operation in accordance with some aspects of the disclosure.

FIG. 13 is a call flow diagram illustrating a method for mitigating interference from a jamming device for a communication between a base station and a UE via a RIS in accordance with some aspects of the disclosure.

FIG. 14 is a call flow diagram illustrating a method for mitigating interference from a jamming device for a communication between a base station and a UE via a RIS in accordance with some aspects of the disclosure.

FIG. 15 is a call flow diagram illustrating a method for mitigating interference from a jamming device for a communication between a base station and a UE via an NCR in accordance with some aspects of the disclosure.

FIG. 16 is a call flow diagram illustrating a method for mitigating interference from a jamming device for a communication between a base station and a UE via an NCR in accordance with some aspects of the disclosure.

FIG. 17 is a call flow diagram illustrating a method for mitigating interference from a jamming device for a communication between a base station and a UE via an NCR in accordance with some aspects of the disclosure.

FIG. 18 is a call flow diagram illustrating a method for mitigating interference from a jamming device for a communication between a base station and a UE via an NCR in accordance with some aspects of the disclosure.

FIG. 19 is a flowchart of a method of wireless communication.

FIG. 20 is a flowchart of a method of wireless communication.

FIG. 21 is a flowchart of a method of wireless communication.

FIG. 22 is a flowchart of a method of wireless communication.

FIG. 23 is a flowchart of a method of wireless communication.

FIG. 24 is a flowchart of a method of wireless communication.

FIG. 25 is a flowchart of a method of wireless communication.

FIG. 26 is a flowchart of a method of wireless communication.

FIG. 27 is a diagram illustrating an example of a hardware implementation for an example apparatus and/or network entity.

FIG. 28 is a diagram illustrating an example of a hardware implementation for an example network entity.

FIG. 29 is a diagram illustrating an example of a hardware implementation for an example network entity.

FIG. 30 is a diagram illustrating an example of a hardware implementation for an example apparatus and/or network entity.

FIG. 31 is a diagram illustrating an example of a hardware implementation for an example apparatus and/or network entity.

### DETAILED DESCRIPTION

In some aspects of wireless communication, line of sight communication may be interrupted by blockages. Accordingly, in some aspects, intermediate devices such as reconfigurable intelligent surfaces (RISs) and smart repeaters may be used to mitigate blockage problems and expand wireless communication footprints by removing coverage blind-spots. In some aspects, a RIS may be an array of reflecting elements that can be dynamically reconfigured to control the reflection and scattering of electromagnetic waves. A smart repeater, or network-controlled-repeater (NCR), in some aspects, may amplify signals received along some dynamically configured direction and forward the received signals along another dynamically configured desired direction. Both the RIS and the NCR, in some aspects, may reflect (or forward) any signal incident on it and may not have the capability to distinguish between target and interfering incident signals.

In some aspects, a first configuration of a RIS or NCR for avoiding a blockage may be associated with a first direction for reception from a communication source (e.g., a network device) and a second direction for a reflection (or forwarding) to a communication destination. The first configuration, in some aspects, may be associated with additional reception directions. An additional reception direction, in some aspects, may be associated with receiving interfering signals from an additional wireless device (e.g., a wireless or “jamming” device other than the communication source). A second configuration of the RIS or NCR may also be associated with the first direction (or an equivalent third direction) for reception from the communication source and the second direction (or an equivalent fourth direction) for a reflection (or forwarding) to the communication destination but may not be associated with the additional reception direction (e.g., may have a null associated with the additional direction). Accordingly, the second configuration may also avoid the blockage without receiving (and reflecting or forwarding) the interfering signals from the additional wireless device. However, to determine and/or select the second configuration, the network or controller should know the incident signal direction (e.g., a direction associated with the interfering signals) from the jamming device to the RIS or NCR.

Various aspects relate generally to a beam sweeping procedure and signaling for a RIS or NCR to select a beam pattern that maximizes a signal to interference and noise ratio (SINR) at a communication destination (a UE) by reducing the interference from an unknown jamming device (or jammer). Some aspects more specifically relate to multiple options for determining the beam pattern based on measurements for different Rx beam patterns that puts a null or reduces a sidelobe towards a jammer at one of a UE, a network device, or NCR-based measurements. In some examples, an intermediate wireless device comprising an array of configurable elements (e.g., an array of configurable reflective or refractive elements or a plurality of configurable antenna elements) may be configured to obtain, based on a decreased signal quality at a UE, a first set of configurations of a plurality of configurable elements of the intermediate wireless device for a first interference-direction sensing operation, perform, based on the first set of configurations of the plurality of configurable elements, the first interference-direction sensing operation, and obtain an indication of a configuration of the plurality of configurable elements for a subsequent communication between a network device and the UE based on the first interference-direction sensing operation. Similarly, a network device may be configured to output, based on a decreased signal quality at a UE, a first set of configurations of a plurality of configurable elements of an intermediate wireless device for a first interference-direction sensing operation, obtain, based on the first interference-direction sensing operation, information regarding a directionality of an interfering signal associated with the decreased signal quality at the UE, and output, based on the information regarding the directionality of the interfering signal, an indication of a configuration of the plurality of configurable elements for a subsequent communication between the network device and the UE via the intermediate wireless device. Additionally, a UE or wireless device may be configured to obtain, based on a decreased signal quality at the UE, a first set of configurations of a plurality of configurable elements of an intermediate wireless device for a first interference-direction sensing operation, measure, based on the first set of configurations and during the first interference-direction sensing operation, a received signal quality of a communication associated with the first set of configurations, where the communication is between a network device and the UE via the intermediate wireless device, and output an indication of the received signal quality.

Particular aspects of the subject matter described in this disclosure can be implemented to realize one or more of the following potential advantages. In some examples, by determining a beam pattern based on measurements for different Rx beam patterns that puts a null or reduces a sidelobe towards a jammer at one of a UE, a network device, or NCR-based measurements, the described techniques can be used to improve jamming resilience (e.g., to mitigate the effect of interfering signals from a jamming device).

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

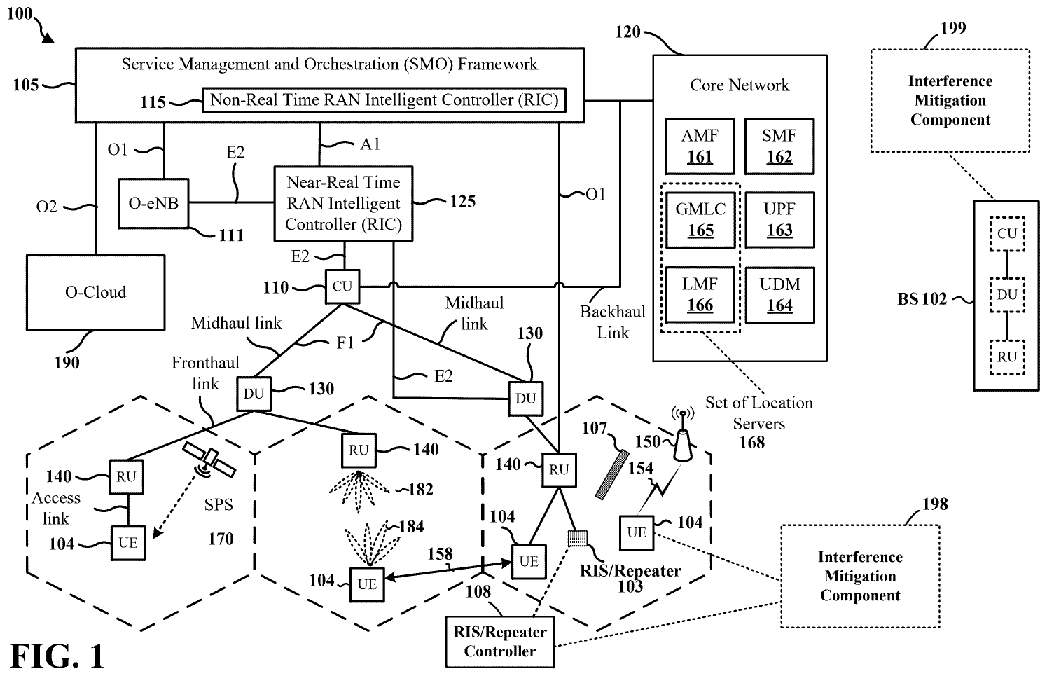

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some aspects, the network may include a reconfiguration intelligent surface (RIS)/repeater 103 that may reflect or forward beamformed (or beam-focused) communication between the RU 140 and a UE 104 to avoid a blockage 107 that blocks a directional beam between the RU 140 (or an associated base station 102) and the UE 104. A RIS is one example of a name for a passive array that reflects or refracts communication between a base station and a UE to control an angle of reflection, e.g., without decoding the communication. In other examples, the RIS may be called a meta-surface, a smart surface, or an intelligent reflecting surface (IRS) and may be related to, or incorporate, meta-devices, or meta-materials (e.g., tunable, active, passive, or programmable meta-materials). A repeater is one example of a name for a device including a plurality of antennas that may be used to receive, amplify, and forward (or transmit) communication between a base station and a UE, e.g., without decoding the communication. In other examples the repeater may be referred to as an NCR, or a receive-amplify-forward device or a smart relaying device. The RIS/repeater 103 may be associated with a RIS/repeater controller 108 (e.g., a mobile termination (MT) such as a RIS-MT or an NCR-MT). Discovery information, such as RIS/repeater capability information and/or position information for the RIS/repeater 103 may be transmitted by the RIS/repeater controller 108, e.g., to a UE 104 via sidelink or to a base station via uplink. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements.

The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an interference mitigation component 198 that may be configured to obtain, based on a decreased signal quality at the UE, a first set of configurations of a plurality of configurable elements of an intermediate wireless device for a first interference-direction sensing operation, measure, based on the first set of configurations and during the first interference-direction sensing operation, a received signal quality of a communication associated with the first set of configurations, where the communication is between a network device and the UE via the intermediate wireless device, and output an indication of the received signal quality. In certain aspects, the RIS/Repeater 103 may have an interference mitigation component 198 that may be configured to obtain, based on a decreased signal quality at a UE, a first set of configurations of a plurality of configurable elements of the intermediate wireless device for a first interference-direction sensing operation, perform, based on the first set of configurations of the plurality of configurable elements, the first interference-direction sensing operation, and obtain an indication of a configuration of the plurality of configurable elements for a subsequent communication between a network device and the UE based on the first interference-direction sensing operation. In certain aspects, the base station 102 may have an interference mitigation component 199 that may be configured to output, based on a decreased signal quality at a UE, a first set of configurations of a plurality of configurable elements of an intermediate wireless device for a first interference-direction sensing operation, obtain, based on the first interference-direction sensing operation, information regarding a directionality of an interfering signal associated with the decreased signal quality at the UE, and output, based on the information regarding the directionality of the interfering signal, an indication of a configuration of the plurality of configurable elements for a subsequent communication between the network device and the UE via the intermediate wireless device. Although the following description may be focused on 5G NR, the concepts described herein may be applicable to other similar areas, such as LTE, LTE-A, CDMA, GSM, and other wireless technologies.

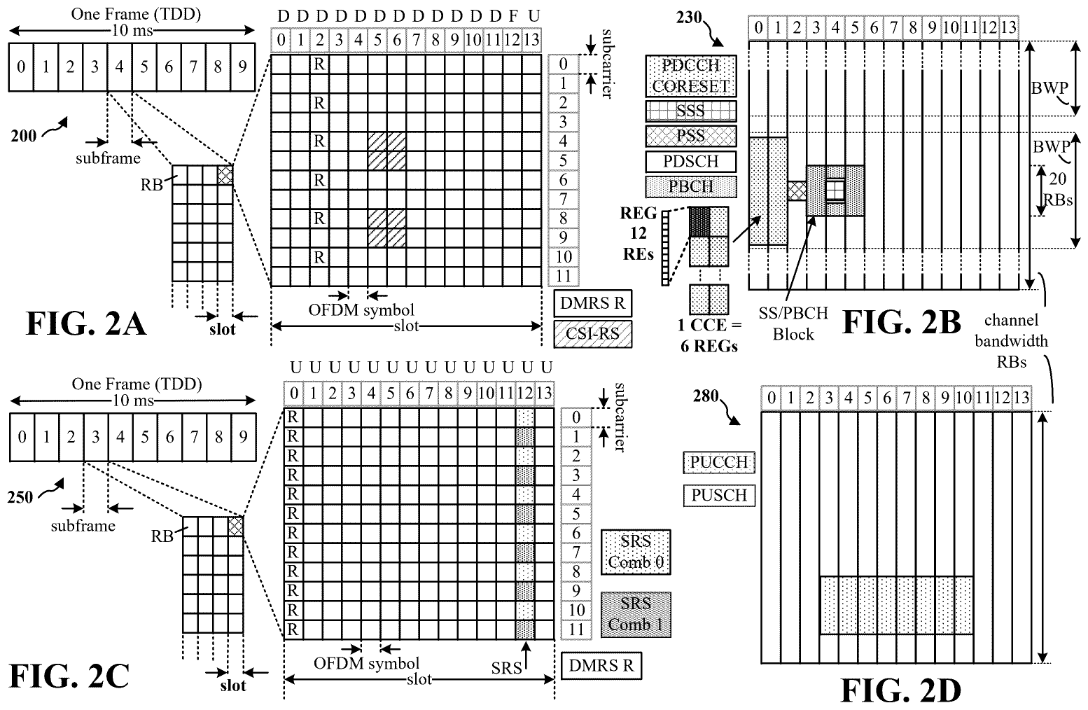

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal. |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

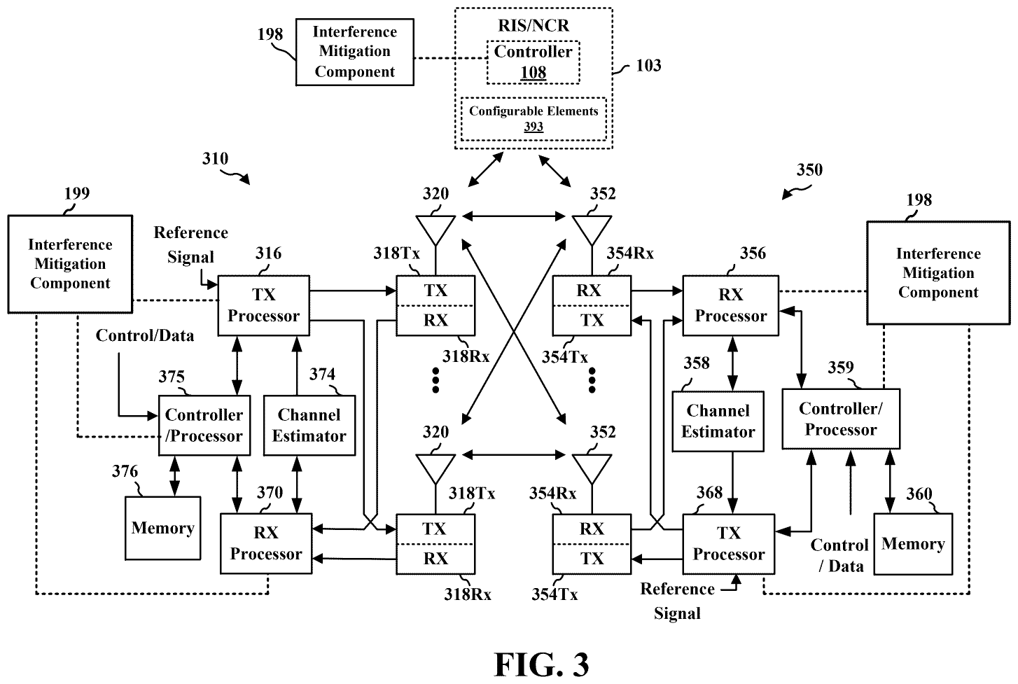

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

FIG. 3 illustrates an example of a RIS/Repeater 103 that is configured to reflect or refract communication between the base station 310 and the UE 350. The RIS/repeater 103 includes a set of configurable elements 393 that are reconfigurable for different incident angles and reflection or refraction angles associated with a RIS or different incident angles, amplifications, and forwarding angles associated with a repeater. The RIS/repeater 103 may also include a RIS/repeater controller 108 that controls the configuration of the set of configurable elements 393 to adjust the reflection or forwarding, e.g., as described in connection with FIG. 1. In some aspects, the RIS/repeater controller 108 may include communication components, e.g., including Tx processor, and Rx processor, and/or a controller processor, such as described for the base station 310 and/or UE 350, in order to receive control signaling regarding the control of the set of configurable elements 393.

At least one of the TX processor 368, the RX processor 356, and the controller/processor 359 may be configured to perform aspects in connection with the interference mitigation component 198 of FIG. 1.

At least one of the TX processor 316, the RX processor 370, and the controller/processor 375 may be configured to perform aspects in connection with the interference mitigation component 199 of FIG. 1.

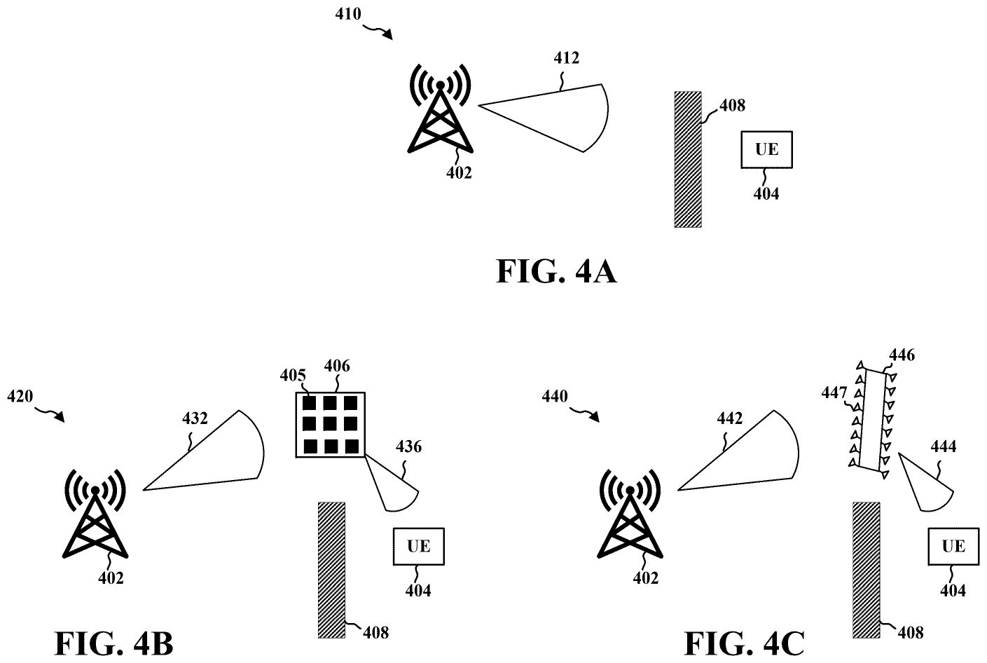

FIG. 4A is a diagram 410 illustrating a blockage 408 between a base station 402 and a UE 404, in accordance with some aspects of the disclosure. Diagram 410 illustrates a blockage 408 that blocks the beam 412 from reception at the UE 404. In order to communicate with the UE 404, in some aspects, the base station 402 may transmit communication via a RIS. In some aspects, a RIS (e.g., RIS 406 of FIG. 4B) may include a large number of uniformly distributed electrically controllable elements (e.g., element 405 also referred to as a configurable element or a RIS element). Each element 405 may have a reconfigurable electromagnetic characteristic, e.g., a reflection or refraction coefficient. Depending on the combination of configured states of each element 405, the RIS 406 may reflect or refract and modify the incident radio waveform in a controlled manner (e.g., by changing a reflected or refracted direction, changing a beam width, etc.). The RIS 406 may function as a near passive device, and the reflection or refraction direction may be controlled by the base station. The RIS 406 may reflect or refract an impinging wave in a direction indicated by the base station to a UE.

A RIS (e.g., the RIS 406) or an NCR (e.g., NCR 446) may be deployed in wireless communication systems, including cellular systems, such as LTE, NR, etc. A RIS or an NCR may alter the channel realization in a controlled manner, which may improve channel diversity. The increased diversity may provide robustness to channel blocking/fading, which may be of particular importance for mmWave communication. Compared to a wireless relay or repeater systems, an RIS may be more cost and energy efficient.

FIG. 4B is a diagram 420 illustrating a communication via a RIS 406 between a base station 402 and a UE 404 associated with a blockage 408 in accordance with some aspects of the disclosure. The base station 402 may control the RIS 406 to extend beam coverage and/or to address blockages (e.g., blockage 408) between the base station 402 and the UE 404. The base station 402 may transmit communication for the UE 404 using a directional beam 432 (which may be referred to as the impinging beam) to the RIS 406 for reflection or refraction over a directional beam 436 to the UE 404. The base station 402 may indicate the directional beam 436 to the RIS 406, and the RIS 406 may reflect or refract the impinging wave associated with directional beam 432 in the direction of the directional beam 436. The RIS 406 may adjust the reflection or refraction of the impinging directional beam 432 based on a set of coefficients (e.g., a phase matrix), indicating a set of configured states (or phases) of the configurable elements (e.g., a state/phase for each element 405) of the RIS 406.

In order to communicate with the UE 404, in some aspects, the base station 402 may transmit communication via an NCR. An NCR (e.g., NCR 446 of FIG. 4C, as an example of a receive-amplify-forward device), in some aspects, may include a large number of antenna elements (e.g., antenna 447). Each element (or a group of elements) may be associated with a processing chain that includes one or more of a low noise amplifier, phase shifter, and power amplifier, and may introduce a phase shift and/or amplification that may be controlled by the network to allow the NCR to generate reception and/or transmission beams with different characteristics.

An NCR (e.g., the NCR 446) may be deployed in wireless communication systems, including cellular systems, such as LTE, NR, etc. An NCR may alter the channel realization in a controlled manner, which may improve channel diversity. The increased diversity may provide robustness to channel blocking/fading, which may be of particular importance for mmWave communication.

FIG. 4C is a diagram 440 illustrating a communication via an NCR 446 between a base station 402 and a UE 404 associated with a blockage 408 in accordance with some aspects of the disclosure. The base station 402 may control the NCR 446 to extend beam coverage and/or to address blockages (e.g., blockage 408) between the base station 402 and the UE 404. The base station 402 may transmit communication for the UE 404 using a directional beam 442 (which may be referred to as the impinging beam) to the NCR 446 for reception, amplification, and forwarding over a directional beam 444 to the UE 404. The base station 402 may indicate the directional beam 444 to the NCR 446, and the NCR 446 may receive, amplify, and forward the impinging wave associated with directional beam 442 in the direction of the directional beam 444. The NCR 446 may adjust the reception, amplification, and forwarding of the impinging directional beam 442 based on a set of coefficients indicating a set of configured states of the antenna elements (e.g., a set of values for amplifications and phase shifts of the antenna elements) of the NCR 446.

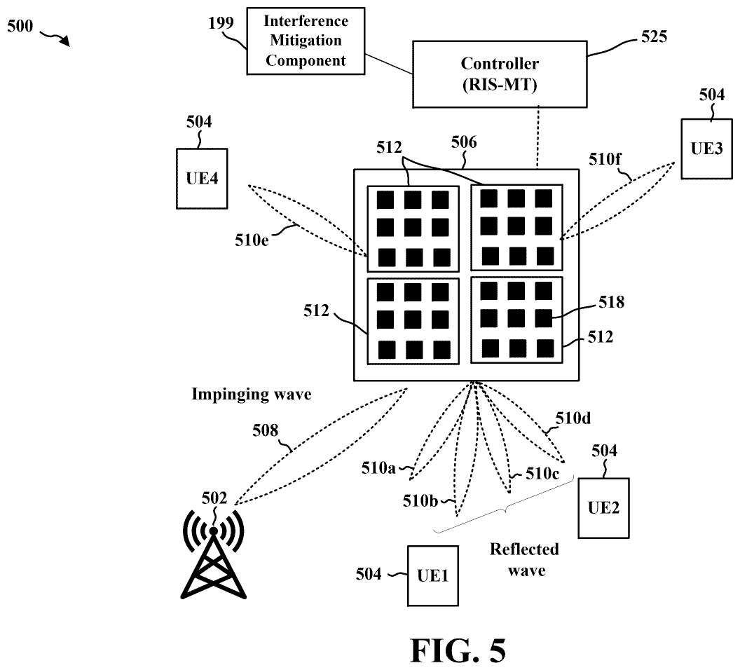

FIG. 5 is a diagram 500 illustrating an example in which the RIS 506 includes multiple subsets 512 of multiple RIS elements 518. As illustrated, different subsets 512 of RIS elements 518 may serve different UEs 504. Accordingly, the different subsets 512 of multiple RIS elements 518 may be configured differently to adjust the reflected or refracted direction, the beam width, or other characteristics of the impinging wave 508, and in some aspects, may each be considered as a separate/independent RIS. The RIS elements 518 may be controlled by a controller 525 (including the interference mitigation component 199 as illustrated in FIG. 1) at the RIS 506 based on control information received by the base station 502. As described in connection with FIG. 4B, the base station 502 may indicate a beam direction (e.g., any of beam direction 510a, beam direction 510b, beam direction 510c, beam direction 510d, beam direction 510c, or beam direction 510f) to the RIS for reflecting or refracting beamformed communication received as the impinging wave 508 to a particular UE 504 in a particular direction. The RIS may similarly be controlled by a UE for reflecting or refracting communication from the UE to a base station and/or to another UE. The following discussion may refer primarily to reflection from a RIS, however, it is to be understood that the term reflection includes both reflection and refraction where the single term is used for convenience and is not intended to be limiting.

In some aspects, a RIS controller (or RIS mobile termination (RIS-MT)) such as controller 525 may have a limited capacity (e.g., compared to the RIS) to assume different configurations. For example, there may be fewer configurable antenna elements associated with the controller 525 than there are configurable reflective or refractive elements associated with the RIS 506. Accordingly, a controller may be used to perform a first (or preliminary) sweep over a set of broad beams and/or lobes (e.g., a configuration associated with a relatively moderate-to-high gain over a larger range of angles compared to a smaller range of angles associated with the relatively high gain associated with narrow beams and/or lobes that may be associated with configurations of the array of configurable reflective or refractive elements of the RIS).

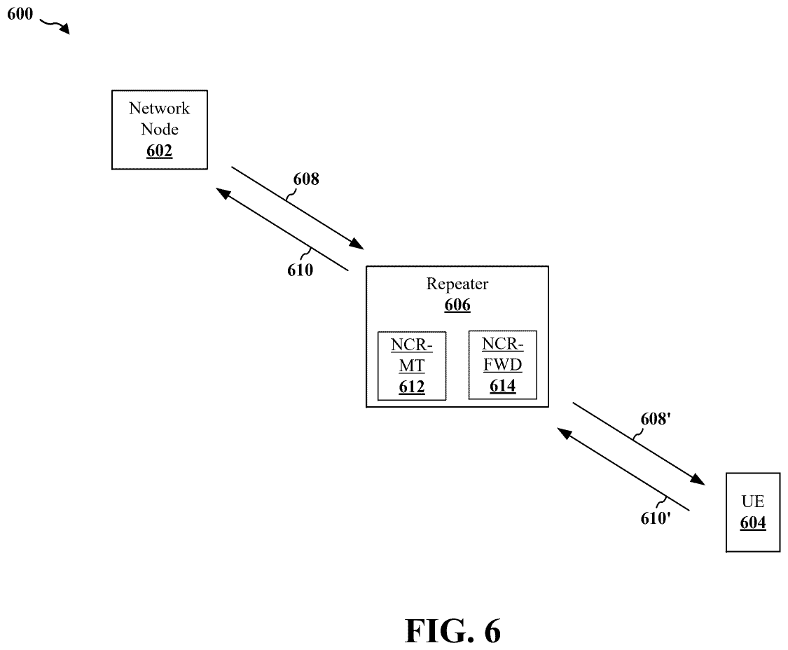

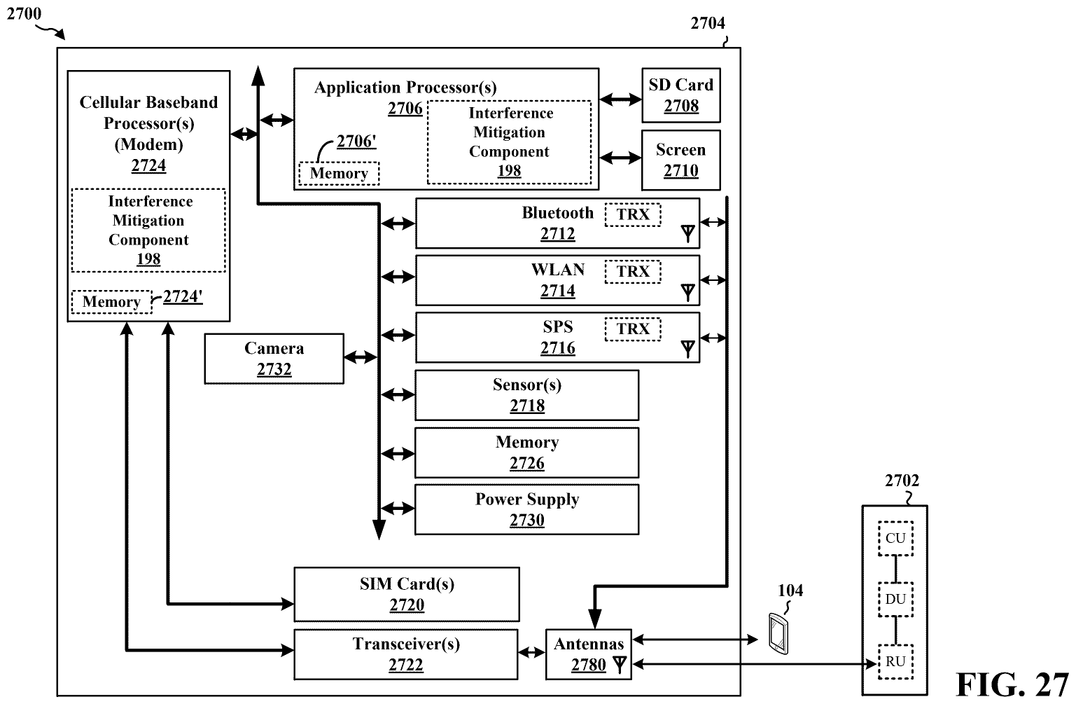

A repeater (e.g., a network-controlled repeater (NCR)) may be used to forward positioning references used for positioning of a remote UE. FIG. 6 is a diagram 600 illustrating a repeater 606 in accordance with various aspects of the present disclosure. As shown in FIG. 6, the repeater 606 may include a mobile termination node (NCR-MT) 612 and a forwarding node (NCR-FWD) 614. The mobile termination node 612 may be a component of the repeater 606 that maintains the control link (C-link) between a network node 602 and the repeater 606 to enable information exchanges (e.g., side control information). The mobile termination node 612 may include a communication interface (e.g., a modem, such as the cellular baseband processor 2724 described with reference to FIG. 27) by which the network node 602 may control and/or configure the repeater 606, e.g., via commands or control information provided via the communication interface. The mobile termination node 612 may also support NR-based positioning. The forwarding node 614 may be a component of the repeater 606 that maintains a backhaul link between the network node 602 and the repeater 606 and an access link between the repeater 606 and the UE 604. The forwarding node 614 may include a plurality of antennas, such as antenna elements, antenna panels, and/or antenna arrays, for transmitting and receiving RF signals.

In some aspects, the mobile termination node 612 and the forwarding node 614 may be co-located. For example, the mobile termination node 612 and the forwarding node 614 may be included within a same device housing. In another example, the mobile termination node 612 and the forwarding node 614 may be located within the same room. In other aspects, the mobile termination node 612 and the forwarding node 614 may not be co-located. For example, the mobile termination node 612 and the forwarding node 614 may be included in different device housings. In another example, the mobile termination node 612 may be located on a first floor of a building, and the forwarding node 614 may be located on a second floor of the building. The forwarding node 614 may receive downlink signals 608 from a network node 602 and forward the downlink signals (shown as downlink signals 608′) to a remote UE 604. Similarly, the forwarding node 614 may receive uplink signals 610 from the remote UE 604 and forward the uplink signals (shown as signals 610′) to the network node 602. While the repeater 606 just forwards the downlink signals 608 (e.g., with no or minimal processing), and hence the network node 602 (e.g., a gNB) may be the logical source/destination of downlink/uplink signals, the repeater 606 may be considered as the physical source/destination for positioning purposes.

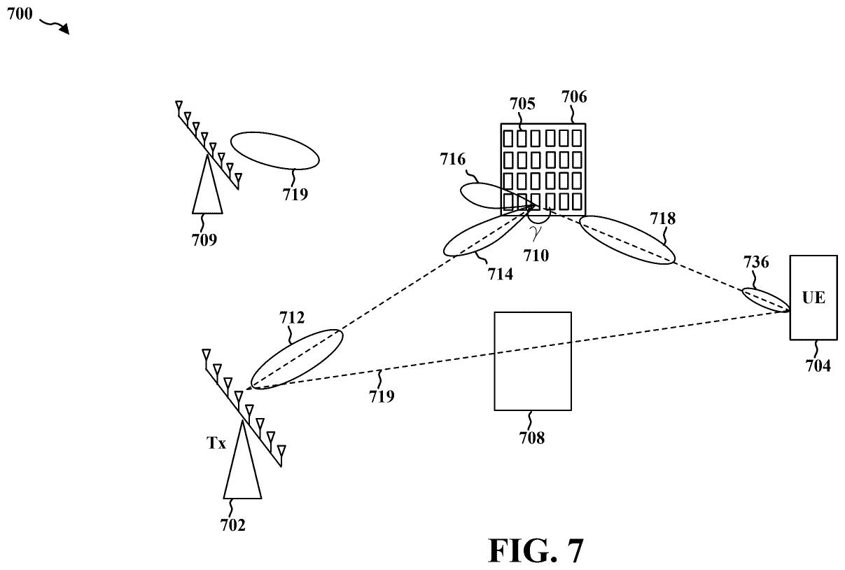

FIG. 7 is a diagram 700 illustrating a RIS 706 in the presence of a jamming device 709 in accordance with some aspects of the disclosure. A line of sight between a base station 702 and a UE 704 may be blocked by a blockage 708. In some aspects, the configuration of the configurable reflective elements 705 of the RIS 706 may be designed to maximize (or optimize) a gain for a target reflection (e.g., a reflection of a transmitted signal from the base station 702 to the UE 704 via the RIS 706). For example, the configuration of the configurable reflective elements 705 may be designed and/or selected to maximize the gain for a signal transmitted from the base station 702 along a beam direction 712 and received at the UE 704 via a beam direction 736 based on a reflection from the RIS 706 associated with a main lobe and/or a direction 718. In some aspects, a RIS configuration may be associated with a set of beam directions each corresponding to a different gain. For example, a first configuration of the RIS 706 may be associated with a main lobe and/or direction 714 (e.g., a direction associated with a relatively high receive power and/or gain) and at least one side lobe and/or direction 716 (e.g., a direction associated with a relatively high receive power and/or gain that may be lower than the power and/or gain associated with the main lobe and/or direction 714). Signals impinging on the RIS 706 may be reflected by an angle γ 710 and/or along a main lobe and/or a direction 718 (e.g., a direction associated with a relatively high reflected power).

While communication between the base station 702 and the UE 704 is ongoing, a jamming device 709 may begin transmitting a signal associated with a beam direction 719 that impinges on the RIS in alignment with the at least one side lobe and/or direction 716 in a way that interferes with (e.g., reduces a SINR or reference signal received quality (RSRQ) for) the communication between the base station 702 and the UE 704. The configuration of the RIS 706 may be adjusted, modified, and/or updated to ensure that the signal from the jamming device 709 is not reflected with high gain towards the UE 704.

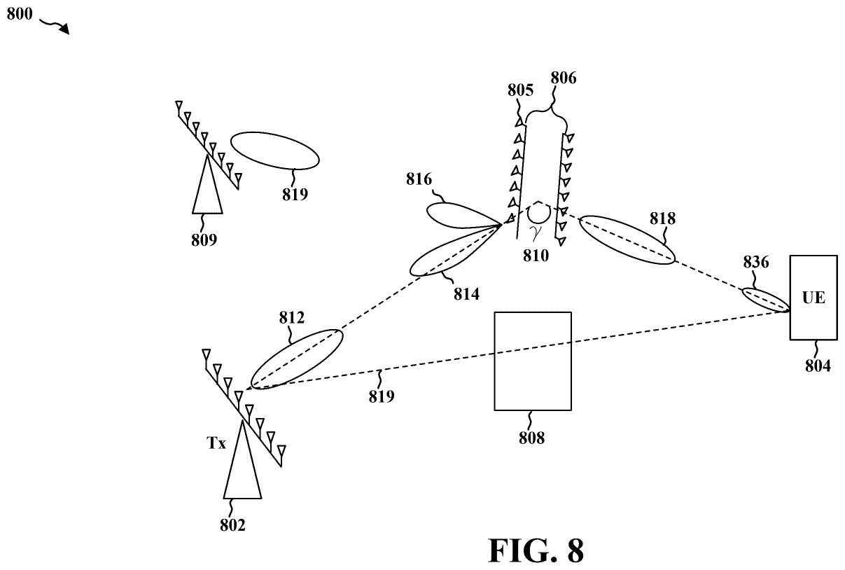

FIG. 8 is a diagram 800 illustrating an NCR 806 in the presence of a jamming device 809 in accordance with some aspects of the disclosure. A line of sight between a base station 802 and a UE 804 may be blocked by a blockage 808. In some aspects, the configuration of the NCR 806 (e.g., a configuration of the configurable antenna elements 805) may be designed to receive a signal from the base station 802. In some aspects, the number of NCR receive antennas may be reduced for improved energy efficiency. For example, if the SINR of a (backhaul) connection between the base station 802 and the NCR 806 using a first number of configurable antenna elements (e.g., configurable antenna elements 805) is much greater than an SINR of a connection (an access connection) between the NCR 806 and the UE 804, the number of antennas may be reduced until the SINR for the (backhaul) connection is matched to the SINR for the (access) connection without compromising end-to-end SINR (an SINR of the repeated signal).

In some aspects, the configuration of the NCR 806 may be designed to maximize (or optimize) a gain for a repeated (e.g., a received, amplified, and forwarded) signal from the base station 802 to the UE 804 via the NCR 806). For example, the configuration of the configurable antenna elements 805 may be designed and/or selected to maximize the gain for a signal transmitted from the base station 802 along a beam direction 812 and received at the UE 804 via a main lobe and/or a direction 836 based on a forwarded signal from the NCR 806 along a main lobe and/or a direction 818. In some aspects, an NCR configuration may be associated with a set of beam directions each corresponding to a different gain. For example, a first configuration of the NCR 806 may be associated with a main lobe and/or a direction 814 (e.g., a direction associated with a relatively high receive power and/or gain) and at least one side lobe and/or a direction 816 (e.g., a direction associated with a relatively high receive power and/or gain that may be lower than the power and/or gain associated with the main lobe and/or direction 814). Signals impinging on the NCR 806 may be received and forwarded with a relative angular shift, y 810, and/or along a main lobe and/or a direction 818 (e.g., a direction associated with a relatively high transmitted and/or forwarded power).

While communication between the base station 802 and the UE 804 is ongoing, a jamming device 809 may begin transmitting a signal associated with a beam direction 819 that impinges on the NCR in alignment with the side lobe and/or a direction 816 in a way that interferes with (e.g., reduces a SINR or reference signal received quality (RSRQ) for) the communication between the base station 802 and the UE 804. The configuration of the NCR 806 may be adjusted, modified, and/or updated to ensure that the signal from the jamming device 809 is not reflected with high gain towards the UE 804. For example, jammer resilience at an NCR may be achieved by placing nulls of an NCR receive beam (e.g., a direction associated with zero, or near-zero, gain) along an incident direction from a jammer, while maintaining a main lobe and/or direction along a target source direction (e.g., a direction of the base station). In some aspects, the quality of null placement (e.g., the ability to adjust the angle associated with the null and/or the reduction/suppression in the gain associated with the null) by, or at, an NCR may be proportional to, or based on, a number of activated receive antennas (e.g., configurable antenna elements used to generate the receive beam). However, the increased number of configurable antenna elements may also reduce energy efficiency (e.g., may be associated with increased power consumption). Accordingly, an interference mitigating configuration of the NCR may be based on balancing the reduction in the strength of the interference against the increased power consumption.

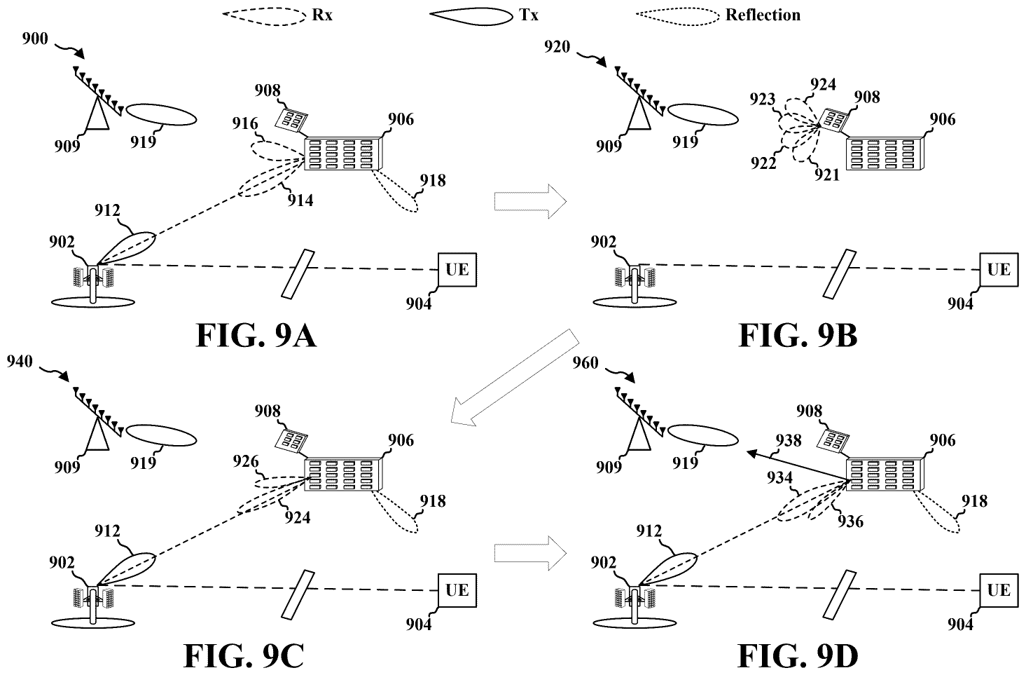

FIG. 9A is diagram 900 illustrating a communication between a base station 902 and a UE 904 via a RIS 906 that is interfered with by a signal from a jamming device 909 in accordance with some aspects of the disclosure. For example, the base station 902 may transmit a signal via a first beam and/or direction 912 while the jamming device 909 may transmit a signal via a beam and/or a direction 919. The RIS may be configured with a first configuration to maximize (or optimize) a gain from the base station 902 to the UE 904 such that a main or primary lobe may be associated with a beam and/or direction 914 with a side or secondary lobe associated with a side lobe and/or direction 916 as described in relation to FIG. 7 such that the main lobe receives the signal from the base station 902 while the side lobe receives the signal from the jamming device 909. The combined signal may be reflected along the beam and/or direction 918 for reception at the UE 904. The UE 904 may receive the reflected signal and may attempt to decode the signal and/or to measure the received signal. Based on the attempted decoding and/or measurement, the UE 904 may identify and/or detect a decreased signal quality (e.g., a decreased SINR or RSRQ) resulting from the interference of the jamming device. The UE 904 may transmit an indication of the decreased signal to the base station 902 to trigger an update and/or modification of the RIS configuration.

FIG. 9B is a diagram 920 illustrating a first interference-direction sensing operation triggered by the decreased signal quality in FIG. 9A in accordance with some aspects of the disclosure. In some aspects, the first interference-direction sensing operation (e.g., a beam sweeping operation) may use a plurality of (configurable) antenna elements of a RIS-MT or a RIS controller 908 capable of receiving and measuring transmitted signals. The RIS controller 908 may receive an indication of a first set of configurations of the plurality of configurable antenna elements. In some aspects, the first set of configurations may include a configuration with a main lobe in each of a plurality of directions (e.g., a main lobe in each of direction 921, direction 922, direction 923, and direction 924). The first set of configurations, in some aspects, may be based on the first configuration described in relation to FIG. 9A. For example, the directions 921-924 may be selected based on side lobes of the first configuration experiencing the interference from the jamming device. The RIS controller 908 may measure a signal strength associated with each configuration (or main lobe) in the first set of configurations (e.g., in the absence of transmissions and/or signals from the base station 902). Based on the measured signal strengths, the RIS controller 908 may identify and/or determine one or more potential directions associated with the jamming signal from the jamming device 909. For example, directions associated with a power that is above a threshold value may be identified as potential directions associated with the jamming signal. In some aspects, the first set of configurations may be associated with a set of resources (frequency and/or time resources) that do not interfere with the communication between the base station 902 and the UE 904. Additionally, or alternatively, the first interference-direction sensing operation may measure a power associated with a set of frequency bands and identify and/or determine the frequency bands that are associated with a power above a threshold value (e.g., a threshold power value that may be different from (or lower than) the threshold power value used for identifying and/or determining the one or more potential directions). In some aspects, the first interference-direction sensing operation, may be configured to be performed for periodic measurement and/or sensing windows to detect a jamming and/or interfering signal. For example, the RIS controller 908 may be configured to periodically determine if the RIS controller 908 detects, via a configured set of resources and receive beam directions, a signal with a power above a threshold power (or a BH SINR below a threshold value) and to transmit an indication of the detected interfering signal and, in some aspects, an associated direction (where the direction may be a range associated with a broad lobe of a reception beam).

In some aspects, the first set of configurations may further be based on a known location and/or position of the jamming device 909, or a set of potential jamming devices including the jamming device 909, e.g., relative to the base station 902 and/or the RIS 906. The first interference-direction sensing operation, in some aspects, may be omitted based on the known relative location and/or position of the jamming device 909 to identify and/or determine that the side lobe and/or direction 916 is associated with the interference-direction of the jamming device.

FIG. 9C is a diagram 940 illustrating a second interference-direction sensing operation based on the first interference-direction sensing operation illustrated in FIG. 9B in accordance with some aspects of the disclosure. In some aspects, the second interference-direction sensing operation (e.g., a beam sweeping operation) may use a plurality of (configurable) reflective elements of the RIS 906. The RIS controller 908 may receive an indication of a second set of configurations of the plurality of configurable reflective elements. In some aspects, each configuration in the second set of configurations may be associated with a main (incident) lobe in the direction of the base station 902 and a main (reflected) lobe in the direction of the UE 904 with different configurations of side lobes (e.g., a set of side lobes in different directions including, for example, a side lobe 926 that may be different from the side lobe and/or direction 916 associated with the first configuration experiencing the interference). The different configurations of side lobes, in some aspects, may include narrower beams associated with reception and/or nulls (e.g., directions associated with a zero, or near-zero, gain). The different configurations of side lobes, in some aspects, may be used to more accurately identify the direction associated with the jamming signal.

The UE 904 may, based on receiving and/or obtaining an indication of the second set of configurations, measure one or more reflected signals (e.g., an SINR or RSRQ) associated with the configurations in the second set of configurations. The UE 904 may report the measurements (or other information relating to an SINR being above, or below, a threshold SINR) associated with the configurations in the second set of configurations to the base station 902.

FIG. 9D is a diagram 960 illustrating an interference mitigating RIS configuration based on the first interference-direction sensing operation and the second interference-direction sensing operation in accordance with some aspects of the disclosure. Based on the first and second interference-direction sensing operations, the base station 902 (or the network) may determine a RIS configuration to maximize (or optimize) a signal quality (e.g., an SINR) for a target reflection (e.g., a reflection of a transmitted signal from the base station 902 to the UE 904 via the RIS 906). In some aspects, the RIS configuration (e.g., a configuration for a plurality of configurable reflective elements of the RIS) may not be one of the configurations in the second set of configurations. For example, the RIS configuration may be associated with set of incidence and/or reception lobes and/or directions, such as a main lobe in a first direction 934 towards the base station 902, one or more side lobes (e.g., in a second direction 936 not towards the jamming device 909), and a null in a direction 938 towards the jamming device 909. The RIS configuration may further include a reflection lobe and/or direction associated with a main lobe in a direction 918 towards the UE 904.

In some aspects, along with updating the RIS configuration, the base station 902 may adjust scheduling and/or resource usage (e.g., may adjust time and/or frequency resources) to avoid the resources associated with the jamming signals. In some aspects, the base station may also increase a transmit power to increase the relative strength of the signal (e.g., to increase the SINR).

While some aspects are discussed above, other options for some of the operations may be possible. For example, the interference mitigation (or jamming resolution) procedure may be initiated by the RIS-MT and/or RIS controller 908 instead of being initiated and/or triggered by a drop in the SINR measured at the UE 904. In some aspects, the RIS-MT and/or RIS controller 908 may be provided with some periodic measurement and/or sensing windows, and if it identifies or detects a jamming signal with a power beyond some configured threshold (or if the backhaul (BH) SINR associated with the communication from the base station 902 to the RIS-MT and/or RIS controller 908 goes below a threshold), it may indicate for the base station 902 to initiate the interference mitigation (or jamming resolution) procedure. In some aspects the RIS controller 908 may try to autonomously find a better RIS configuration.

The RIS-MT and/or RIS controller 908, in some aspects, may provide additional information to the base station 902 and/or network. For example, the RIS-MT and/or RIS controller 908 may report measurements of a “jamming” signal to the base station 902 and/or the network and may get some assistance information from the base station and/or network on how to initiate or address self-resolution of the jamming issue. As discussed above, in some aspects, the jamming device 909 may be known to the base station 902 and/or the network (e.g., the jamming device 909 may be another cell/TRP belonging to same or a neighboring base station) so a network entity may attempt to mitigate the problem via BH coordination instead of jammer avoidance. As discussed above, in some aspects, the direction and/or strengths of the jamming signals may be known to the base station 902 and/or the network and the network may indicate a null-forming configuration (or pattern) for the RIS 906 (e.g., indicating a direction associated with a null of the null-forming configuration and a relative gain compared to a direction towards the base station 902).

Additionally, in some aspects, the RIS-MT and/or RIS controller 908 may collect, and provide to the base station 902 and/or the network, jamming statistics associated with one or more timescales, where the jamming statistics may relate to which directions, which time resources, and/or which frequency resources experience interference greater than some configured threshold. The threshold may be configured by a network entity, and the configuration for the RIS illustrated in FIG. 9D and the resources used for the transmissions from the base station 902 may be based on the jamming statistics as well as the first and second interference-direction sensing operations. In some aspects, the RIS controller 908 may, indicate a possible and/or suggested configuration for the RIS and/or scheduling for the communication (e.g., indicated time and/or frequency resources) based on the jamming statistics and/or the first interference-direction sensing operation to the base station 902 and/or the network. For example, the RIS controller 908, in some aspects, may suggest using a set of time and/or frequency resources for communication between the base station 902 and the UE 904 that are not associated with interference above the threshold value. Additionally, or alternatively, the RIS controller 908 may indicate and/or suggest an increased transmission power (e.g., by ‘X’ dB) from the base station 902 to, at least partially, compensate for the interference introduced by the jamming device 909.

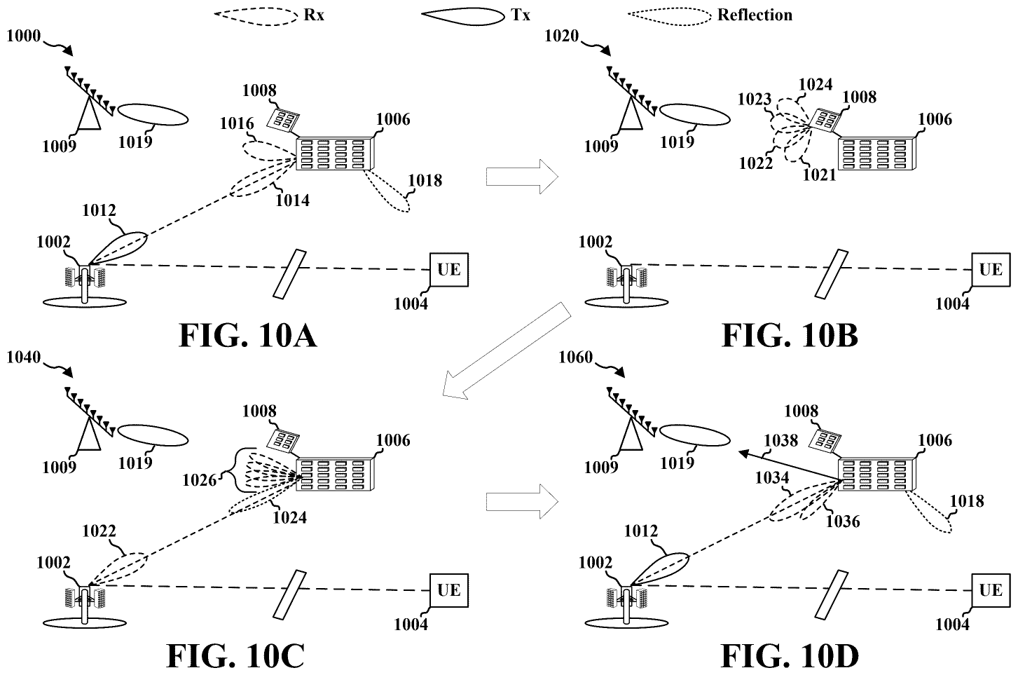

FIG. 10A is diagram 1000 illustrating a communication between a base station 1002 and a UE 1004 via a RIS 1006 that is interfered with by a signal from a jamming device 1009 in accordance with some aspects of the disclosure. For example, the base station 1002 may transmit a signal via a first beam and/or direction 1012 while the jamming device 1009 may transmit a signal via a beam and/or a direction 1019. The RIS may be configured with a first configuration to maximize (or optimize) a gain from the base station 1002 to the UE 1004 such that a main or primary lobe may be associated with a beam and/or direction 1014 with a side or secondary lobe associated with a side lobe and/or direction 1016 as described in relation to FIG. 7 such that the main lobe receives the signal from the base station 1002 while the side lobe receives the signal from the jamming device 1009. The combined signal may be reflected along the beam and/or direction 1018 for reception at the UE 1004. The UE 1004 may receive the reflected signal and may attempt to decode the signal and/or to measure the received signal. Based on the attempted decoding and/or measurement, the UE 1004 may identify and/or detect a decreased signal quality (e.g., a decreased SINR or RSRQ) resulting from the interference of the jamming device. The UE 1004 may transmit an indication of the decreased signal to the base station 1002 to trigger an update and/or modification of the RIS configuration.

FIG. 10B is a diagram 1020 illustrating a first interference-direction sensing operation triggered by the decreased signal quality in FIG. 10A in accordance with some aspects of the disclosure. In some aspects, the first interference-direction sensing operation (e.g., a beam sweeping operation) may use a plurality of (configurable) antenna elements of a RIS-MT or a RIS controller 1008 capable of receiving and measuring transmitted signals. The RIS controller 1008 may receive an indication of a first set of configurations of the plurality of configurable antenna elements. In some aspects, the first set of configurations may include a configuration with a main lobe in each of a plurality of directions (e.g., a main lobe in each of direction 1021, direction 1022, direction 1023, and direction 1024). The first set of configurations, in some aspects, may be based on the first configuration described in relation to FIG. 10A. For example, the directions 1021-924 may be selected based on side lobes of the first configuration experiencing the interference from the jamming device. The RIS controller 1008 may measure a signal strength associated with each configuration (or main lobe) in the first set of configurations (e.g., in the absence of transmissions and/or signals from the base station 1002). Based on the measured signal strengths, the RIS controller 1008 may identify and/or determine one or more potential directions associated with the jamming signal from the RIS 1006. For example, directions associated with a power that is above a threshold value may be identified as potential directions associated with the jamming signal. In some aspects, the first set of configurations may be associated with a set of resources (frequency and/or time resources) that do not interfere with the communication between the base station 1002 and the UE 1004. Additionally, or alternatively, the first interference-direction sensing operation may measure a power associated with a set of frequency bands and identify and/or determine the frequency bands that are associated with a power above a threshold value (e.g., a threshold power value that may be different from (or lower than) the threshold power value used for identifying and/or determining the one or more potential directions). In some aspects, the first interference-direction sensing operation, may be configured to be performed for periodic measurement and/or sensing windows to detect a jamming and/or interfering signal. For example, the NCR controller 1108 may be configured to periodically determine if the NCR controller 1108 detects, via a configured set of resources and receive beam directions, a signal with a power above a threshold power (or a BH SINR below a threshold value) and to transmit an indication of the detected interfering signal and, in some aspects, an associated direction (where the direction may be a range associated with a broad lobe of a reception beam).

In some aspects, the first set of configurations may further be based on a known location and/or position of the jamming device 1009, or a set of potential jamming devices including the jamming device 1009, e.g., relative to the base station 1002 and/or the RIS 1006. The first interference-direction sensing operation, in some aspects, may be omitted based on the known relative location and/or position of the jamming device 1009 to identify and/or determine that the side lobe and/or direction 1016 is associated with the interference-direction of the jamming device.

FIG. 10C is a diagram 1040 illustrating a second interference-direction sensing operation based on the first interference-direction sensing operation illustrated in FIG. 10B in accordance with some aspects of the disclosure. In some aspects, the second interference-direction sensing operation (e.g., a beam sweeping operation) may use a plurality of (configurable) reflective elements of the RIS 1006. The RIS controller 1008 may receive an indication of a second set of configurations of the plurality of configurable reflective elements. In some aspects, each configuration in the second set of configurations may be associated with a main (incident) lobe in the possible direction of the jamming device 1009 (e.g., a main lobe in the set of lobes and/or directions 1026) and a main (reflected) lobe (e.g., the lobe and/or direction 1024) in the direction of the base station 1002. The different configurations of main (incident) lobes, in some aspects, may include narrower beams associated with reception and/or nulls (e.g., directions associated with a zero, or near-zero, gain). The different configurations of main (incident) lobes, in some aspects, may be used to more accurately identify the direction associated with the jamming signal. The base station 1002 may, based on the second set of configurations, measure one or more reflected signals (e.g., an SINR or RSRQ) associated with the configurations in the second set of configurations.

In some aspects, the second interference-direction sensing operation may be performed so as not to interrupt the communication between the base station 1002 and the UE 1004. For example, the second interference-direction sensing operation may be performed on resources (e.g., time and/or frequency resources) that are distinct from the resources used for the communication.

FIG. 10D is a diagram 1060 illustrating an interference mitigating RIS configuration based on the first interference-direction sensing operation and the second interference-direction sensing operation in accordance with some aspects of the disclosure. Based on the first and second interference-direction sensing operations, the base station 1002 (or the network) may determine a RIS configuration to maximize (or optimize) a signal quality (e.g., an SINR) for a target reflection (e.g., a reflection of a transmitted signal from the base station 1002 to the UE 1004 via the RIS 1006). In some aspects, the RIS configuration (e.g., a configuration for a plurality of configurable reflective elements of the RIS) may not be one of the configurations in the second set of configurations. For example, the RIS configuration may be associated with set of incidence and/or reception lobes and/or directions, such as a main lobe in a first direction 1034 towards the base station 1002, one or more side lobes (e.g., in a second direction 1036 not towards the jamming device 1009), and a null in a direction 1038 towards the jamming device 1009. The RIS configuration may further include a reflection lobe and/or direction associated with a main lobe in a direction 1018 towards the UE 1004.

In some aspects, along with updating the RIS configuration, the base station 1002 may adjust scheduling and/or resource usage (e.g., may adjust time and/or frequency resources) to avoid the resources associated with the jamming signals. In some aspects, the base station may also increase a transmit power to increase the relative strength of the signal (e.g., to increase the SINR).

While some aspects are discussed above, other options for some of the operations may be possible. For example, the interference mitigation (or jamming resolution) procedure may be initiated by the RIS-MT and/or RIS controller 1008 instead of being initiated and/or triggered by a drop in the SINR measured at the UE 1004. In some aspects, the RIS-MT and/or RIS controller 1008 may be provided with some periodic measurement and/or sensing windows, and if it identifies or detects a jamming signal with a power beyond some configured threshold (or if the backhaul (BH) SINR associated with the communication from the base station 1002 to the RIS-MT and/or RIS controller 1008 goes below a threshold), it may indicate for the base station 1002 to initiate the interference mitigation (or jamming resolution) procedure. In some aspects the RIS controller 1008 may try to autonomously find a better RIS configuration.

The RIS-MT and/or RIS controller 1008, in some aspects, may provide additional information to the base station 1002 and/or network. For example, the RIS-MT and/or RIS controller 1008 may report measurements of a “jamming” signal to the base station 1002 and/or the network and may get some assistance information from the base station and/or network on how to initiate or address self-resolution of the jamming issue. As discussed above, in some aspects, the jamming device 1009 may be known to the base station 1002 and/or the network (e.g., the jamming device 1009 may be another cell/TRP belonging to same or a neighboring base station) so a network entity may attempt to mitigate the problem via BH coordination instead of jammer avoidance. As discussed above, in some aspects, the direction and/or strengths of the jamming signals may be known to the base station 1002 and/or the network and the network may indicate a null-forming configuration (or pattern) for the RIS 1006 (e.g., indicating a direction associated with a null of the null-forming configuration and a relative gain compared to a direction towards the base station 1002).

Additionally, in some aspects, the RIS-MT and/or RIS controller 1008 may collect, and provide to the base station 1002 and/or the network, jamming statistics associated with one or more timescales, where the jamming statistics may relate to which directions, which time resources, and/or which frequency resources experience interference greater than some configured threshold. The threshold may be configured by a network entity, and the configuration for the RIS illustrated in FIG. 10D and the resources used for the transmissions from the base station 1002 may be based on the jamming statistics as well as the first and second interference-direction sensing operations. In some aspects, the RIS controller 1008 may, indicate a possible and/or suggested configuration for the RIS and/or scheduling for the communication (e.g., indicated time and/or frequency resources) based on the jamming statistics and/or the first interference-direction sensing operation to the base station 1002 and/or the network. For example, the RIS controller 1008, in some aspects, may suggest using a set of time and/or frequency resources for communication between the base station 1002 and the UE 1004 that are not associated with interference above the threshold value. Additionally, or alternatively, the RIS controller 1008 may indicate and/or suggest an increased transmission power (e.g., by ‘X’ dB) from the base station 1002 to, at least partially, compensate for the interference introduced by the jamming device 1009.

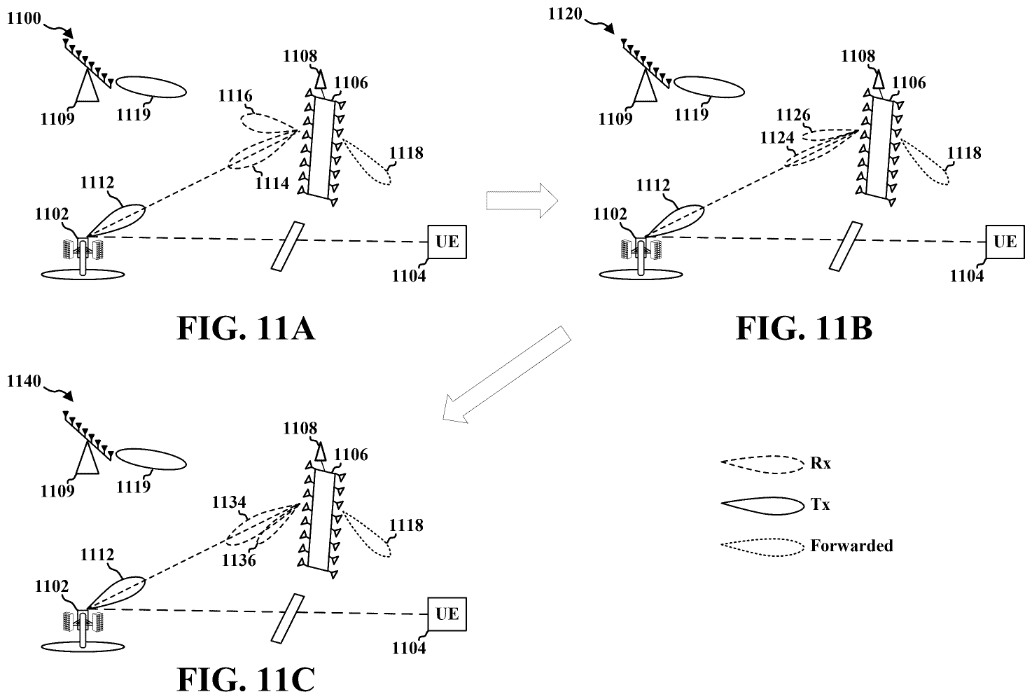

FIG. 11A is diagram 1100 illustrating a communication between a base station 1102 and a UE 1104 via an NCR 1106 that is interfered with by a signal from a jamming device 1109 in accordance with some aspects of the disclosure. For example, the base station 1102 may transmit a signal via a first beam and/or direction 1112 while the jamming device 1109 may transmit a signal via a beam and/or a direction 1119. The NCR configuration may be a first configuration designed to maximize (or optimize) a gain for a repeated (e.g., a received, amplified, and forwarded) signal from the base station 1102 to the UE 1104 via the NCR 1106). In some aspects, the first configuration may use a first (minimized) number of configurable antenna elements of the NCR 1106 (or an NCR-FWD component of the NCR 1106) selected to provide an acceptable SINR (e.g., a BH SINR) while minimizing the total energy consumption (e.g., minimizing the total number of configurable antenna elements). The first configuration, in some aspects, may be associated with a main or primary (reception) lobe associated with a lobe and/or direction 1114 and with a side (or secondary) lobe associated with a side lobe and/or direction 1116 as described in relation to FIG. 7 such that the main lobe receives the signal from the base station 1102 while the side lobe receives the signal from the jamming device 1109. The combined signal may be amplified and forwarded along the beam and/or direction 1118 for reception at the UE 1104. The UE 1104 may receive the forwarded signal and may attempt to decode the signal and/or to measure the received signal. Based on the attempted decoding and/or measurement, the UE 1104 may identify and/or detect a decreased signal quality (e.g., a decreased SINR or RSRQ) resulting from the interference of the jamming device. The UE 1104 may transmit an indication of the decreased signal to the base station 1102 to trigger an update and/or modification of the NCR configuration.

The NCR controller 1108 (e.g., an NCR-MT), in some aspects, may be configured with periodic measurement and/or sensing windows to detect a jamming and/or interfering signal. For example, if the NCR controller 1108 detects a signal with a power above a threshold power (or a BH SINR below a threshold value) it may transmit an indication of the detected interfering signal and, in some aspects, an associated direction (where the direction may be a range associated with a broad lobe of a reception beam). In some aspects, the network and/or the base station 1102 may be aware of and/or know a location and/or position of the jamming device 1109, or a set of potential jamming devices including the jamming device 1109, e.g., relative to the base station 1102 and/or the NCR 1106. In some aspects, the network and/or base station 1102 may be aware of the interference without the indication from one of the UE 1104 or the NCR controller 1108.

FIG. 11B is a diagram 1120 illustrating a first interference-direction sensing operation based on detecting (at one of the base station 1102, the network, the UE 1104, or the NCR controller 1108) the interfering signal as described in relation to FIG. 11A in accordance with some aspects of the disclosure. In some aspects, the first interference-direction sensing operation (e.g., a beam sweeping operation) may use a plurality of (configurable) antenna elements of the NCR 1106. The NCR controller 1108 may receive an indication of a first set of configurations of the plurality of configurable antenna elements. The first set of configurations of the plurality of configurable antenna elements, in some aspects, may use a greater number of configurable antenna elements than the first configuration associated with the first configuration that experienced the interference. In some aspects, each configuration in the first set of configurations may be associated with a main (receive) lobe 1124 in the direction of the base station 1102 with different configurations of side lobes (e.g., a set of side lobes in different directions including, for example, a side lobe 1126 that may be different from the side lobe and/or direction 1116 associated with the first configuration experiencing the interference). The different configurations of side lobes, in some aspects, may include narrower beams associated with reception and/or nulls (e.g., directions associated with a zero, or near-zero, gain). In some aspects, the different configurations of side lobes may be possible based on using the larger number of configurable antenna elements to provide additional control over the characteristics of the receive lobes and/or directions (e.g., compared to an energy-saving configuration using a smaller numbers of configurable antenna elements). The different configurations of side lobes, in some aspects, may be used to more accurately identify the direction associated with the jamming signal.

The received signal, in some aspects, may be measured at the NCR 1106 (e.g., by the NCR controller 1108), or may be forwarded to one or more of the base station 1102 or the UE 1104 for measurement. If the received signal is forwarded to the UE 1104, the UE 1104 may, based on receiving and/or obtaining an indication of the first set of configurations, measure an SINR (or RSRQ) for one or more forwarded signals associated with the configurations in the first set of configurations. The UE 1104 may report the measurements associated with each of the configurations in the first set of configurations to the base station 1102 and/or the network.

In some aspects, the first interference-direction sensing operation may be performed in such a way so as not to interrupt the communication between the base station 1102 and the UE 1104. For example, the first interference-direction sensing operation may be performed on resources (e.g., time and/or frequency resources) that are distinct from the resources used for the communication.

FIG. 11C is a diagram 1140 illustrating an interference mitigating NCR configuration based on the first interference-direction sensing operation in accordance with some aspects of the disclosure. Based on the first interference-direction sensing operations, the base station 1102 (or the network) may determine an NCR configuration to maximize (or optimize) a signal quality (e.g., an SINR) for a target (amplification and) forwarding (e.g., an amplification and forwarding of a transmitted signal from the base station 1102 to the UE 1104 via the NCR 1106). In some aspects, the NCR configuration (e.g., a configuration for a plurality of configurable antenna elements of the NCR) may not be one of the configurations in the first set of configurations. For example, the NCR configuration may be associated with set of reception lobes and/or directions, such as a main lobe in a first direction 1134 towards the base station 1102, one or more side lobes (e.g., in a second direction 1136 not towards the jamming device 1109), and a null in a direction towards the jamming device 1109. The NCR configuration may further include an amplification and forwarding lobe and/or direction associated with a main lobe in a direction 1118 towards the UE 1104. In some aspects, at least one configuration in the first set of configurations may use (or be associated with) a first number of configurable (antenna) elements and the configuration of the plurality of configurable elements for the subsequent communication may be for a second number of configurable (antenna) elements, where the first number of configurable elements is greater than or equal to the second number of configurable elements.

In some aspects, along with updating the NCR configuration, the base station 1102 may adjust scheduling and/or resource usage (e.g., may adjust time and/or frequency resources) to avoid the resources associated with the jamming signals. In some aspects, the base station may also increase a transmit power to increase the relative strength of the signal (e.g., to increase the SINR).

While some aspects are discussed above, other options for some of the operations may be possible. For example, the interference mitigation (or jamming resolution) procedure may be initiated by the NCR-MT and/or NCR controller 1108 instead of being initiated and/or triggered by a drop in the SINR measured at the UE 1104. In some aspects, the NCR-MT and/or NCR controller 1108 may be provided with some periodic measurement and/or sensing windows, and if it identifies or detects a jamming signal with a power beyond some configured threshold (or if the backhaul (BH) SINR associated with the communication from the base station 1102 to the NCR-MT and/or NCR controller 1108 goes below a threshold), it may indicate for the base station 1102 to initiate the interference mitigation (or jamming resolution) procedure. In some aspects the NCR controller 1108 may try to autonomously find a better NCR configuration.

The NCR-MT and/or NCR controller 1108, in some aspects, may provide additional information to the base station 1102 and/or network. For example, the NCR-MT and/or NCR controller 1108 may report measurements of a “jamming” signal to the base station 1102 and/or the network and may get some assistance information from the base station and/or network on how to initiate or address self-resolution of the jamming issue. As discussed above, in some aspects, the jamming device 1109 may be known to the base station 1102 and/or the network (e.g., the jamming device 1109 may be another cell/TRP belonging to same or a neighboring base station) so a network entity may attempt to mitigate the problem via BH coordination instead of jammer avoidance. As discussed above, in some aspects, the direction and/or strengths of the jamming signals may be known to the base station 1102 and/or the network and the network may indicate a null-forming configuration (or pattern) for the NCR 1106 (e.g., indicating a direction associated with a null of the null-forming configuration and a relative gain compared to a direction towards the base station 1102).

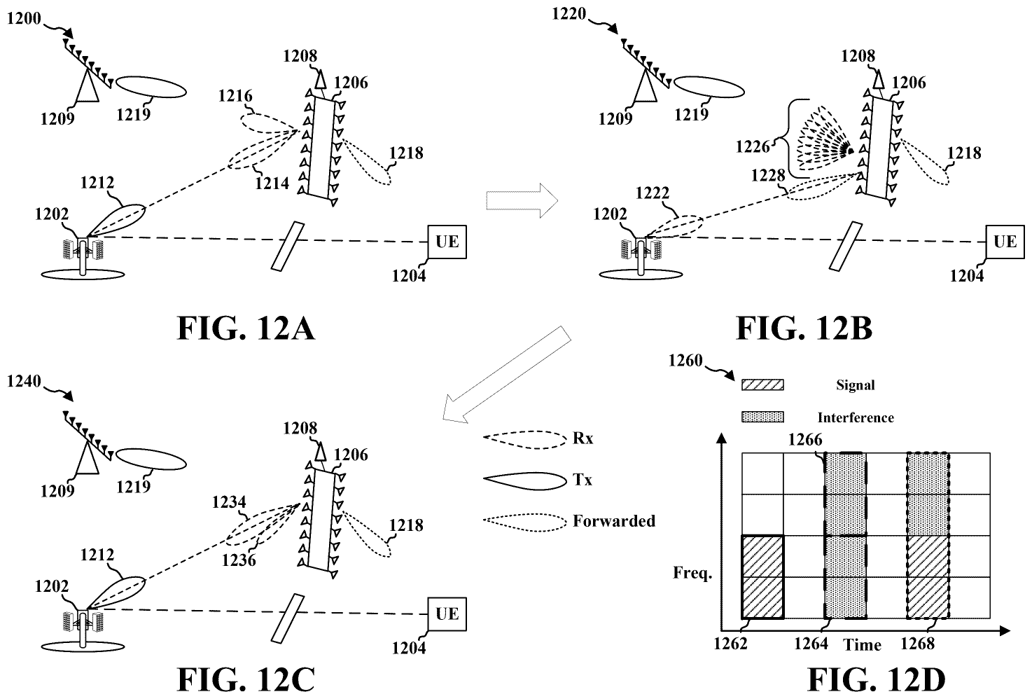

Additionally, in some aspects, the NCR-MT and/or NCR controller 1108 may collect, and provide to the base station 1102 and/or the network, jamming statistics associated with one or more timescales, where the jamming statistics may relate to which directions, which time resources, and/or which frequency resources experience interference greater than some configured threshold. The threshold may be configured by a network entity, and the configuration for the NCR illustrated in FIG. 12D below and the resources used for the transmissions from the base station 1102 may be based on the jamming statistics as well as the first and second interference-direction sensing operations. In some aspects, the NCR controller 1108 may, indicate a possible and/or suggested configuration for the NCR and/or scheduling for the communication (e.g., indicated time and/or frequency resources) based on the jamming statistics and/or the first interference-direction sensing operation to the base station 1102 and/or the network. For example, the NCR controller 1108, in some aspects, may suggest using a set of time and/or frequency resources for communication between the base station 1102 and the UE 1104 that are not associated with interference above the threshold value. Additionally, or alternatively, the NCR controller 1108 may indicate and/or suggest an increased transmission power (e.g., by ‘X’ dB) from the base station 1102 to, at least partially, compensate for the interference introduced by the jamming device 1109.

FIG. 12A is diagram 1200 illustrating a communication between a base station 1202 and a UE 1204 via an NCR 1206 that is interfered with by a signal from a jamming device 1209 in accordance with some aspects of the disclosure. For example, the base station 1202 may transmit a signal via a first beam and/or direction 1212 while the jamming device 1209 may transmit a signal via a beam and/or a direction 1219. The NCR configuration may be a first configuration designed to maximize (or optimize) a gain for a repeated (e.g., a received, amplified, and forwarded) signal from the base station 1202 to the UE 1204 via the NCR 1206). In some aspects, the first configuration may use a first (minimized) number of configurable antenna elements of the NCR 1206 (or an NCR-FWD component of the NCR 1206) selected to provide an acceptable SINR (e.g., a BH SINR) while minimizing the total energy consumption (e.g., minimizing the total number of configurable antenna elements). The first configuration, in some aspects, may be associated with a main or primary (reception) lobe associated with a beam and/or direction 1214 and with a side (or secondary) lobe associated with a beam and/or direction 1216 as described in relation to FIG. 7 such that the main lobe receives the signal from the base station 1202 while the side lobe receives the signal from the jamming device 1209. The combined signal may be amplified and forwarded along the beam and/or direction 1218 for reception at the UE 1204. The UE 1204 may receive the forwarded signal and may attempt to decode the signal and/or to measure the received signal. Based on the attempted decoding and/or measurement, the UE 1204 may identify and/or detect a decreased signal quality (e.g., a decreased SINR or RSRQ) resulting from the interference of the jamming device. The UE 1204 may transmit an indication of the decreased signal to the base station 1202 to trigger an update and/or modification of the NCR configuration.

The NCR controller 1208 (e.g., an NCR-MT), in some aspects, may be configured with periodic measurement and/or sensing windows to detect a jamming and/or interfering signal. For example, if the NCR controller 1208 detects a signal with a power above a threshold power (or a BH SINR below a threshold value) it may transmit an indication of the detected interfering signal and, in some aspects, an associated direction (where the direction may be a range associated with a broad lobe of a reception beam). In some aspects, the network and/or the base station 1202 may be aware of and/or know a location and/or position of the jamming device 1209, or a set of potential jamming devices including the jamming device 1209, e.g., relative to the base station 1202 and/or the NCR 1206. In some aspects, the network and/or base station 1202 may be aware of the interference without the indication from one of the UE 1204 or the NCR controller 1208.

FIG. 12B is a diagram 1220 illustrating a first interference-direction sensing operation based on detecting (at one of the base station 1202, the network, the UE 1204, or the NCR controller 1208) the interfering signal as described in relation to FIG. 12A in accordance with some aspects of the disclosure. In some aspects, the first interference-direction sensing operation (e.g., a beam sweeping operation) may use a plurality of (configurable) antenna elements of the NCR 1206. The NCR controller 1208 may receive an indication of a first set of configurations of the plurality of configurable reflective elements. The first set of configurations of the plurality of configurable antenna elements, in some aspects, may use a greater number of configurable antenna elements than the first configuration associated with the first configuration that experienced the interference. In some aspects, each configuration in the first set of configurations may be associated with a main (receive) lobe in the possible direction of the jamming device 1209 (e.g., a main lobe in the set of lobes and/or directions 1226). The different configurations of main (receive) lobes, in some aspects, may include narrower beams associated with reception and/or nulls (e.g., directions associated with a zero, or near-zero, gain). In some aspects, the different configurations of side lobes may be possible based on using the larger number of configurable antenna elements to provide additional control over the characteristics of the receive lobes and/or directions (e.g., compared to an energy-saving configuration using a smaller numbers of configurable antenna elements). The different configurations of main (receive) lobes, in some aspects, may be used to more accurately identify the direction associated with the jamming signal.

The received signal, in some aspects, may be measured at the NCR 1206 (e.g., by the NCR controller 1208), or may be forwarded to one or more of the base station 1202 (via the lobe and/or direction 1228 to be received via a lobe and/or direction 1222) or the UE 1204 (via the lobe and/or direction 1218) for measurement. If the received signal is forwarded to the UE 1204, the UE 1204 may, based on receiving and/or obtaining an indication of the first set of configurations, measure an SINR (or RSRQ) for one or more forwarded signals associated with the configurations in the first set of configurations. The UE 1204 may report the measurements associated with each of the configurations in the first set of configurations to the base station 1202 and/or the network.

FIG. 12C is a diagram 1240 illustrating an interference mitigating NCR configuration based on the first interference-direction sensing operation in accordance with some aspects of the disclosure. Based on the first interference-direction sensing operations, the base station 1202 (or the network) may determine an NCR configuration to maximize (or optimize) a signal quality (e.g., an SINR) for a target (amplification and) forwarding (e.g., an amplification and forwarding of a transmitted signal from the base station 1202 to the UE 1204 via the NCR 1206). In some aspects, the NCR configuration (e.g., a configuration for a plurality of configurable antenna elements of the NCR) may not be one of the configurations in the first set of configurations. For example, the NCR configuration may be associated with set of reception lobes and/or directions, such as a main lobe in a first direction 1234 towards the base station 1202, one or more side lobes (e.g., in a second direction 1236 not towards the jamming device 1209), and a null in a direction towards the jamming device 1209. The NCR configuration may further include an amplification and forwarding lobe and/or direction associated with a main lobe in a direction 1218 towards the UE 1204.

FIG. 12D is a diagram 1260 illustrating the use of disjoint resources for the first interference-direction sensing operation in accordance with some aspects of the disclosure. In some aspects, the first interference-direction sensing operation may be performed in such a way so as not to interrupt the communication between the base station 1202 and the UE 1204. For example, the first interference-direction sensing operation may be performed on resources that are distinct from the resources used for the communication. Diagram 1260 illustrates a first set of resources 1262 in time and frequency that may be used for a signal and/or communication by the base station 1202 that may be associated with a current configuration for communication or a current configuration for the first interference-direction sensing operation. Diagram 1260 further illustrates a second set of resources 1264 that includes resources overlapping in frequency, but not in time, with the first set of resources 1262 and a third set of resources 1266 that includes resources that do not overlap in time or frequency with the first set of resources 1262. The second set of resources and/or the third set of resources may be used for the first interference-direction sensing operation and may be associated with a configuration in the first set of configurations or the current configuration for communication. A fourth set of resources 1268 includes communication and interference transmissions overlapping in time but not frequency that may be transmitted in association with a configuration in the first set of configurations for the first interference-direction sensing operation (e.g., as illustrated in FIG. 11B).

In some aspects, along with updating the NCR configuration, the base station 1202 may adjust scheduling and/or resource usage (e.g., may adjust time and/or frequency resources) to avoid the resources associated with the jamming signals. In some aspects, the base station may also increase a transmit power to increase the relative strength of the signal (e.g., to increase the SINR).

While some aspects are discussed above, other options for some of the operations may be possible. For example, the interference mitigation (or jamming resolution) procedure may be initiated by the NCR-MT and/or NCR controller 1208 instead of being initiated and/or triggered by a drop in the SINR measured at the UE 1204. In some aspects, the NCR-MT and/or NCR controller 1208 may be provided with some periodic measurement and/or sensing windows, and if it identifies or detects a jamming signal with a power beyond some configured threshold (or if the backhaul (BH) SINR associated with the communication from the base station 1202 to the NCR-MT and/or NCR controller 1208 goes below a threshold), it may indicate for the base station 1202 to initiate the interference mitigation (or jamming resolution) procedure. In some aspects the NCR controller 1208 may try to autonomously find a better NCR configuration.

The NCR-MT and/or NCR controller 1208, in some aspects, may provide additional information to the base station 1202 and/or network. For example, the NCR-MT and/or NCR controller 1208 may report measurements of a “jamming” signal to the base station 1202 and/or the network and may get some assistance information from the base station and/or network on how to initiate or address self-resolution of the jamming issue. As discussed above, in some aspects, the jamming device 1209 may be known to the base station 1202 and/or the network (e.g., the jamming device 1209 may be another cell/TRP belonging to same or a neighboring base station) so a network entity may attempt to mitigate the problem via BH coordination instead of jammer avoidance. As discussed above, in some aspects, the direction and/or strengths of the jamming signals may be known to the base station 1202 and/or the network and the network may indicate a null-forming configuration (or pattern) for the NCR 1206 (e.g., indicating a direction associated with a null of the null-forming configuration and a relative gain compared to a direction towards the base station 1202).

Additionally, in some aspects, the NCR-MT and/or NCR controller 1208 may collect, and provide to the base station 1202 and/or the network, jamming statistics associated with one or more timescales, where the jamming statistics may relate to which directions, which time resources, and/or which frequency resources experience interference greater than some configured threshold. The threshold may be configured by a network entity, and the configuration for the NCR illustrated in FIG. 12D and the resources used for the transmissions from the base station 1202 may be based on the jamming statistics as well as the first and second interference-direction sensing operations. In some aspects, the NCR controller 1208 may, indicate a possible and/or suggested configuration for the NCR and/or scheduling for the communication (e.g., indicated time and/or frequency resources) based on the jamming statistics and/or the first interference-direction sensing operation to the base station 1202 and/or the network. For example, the NCR controller 1208, in some aspects, may suggest using a set of time and/or frequency resources for communication between the base station 1202 and the UE 1204 that are not associated with interference above the threshold value. Additionally, or alternatively, the NCR controller 1208 may indicate and/or suggest an increased transmission power (e.g., by ‘X’ dB) from the base station 1202 to, at least partially, compensate for the interference introduced by the jamming device 1209.

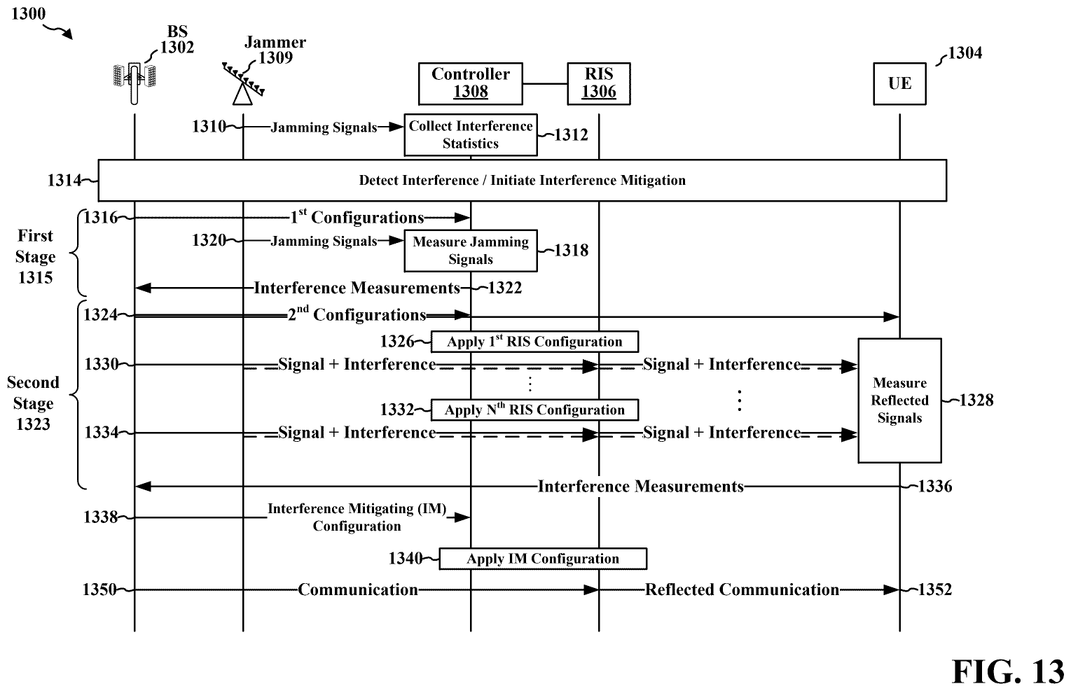

FIG. 13 is a call flow diagram 1300 illustrating a method for mitigating interference from a jamming device 1309 for a communication between a base station 1302 and a UE 1304 via a RIS 1306 in accordance with some aspects of the disclosure. The method is illustrated in relation to a base station 1302 (e.g., as an example of a network device or network node that may include one or more components of a disaggregated base station) in communication with a UE 1304 (e.g., as an example of a wireless device). The functions ascribed to the base station 1302, in some aspects, may be performed by one or more components of a network entity, a network node, or a network device (a single network entity/node/device or a disaggregated network entity/node/device as described above in relation to FIG. 1). Similarly, the functions ascribed to the UE 1304, in some aspects, may be performed by one or more components of a wireless device supporting communication with a network entity/node/device. Accordingly, references to “transmitting” in the description below may be understood to refer to a first component of the base station 1302 (or the UE 1304) outputting (or providing) an indication of the content of the transmission to be transmitted by a different component of the base station 1302 (or the UE 1304). Similarly, references to “receiving” in the description below may be understood to refer to a first component of the base station 1302 (or the UE 1304) receiving a transmitted signal and outputting (or providing) the received signal (or information based on the received signal) to a different component of the base station 1302 (or the UE 1304). The RIS 1306, in some aspects, may be collocated and/or included in a same device or housing as the controller 1308 (e.g., a RIS controller) and may communicate via wired or wireless communication. Accordingly, while some actions may be ascribed to the controller 1308, in some aspects, they may additionally, or alternatively, be referred to (or be considered) as being performed by the RIS 1306.

The controller 1308, in some aspects, may be a mobile termination (MT) point comprising a plurality of configurable antenna elements and capable of wireless communication with the base station 1302. In some aspects, the controller 1308 may further be capable of measuring and/or decoding transmissions from other wireless devices including the base station 1302 and the jamming device 1309. Accordingly, in some aspects, an array of configurable antenna elements of the controller may be configured to collect interference statistics at 1312 based on jamming signals 1310. In some aspects, the controller 1308 may be configured with periodic measurement and/or sensing windows to detect and/or collect statistics related to a jamming and/or interfering signal. For example, the controller 1308 may be configured to periodically determine if the controller 1308 detects, via a configured set of resources and receive beam directions, a signal with a power above a threshold power (or a BH SINR below a threshold value) and to transmit an indication of the detected interfering signal and, in some aspects, an associated direction (where the direction may be a range associated with a broad lobe of a reception beam).

At 1314, one or more of the base station 1302, the controller 1308, or the UE 1304 may detect interference and/or initiate the method for mitigating interference as discussed in relation to FIG. 9D. For example, in some aspects, the UE 1304 may detect an SINR below a threshold value over a threshold time period (e.g., an average power over a sensing window that is above a threshold value) and transmit an indication to the base station 1302. Alternatively, or additionally, the controller 1308 may detect an interfering signal with a power greater than a threshold power for a time greater than a threshold time (e.g., an average power over a sensing window that is above a threshold value) and transmit an indication to the base station 1302. Based on an indication received from either the UE 1304 or the controller 1308, the base station 1302 may initiate an interference mitigation operation. Based on the known configuration of the RIS 1306 (e.g., the configuration of the array of configurable reflective elements of the RIS), the base station 1302 may determine a first set of configurations as discussed in relation to FIGS. 9B and 9D. The first set of configurations, in some aspects, may further be based on known characteristics of potential interfering and/or jamming devices (e.g., jamming device 1309) and/or the indication of the interference statistics collected at 1312 as described in relation to FIG. 9B.

For example, a first configuration experiencing interference may be associated with a first main lobe for reception from the network device directed towards the network device and a first set of side (or secondary) lobes for reception directed in a first set of directions corresponding to the first set of side lobes as described in relation to FIG. 9A. In some aspects, the first set of configurations may include one or more configurations associated with a second main lobe for reception directed in a direction in the first set of directions as described in relation to FIG. 9B.

The base station 1302 may initiate a first stage of the method for interference mitigation 1315 and may transmit, and the controller 1308 may receive, the first set of configurations 1316. Based on the first set of configurations 1316, the controller 1308 may, at 1318, measure, and/or monitor for, one or more jamming signals 1320 while implementing each configuration in the first set of configurations as described in relation to FIG. 9B. For example, the controller 1308 may measure a signal strength associated with each configuration (or main lobe) in the first set of configurations (e.g., in the absence of transmissions and/or signals from the base station 1302). Based on the measured signal strengths, the controller 1308 may identify and/or determine one or more potential directions associated with the jamming signal from the jamming device 1309. For example, directions associated with a power that is above a threshold value may be identified as potential directions associated with the jamming signal. In some aspects, the first set of configurations may be associated with a set of resources (frequency and/or time resources) that do not interfere with the communication between the base station 1302 and the UE 1304. Additionally, or alternatively, the first interference-direction sensing operation may measure a (per-frequency-band and/or per-frequency resource) power associated with a set of frequency bands and identify and/or determine the frequency bands that are associated with a power above a threshold value (e.g., a threshold power value that may be different from (or lower than) the threshold power value used for identifying and/or determining the one or more potential directions).

Based on the measurements and/or monitoring at 1318, the controller 1308 may transmit, and the base station 1302 may receive, an indication 1322 of the interference measurements (e.g., one or more of the measurements, an indication of one or more directions and/or frequency bands associated with a power above a threshold, or other information regarding the interference measured at the controller 1308). Once the indication 1322 is received at the base station 1302, the first stage of the method for interference mitigation 1315 may be complete and the base station 1302 may generate and/or determine a second set of configurations for the plurality (or array) of configurable reflective elements of the RIS 1306 for a second interference-direction sensing operation.

In some aspects, the second set of configurations may be based on the first interference-direction sensing operation (e.g., the first stage of the method for interference mitigation 1315) as described in relation to FIG. 9C. Each configuration in the second set of configurations, in some aspects, may be associated with a main (incident) lobe in the direction of the base station 1302 and a main (reflected) lobe in the direction of the UE 1304 with different configurations of side lobes (e.g., a set of side lobes in different directions including, for example, a side lobe that may be different from a side lobe associated with the first configuration experiencing the interference). The different configurations of side lobes, in some aspects, may include narrower beams associated with reception and/or nulls (e.g., directions associated with a zero, or near-zero, gain). The different configurations of side lobes, in some aspects, may be used to more accurately identify the direction associated with the jamming signal. The second set of configurations, in some aspects, may further be associated with a reflection direction towards the UE 1304 such that the UE 1304 may measure signals (e.g., comprising a signal from the base station 1302 and the jamming device 1309) during a second stage of the method for interference mitigation 1323.

The base station 1302 may transmit, and the controller 1308 and the UE 1304 may receive, the second set of configurations 1324. Based on receiving the second set of configurations 1324, the controller 1308 and the RIS 1306 may, at 1326, apply and/or implement (e.g., configure the array of configurable reflective elements of the RIS based on) a first configuration in the second set of configurations. Additionally, based on receiving the second set of configurations 1324, the UE 1304 may, at 1328 monitor for and/or measure and collect information regarding signals received in association with each configuration in the second set of configurations. The RIS 1306 may, while in the first configuration of the second set of configurations, reflect an impinging set of transmissions 1330 including a signal transmitted by the base station 1302 and an interference transmitted by the jamming device 1309 that is measured, at 1328, by the UE 1304.

Similarly, the controller 1308 and the RIS 1306 may, apply and/or implement (e.g., configure the array of configurable reflective elements of the RIS based on) additional configurations in the second set of configurations, and, while in each configuration of the second set of configurations, reflect an impinging set of transmissions including a signal transmitted by the base station 1302 and an interference transmitted by the jamming device 1309 that is measured, at 1328, by the UE 1304 until a last (e.g., an N^{th}) configuration is applied and/or implemented at 1332 to reflect the impinging set of transmissions 1334 including a signal transmitted by the base station 1302 and an interference transmitted by the jamming device 1309 that is measured, at 1328, by the UE 1304. Once the reflected signals (e.g., based on the impinging set of transmissions 1330 and 1334) have been measured at the UE 1304, the UE 1304 may prepare a report and transmit an indication 1336 of the interference measurements. The indication 1336, in some aspects, may include an indication of one or more of (1) the measurements (e.g., an SINR or RSRQ) associated with each configuration in the second set of configurations, (2) an indication of one or more configurations in the second set of configurations associated with an SINR above (or below) a threshold SINR (e.g., a per-frequency band SINR or an SINR across all monitored frequencies), or (3) other information (for instance complex valued I/Q samples of received observations) regarding the signal measured at the UE 1304).

Based on known interferer information and/or the information provided by the controller 1308 and the UE 1304 (e.g., one or more of the statistics collected at 1312, the indication 1322, and/or the indication 1336), the base station 1302 (or an associated network entity or function) may determine an optimized configuration for communication between the base station 1302 and the UE 1304 that reduces the effects of the interference from the jamming device 1309 (or a plurality of jamming devices including jamming device 1309). The base station 1302 may transmit, and the controller 1308 may receive, an interference mitigating configuration 1338 for the RIS 1306 (e.g., a configuration of the plurality, or array, of configurable reflective elements of the RIS). The controller 1308 and the RIS 1306 may, at 1340 apply the interference mitigating configuration 1338 and reflect impinging communication 1350 as reflected communication 1352.

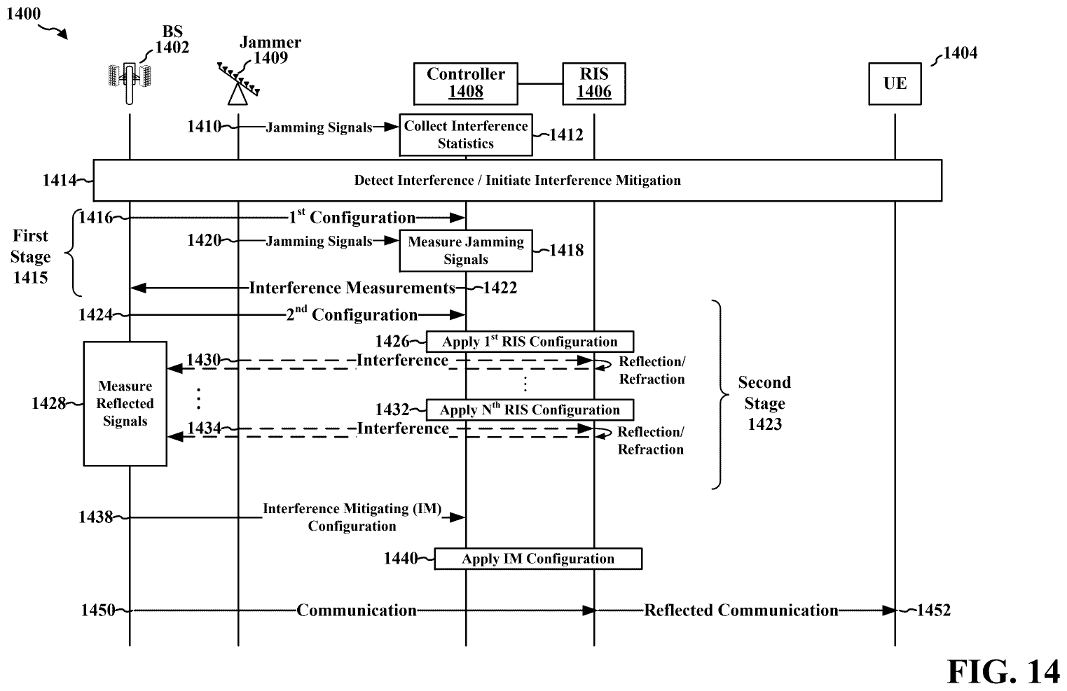

FIG. 14 is a call flow diagram 1400 illustrating a method for mitigating interference from a jamming device 1409 for a communication between a base station 1402 and a UE 1404 via a RIS 1406 in accordance with some aspects of the disclosure. The method is illustrated in relation to a base station 1402 (e.g., as an example of a network device or network node that may include one or more components of a disaggregated base station) in communication with a UE 1404 (e.g., as an example of a wireless device). The functions ascribed to the base station 1402, in some aspects, may be performed by one or more components of a network entity, a network node, or a network device (a single network entity/node/device or a disaggregated network entity/node/device as described above in relation to FIG. 1). Similarly, the functions ascribed to the UE 1404, in some aspects, may be performed by one or more components of a wireless device supporting communication with a network entity/node/device. Accordingly, references to “transmitting” in the description below may be understood to refer to a first component of the base station 1402 (or the UE 1404) outputting (or providing) an indication of the content of the transmission to be transmitted by a different component of the base station 1402 (or the UE 1404). Similarly, references to “receiving” in the description below may be understood to refer to a first component of the base station 1402 (or the UE 1404) receiving a transmitted signal and outputting (or providing) the received signal (or information based on the received signal) to a different component of the base station 1402 (or the UE 1404). The RIS 1406, in some aspects, may be collocated and/or included in a same device or housing as the controller 1408 (e.g., a RIS controller) and may communicate via wired or wireless communication. Accordingly, while some actions may be ascribed to the controller 1408, in some aspects, they may additionally, or alternatively, be referred to (or be considered) as being performed by the RIS 1406.

The controller 1408, in some aspects, may be a mobile termination (MT) point comprising a plurality of configurable antenna elements and capable of wireless communication with the base station 1402. In some aspects, the controller 1408 may further be capable of measuring and/or decoding transmissions from other wireless devices including the base station 1402 and the jamming device 1409. Accordingly, in some aspects, an array of configurable antenna elements of the controller may be configured to collect interference statistics at 1412 based on jamming signals 1410. In some aspects, the controller 1408 may be configured with periodic measurement and/or sensing windows to detect and/or collect statistics related to a jamming and/or interfering signal. For example, the controller 1408 may be configured to periodically determine if the controller 1408 detects, via a configured set of resources and receive beam directions, a signal with a power above a threshold power (or a BH SINR below a threshold value) and to transmit an indication of the detected interfering signal and, in some aspects, an associated direction (where the direction may be a range associated with a broad lobe of a reception beam).

At 1414, one or more of the base station 1402, the controller 1408, or the UE 1404 may detect interference and/or initiate the method for mitigating interference as discussed in relation to FIG. 10D. For example, in some aspects, the UE 1404 may detect an SINR below a threshold value over a threshold time period (e.g., an average power over a sensing window that is above a threshold value) and transmit an indication to the base station 1402. Alternatively, or additionally, the controller 1408 may detect an interfering signal with a power greater than a threshold power for a time greater than a threshold time (e.g., an average power over a sensing window that is above a threshold value) and transmit an indication to the base station 1402. Based on an indication received from either the UE 1404 or the controller 1408, the base station 1402 may initiate an interference mitigation operation. Based on the known configuration of the RIS 1406 (e.g., the configuration of the array of configurable reflective elements of the RIS), the base station 1402 may determine a first set of configurations as discussed in relation to FIG. 10D. The first set of configurations, in some aspects, may further be based on known characteristics of potential interfering and/or jamming devices (e.g., jamming device 1409) and/or the indication of the interference statistics collected at 1412 as described in relation to FIG. 10B.

For example, a first configuration experiencing interference may be associated with a first main lobe for reception from the network device directed towards the network device and a first set of side (or secondary) lobes for reception directed in a first set of directions corresponding to the first set of side lobes as described in relation to FIG. 10A. In some aspects, the first set of configurations may include one or more configurations associated with a second main lobe for reception directed in a direction in the first set of directions as described in relation to FIG. 10B.

The base station 1402 may initiate a first stage of the method for interference mitigation 1415 and may transmit, and the controller 1408 may receive, the first set of configurations 1416. Based on the first set of configurations 1416, the controller 1408 may, at 1418, measure, and/or monitor for, one or more jamming signals 1420 while implementing each configuration in the first set of configurations as described in relation to FIG. 10B. For example, the controller 1408 may measure a signal strength associated with each configuration (or main lobe) in the first set of configurations (e.g., in the absence of transmissions and/or signals from the base station 1402). Based on the measured signal strengths, the controller 1408 may identify and/or determine one or more potential directions associated with the jamming signal from the jamming device 1409. For example, directions associated with a power that is above a threshold value may be identified as potential directions associated with the jamming signal. In some aspects, the first set of configurations may be associated with a set of resources (frequency and/or time resources) that do not interfere with the communication between the base station 1402 and the UE 1404. Additionally, or alternatively, the first interference-direction sensing operation may measure a (per-frequency-band and/or per-frequency resource) power associated with a set of frequency bands and identify and/or determine the frequency bands that are associated with a power above a threshold value (e.g., a threshold power value that may be different from (or lower than) the threshold power value used for identifying and/or determining the one or more potential directions).

Based on the measurements and/or monitoring at 1418, the controller 1408 may transmit, and the base station 1402 may receive, an indication 1422 of the interference measurements (e.g., one or more of the measurements, an indication of one or more directions and/or frequency bands associated with a power above a threshold, or other information, for instance complex valued I/Q samples of received observations, regarding the interference measured at the controller 1408). Once the indication 1422 is received at the base station 1402, the first stage of the method for interference mitigation 1415 may be complete and the base station 1402 may generate and/or determine a second set of configurations for the plurality (or array) of configurable reflective elements of the RIS 1406 for a second interference-direction sensing operation.

In some aspects, the second set of configurations may be based on the first interference-direction sensing operation (e.g., the first stage of the method for interference mitigation 1415) as described in relation to FIG. 10C. One or more configurations in the second set of configurations may be associated with a main (incident) lobe and/or direction in a set of possible lobes and/or directions that may be associated with a direction of the jamming device 1409 and a main (reflected) lobe in the direction of the base station 1402 such that the base station 1402 may measure signals during a second stage of the method for interference mitigation 1423 (e.g., the base station may measure a power associated with a jamming signal from the jamming device 1409) as described in relation to FIG. 10C. The different configurations of main (incident) lobes, in some aspects, may include narrower beams associated with reception and/or nulls (e.g., directions associated with a zero, or near-zero, gain). The different configurations of main (incident) lobes, in some aspects, may be used to more accurately identify the direction associated with the jamming signal.

The base station 1402 may transmit, and the controller 1408 and the UE 1404 may receive, the second set of configurations 1424. Based on receiving the second set of configurations 1424, the controller 1408 and the RIS 1406 may, at 1426, apply and/or implement (e.g., configure the array of configurable reflective elements of the RIS based on) a first configuration in the second set of configurations. Additionally, based on the second set of configurations 1424, the base station 1402 may, at 1428 monitor for and/or measure and collect information regarding signals received in association with each configuration in the second set of configurations. The RIS 1406 may, while in the first configuration of the second set of configurations, reflect an impinging interfering transmission 1430 (e.g., if there is an impinging interfering signal) transmitted by the jamming device 1409 that is measured, at 1428, by the base station 1402.

Similarly, the controller 1408 and the RIS 1406 may, apply and/or implement (e.g., configure the array of configurable reflective elements of the RIS based on) additional configurations in the second set of configurations, and, while in each configuration of the second set of configurations, reflect an impinging interfering transmission transmitted by the jamming device 1409 that is measured, at 1428, by the base station 1402 until a last (e.g., an N^{th}) configuration is applied and/or implemented at 1432 to reflect the impinging interfering transmission 1434 transmitted by the jamming device 1409 that is measured, at 1428, by the base station 1402.

Based on the measurements performed by the base station 1402, known interferer information, and the information received from the controller 1408 (e.g., one or more of the statistics collected at 1412 and/or the indication 1422), the base station 1402 (or an associated network entity or function) may determine an optimized configuration for communication between the base station 1402 and the UE 1404 that reduces the effects of the interference from the jamming device 1409 (or a plurality of jamming devices including jamming device 1409. The base station 1402 may transmit, and the controller 1408 may receive, an interference mitigating configuration 1438 for the RIS 1406 (e.g., a configuration of the plurality, or array, of configurable reflective elements of the RIS). The controller 1408 and the RIS 1306 may, at 1440 apply the interference mitigating configuration 1438 and reflect impinging communication 1450 as reflected communication 1452.

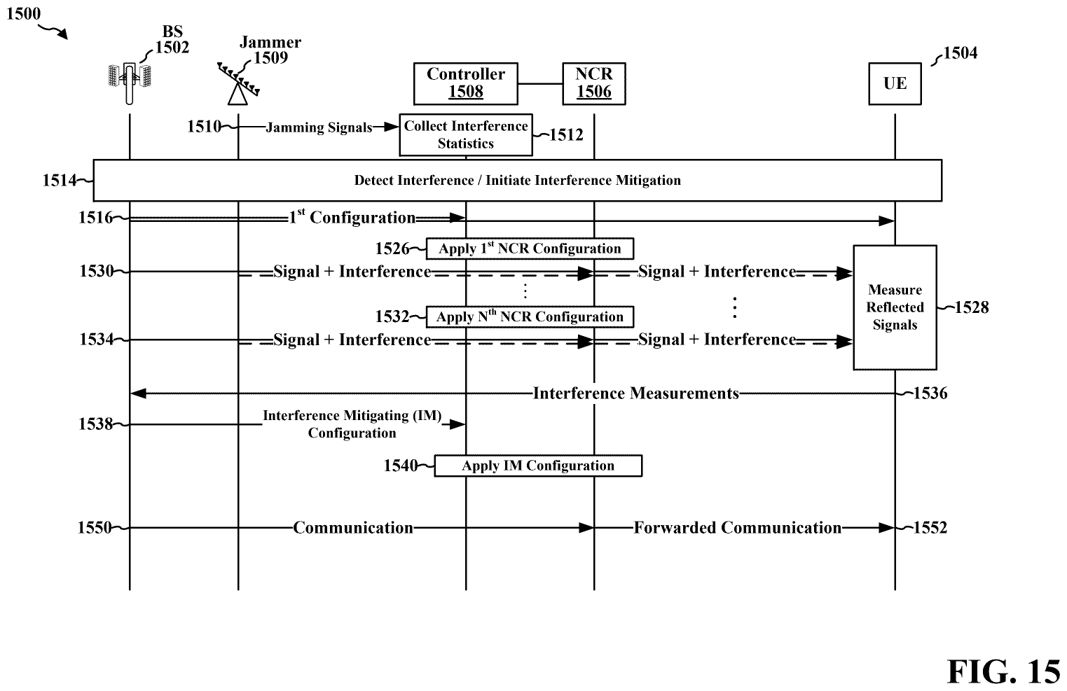

FIG. 15 is a call flow diagram 1500 illustrating a method for mitigating interference from a jamming device 1509 for a communication between a base station 1502 and a UE 1504 via an NCR 1506 in accordance with some aspects of the disclosure. The method is illustrated in relation to a base station 1502 (e.g., as an example of a network device or network node that may include one or more components of a disaggregated base station) in communication with a UE 1504 (e.g., as an example of a wireless device). The functions ascribed to the base station 1502, in some aspects, may be performed by one or more components of a network entity, a network node, or a network device (a single network entity/node/device or a disaggregated network entity/node/device as described above in relation to FIG. 1). Similarly, the functions ascribed to the UE 1504, in some aspects, may be performed by one or more components of a wireless device supporting communication with a network entity/node/device. Accordingly, references to “transmitting” in the description below may be understood to refer to a first component of the base station 1502 (or the UE 1504) outputting (or providing) an indication of the content of the transmission to be transmitted by a different component of the base station 1502 (or the UE 1504). Similarly, references to “receiving” in the description below may be understood to refer to a first component of the base station 1502 (or the UE 1504) receiving a transmitted signal and outputting (or providing) the received signal (or information based on the received signal) to a different component of the base station 1502 (or the UE 1504). As described in relation to FIG. 6, the NCR 1506 may include a first set of configurable antenna elements (e.g., NCR-MT 612) capable of receiving transmissions from a network device and a first set of configurable antenna elements (e.g., NCR-FWD or forwarding node 614) capable of transmitting (e.g., forwarding) a received (and amplified) transmission to an additional wireless device. The NCR 1506, in some aspects, may be collocated and/or included in a same device or housing as the controller 1508 (e.g., an NCR controller) and may communicate via wired or wireless communication. Accordingly, while some actions may be ascribed to the controller 1508, in some aspects, they may additionally, or alternatively, be referred to (or be considered) as being performed by the NCR 1506.

The controller 1508, in some aspects, may be connected to, or in communication with, the NCR-MT to receive wireless communication from the base station 1502. In some aspects, the controller 1508 may further be capable of measuring and/or decoding transmissions from other wireless devices including the base station 1502 and the jamming device 1509. Accordingly, in some aspects, a plurality, or an array, of configurable antenna elements of the controller may be configured to collect interference statistics at 1512 based on jamming signals 1510. In some aspects, the controller 1508 may be configured with periodic measurement and/or sensing windows to detect and/or collect statistics related to a jamming and/or interfering signal. For example, the controller 1508 may be configured to periodically determine if the controller 1508 detects, via a configured set of resources and receive beam directions, a signal with a power above a threshold power (or a BH SINR below a threshold value) and to transmit an indication of the detected interfering signal and, in some aspects, an associated direction (where the direction may be a range associated with a broad lobe of a reception beam).

At 1514, one or more of the base station 1502, the controller 1508, or the UE 1504 may detect interference and/or initiate the method for mitigating interference as discussed in relation to FIG. 11C. For example, in some aspects, the UE 1504 may detect an SINR below a threshold value over a threshold time period (e.g., an average power over a sensing window that is above a threshold value) and transmit an indication to the base station 1502. Alternatively, or additionally, the controller 1508 may detect an interfering signal with a power greater than a threshold power for a time greater than a threshold time (e.g., an average power over a sensing window that is above a threshold value) and transmit an indication to the base station 1502. Based on an indication received from either the UE 1504 or the controller 1508, the base station 1502 may initiate an interference mitigation operation. Based on the known configuration of the NCR 1506 (e.g., the configuration of the plurality of configurable antenna elements of the NCR), the base station 1502 may determine a first set of configurations as discussed in relation to FIGS. 11B and 11C. The first set of configurations, in some aspects, may further be based on known characteristics of potential interfering and/or jamming devices (e.g., jamming device 1509) and/or the indication of the interference statistics collected at 1512 as described in relation to FIGS. 11B and 11C.

For example, a first configuration experiencing interference may be associated with a first main lobe for reception from the network device directed towards the network device and a first set of side (or secondary) lobes for reception directed in a first set of directions corresponding to the first set of side lobes as described in relation to FIG. 11A. In some aspects, the first set of configurations may include one or more configurations associated with a second main lobe for reception directed in a direction in the first set of directions as described in relation to FIG. 11B. In some aspects, the first set of configurations of the plurality of configurable antenna elements may use a greater number of configurable antenna elements than the first configuration associated with the first configuration that experienced the interference. In some aspects, each configuration in the first set of configurations may be associated with a main (receive) lobe in the direction of the base station 1502 with different configurations of side lobes (e.g., a set of side lobes in different directions including, for example, a side lobe that may be different from the side lobe associated with the first configuration experiencing the interference) as described in relation to FIG. 11B. The different configurations of side lobes, in some aspects, may include narrower beams associated with reception and/or nulls (e.g., directions associated with a zero, or near-zero, gain). In some aspects, the different configurations of side lobes may be possible based on using the larger number of configurable antenna elements to provide additional control over the characteristics of the receive lobes and/or directions (e.g., compared to an energy-saving configuration using a smaller numbers of configurable antenna elements). The different configurations of side lobes, in some aspects, may be used to more accurately identify the direction associated with the jamming signal. The first set of configurations, in some aspects, may further be associated with a forwarding direction towards the UE 1504 such that the UE 1504 may measure signals (e.g., including a signal from the base station 1502 and the jamming device 1509) in association with the method for interference mitigation.

The base station 1502 may initiate the method for interference mitigation and may transmit, and the controller 1508 and the UE 1504 may receive, the first set of configurations 1516. In some aspects, the first set of configurations may be associated with a set of resources (frequency and/or time resources) that do not interfere with the communication between the base station 1502 and the UE 1504 as described in relation to FIG. 12D. Additionally, or alternatively, the first interference-direction sensing operation may measure a (per-frequency-band and/or per-frequency resource) power associated with a set of frequency bands and identify and/or determine the frequency bands that are associated with a power above a threshold value (e.g., a threshold power value that may be different from (or lower than) the threshold power value used for identifying and/or determining the one or more potential directions).

Based on receiving the first set of configurations 1516, the controller 1508 and the NCR 1506 may, at 1526, apply and/or implement (e.g., configure the plurality of configurable antenna elements of the NCR based on) a first configuration in the first set of configurations. Additionally, based on receiving the first set of configurations 1516, the UE 1504 may, at 1528 monitor for and/or measure and collect information regarding signals received in association with each configuration in the first set of configurations. The NCR 1506 may, while in the first configuration of the first set of configurations, receive, amplify, and forward an impinging set of transmissions 1530 including a signal transmitted by the base station 1502 and an interference transmitted by the jamming device 1509 that is measured, at 1528, by the UE 1504.

Similarly, the controller 1508 and the NCR 1506 may, apply and/or implement (e.g., configure the plurality of configurable antenna elements of the NCR based on) additional configurations in the first set of configurations, and, while in each configuration of the first set of configurations, receive, amplify, and forward an impinging set of transmissions including a signal transmitted by the base station 1502 and an interference transmitted by the jamming device 1509 that is measured, at 1528, by the UE 1504 until a last (e.g., an N^{th}) configuration is applied and/or implemented at 1532 to receive, amplify, and forward the impinging set of transmissions 1534 including a signal transmitted by the base station 1502 and an interference transmitted by the jamming device 1509 that is measured, at 1528, by the UE 1504. Once the reflected signals (e.g., based on the received set of transmissions 1530 and 1534) have been measured at the UE 1504, the UE 1504 may prepare a report and transmit an indication 1536 of the interference measurements. The indication 1536, in some aspects, may include an indication of one or more of (1) the measurements (e.g., an SINR or RSRQ) associated with each configuration in the first set of configurations, (2) an indication of one or more configurations in the first set of configurations associated with an SINR above (or below) a threshold SINR (e.g., a per-frequency band SINR or an SINR across all monitored frequencies), or (3) other information (for instance complex valued I/Q samples of received observations) regarding the signal measured at the UE 1504).

Based on known interferer information and/or the information provided by the controller 1508 and the UE 1504 (e.g., one or more of the statistics collected at 1512 and/or the indication 1536), the base station 1502 (or an associated network entity or function) may determine an optimized configuration for communication between the base station 1502 and the UE 1504 that reduces the effects of the interference from the jamming device 1509 (or a plurality of jamming devices including jamming device 1509). The base station 1502 may transmit, and the controller 1508 may receive, an interference mitigating configuration 1538 for the NCR 1506 (e.g., a configuration of the plurality of configurable antenna elements of the NCR). In some aspects, at least one configuration in the first set of configurations may use (or be associated with) a first number of configurable (antenna) elements and the interference mitigating configuration 1538 for the NCR 1506 may use (or be associated with) a second number of configurable (antenna) elements, where the first number of configurable elements is greater than or equal to the second number of configurable elements. The controller 1508 and the NCR 1506 may, at 1540 apply the interference mitigating configuration 1538 and receive, amplify, and forward communication 1550 as forwarded communication 1552.

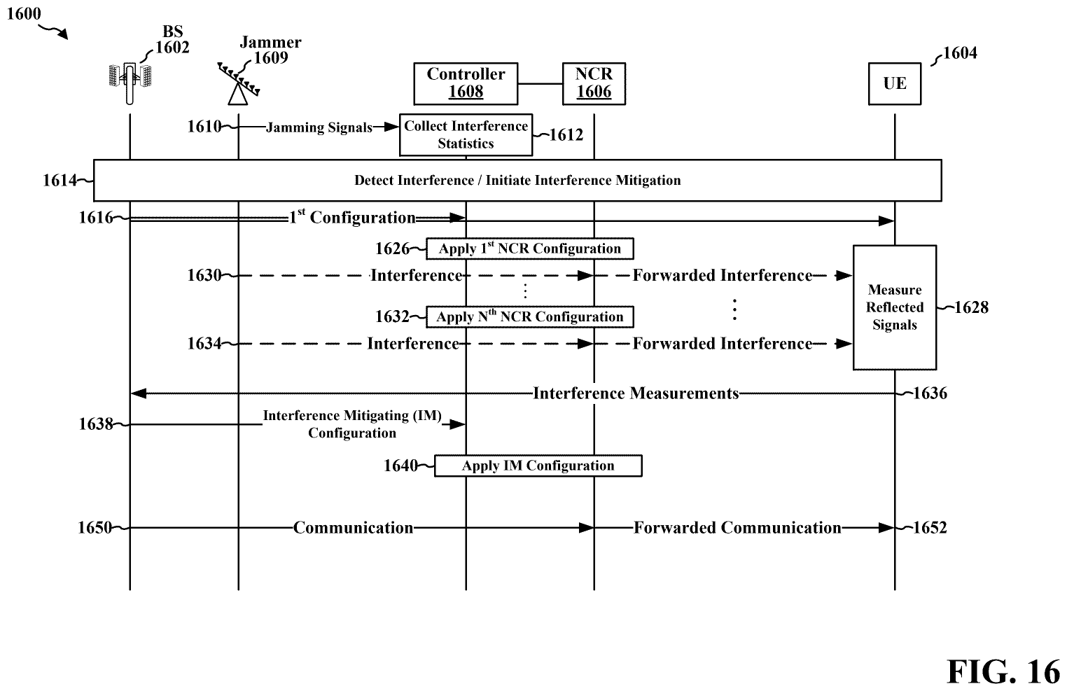

FIG. 16 is a call flow diagram 1600 illustrating a method for mitigating interference from a jamming device 1609 for a communication between a base station 1602 and a UE 1604 via an NCR 1606 in accordance with some aspects of the disclosure. The method is illustrated in relation to a base station 1602 (e.g., as an example of a network device or network node that may include one or more components of a disaggregated base station) in communication with a UE 1604 (e.g., as an example of a wireless device). The functions ascribed to the base station 1602, in some aspects, may be performed by one or more components of a network entity, a network node, or a network device (a single network entity/node/device or a disaggregated network entity/node/device as described above in relation to FIG. 1). Similarly, the functions ascribed to the UE 1604, in some aspects, may be performed by one or more components of a wireless device supporting communication with a network entity/node/device. Accordingly, references to “transmitting” in the description below may be understood to refer to a first component of the base station 1602 (or the UE 1604) outputting (or providing) an indication of the content of the transmission to be transmitted by a different component of the base station 1602 (or the UE 1604). Similarly, references to “receiving” in the description below may be understood to refer to a first component of the base station 1602 (or the UE 1604) receiving a transmitted signal and outputting (or providing) the received signal (or information based on the received signal) to a different component of the base station 1602 (or the UE 1604). As described in relation to FIG. 6, the NCR 1606 may include a first set of configurable antenna elements (e.g., NCR-MT 612) capable of receiving transmissions from a network device and a first set of configurable antenna elements (e.g., NCR-FWD or forwarding node 614) capable of transmitting (e.g., forwarding) a received (and amplified) transmission to an additional wireless device. The NCR 1606, in some aspects, may be collocated and/or included in a same device or housing as the controller 1608 (e.g., an NCR controller) and may communicate via wired or wireless communication. Accordingly, while some actions may be ascribed to the controller 1608, in some aspects, they may additionally, or alternatively, be referred to (or be considered) as being performed by the NCR 1606.

The controller 1608, in some aspects, may be connected to, or in communication with, the NCR-MT to receive wireless communication from the base station 1602. In some aspects, the controller 1608 may further be capable of measuring and/or decoding transmissions from other wireless devices including the base station 1602 and the jamming device 1609. Accordingly, in some aspects, a plurality, or an array, of configurable antenna elements of the controller may be configured to collect interference statistics at 1612 based on jamming signals 1610. In some aspects, the controller 1608 may be configured with periodic measurement and/or sensing windows to detect and/or collect statistics related to a jamming and/or interfering signal. For example, the controller 1608 may be configured to periodically determine if the controller 1608 detects, via a configured set of resources and receive beam directions, a signal with a power above a threshold power (or a BH SINR below a threshold value) and to transmit an indication of the detected interfering signal and, in some aspects, an associated direction (where the direction may be a range associated with a broad lobe of a reception beam).

At 1614, one or more of the base station 1602, the controller 1608, or the UE 1604 may detect interference and/or initiate the method for mitigating interference as discussed in relation to FIGS. 12A, 12B, and 12C. For example, in some aspects, the UE 1604 may detect an SINR below a threshold value over a threshold time period (e.g., an average power over a sensing window that is above a threshold value) and transmit an indication to the base station 1602. Alternatively, or additionally, the controller 1608 may detect an interfering signal with a power greater than a threshold power for a time greater than a threshold time (e.g., an average power over a sensing window that is above a threshold value) and transmit an indication to the base station 1602. Based on an indication received from either the UE 1604 or the controller 1608, the base station 1602 may initiate an interference mitigation operation. Based on the known configuration of the NCR 1606 (e.g., the configuration of the plurality of configurable antenna elements of the NCR), the base station 1602 may determine a first set of configurations as discussed in relation to FIGS. 12A, 12B, and 12C. The first set of configurations, in some aspects, may further be based on known characteristics of potential interfering and/or jamming devices (e.g., jamming device 1609) and/or the indication of the interference statistics collected at 1612 as described in relation to FIGS. 12A, 12B, and 12C.

For example, a first configuration experiencing interference may be associated with a first main lobe for reception from the network device directed towards the network device and a first set of side (or secondary) lobes for reception directed in a first set of directions corresponding to the first set of side lobes as described in relation to FIG. 12A. In some aspects, the first set of configurations may include one or more configurations associated with a second main lobe for reception directed in a direction in the first set of directions as described in relation to FIG. 12B. In some aspects, the first set of configurations of the plurality of configurable antenna elements may use a greater number of configurable antenna elements than the first configuration associated with the first configuration that experienced the interference. In some aspects, each configuration in the first set of configurations may be associated with a main (receive) lobe and/or direction in a set of possible lobes and/or directions that may be associated with a direction of the jamming device 1609. The different configurations of main (receive) lobes, in some aspects, may include narrower beams associated with reception and/or nulls (e.g., directions associated with a zero, or near-zero, gain). In some aspects, the different configurations of side lobes may be possible based on using the larger number of configurable antenna elements to provide additional control over the characteristics of the receive lobes and/or directions (e.g., compared to an energy-saving configuration using a smaller numbers of configurable antenna elements). The different configurations of main (receive) lobes, in some aspects, may be used to more accurately identify the direction associated with the jamming signal. The first set of configurations, in some aspects, may further be associated with a forwarding direction towards the UE 1604 such that the UE 1604 may measure signals (e.g., signals from the jamming device 1609) in association with the method for interference mitigation.

The base station 1602 may initiate the method for interference mitigation and may transmit, and the controller 1608 and the UE 1604 may receive, the first set of configurations 1616. In some aspects, the first set of configurations may be associated with a set of resources (frequency and/or time resources) that do not interfere with the communication between the base station 1602 and the UE 1604 as described in relation to FIG. 12B. Additionally, or alternatively, the first interference-direction sensing operation may measure a (per-frequency-band and/or per-frequency resource) power associated with a set of frequency bands and identify and/or determine the frequency bands that are associated with a power above a threshold value (e.g., a threshold power value that may be different from (or lower than) the threshold power value used for identifying and/or determining the one or more potential directions).

Based on receiving the first set of configurations 1616, the controller 1608 and the NCR 1606 may, at 1626, apply and/or implement (e.g., configure the plurality of configurable antenna elements of the NCR based on) a first configuration in the first set of configurations. Additionally, based on receiving the first set of configurations 1616, the UE 1604 may, at 1628 monitor for and/or measure and collect information regarding signals received in association with each configuration in the first set of configurations. The NCR 1606 may, while in the first configuration of the first set of configurations, receive, amplify, and forward an interfering transmission 1630 (e.g., if there is an interfering signal) transmitted by the jamming device 1609 that is measured, at 1628, by the UE 1604.

Similarly, the controller 1608 and the NCR 1606 may, apply and/or implement (e.g., configure the plurality of configurable antenna elements of the NCR based on) additional configurations in the first set of configurations, and, while in each configuration of the first set of configurations, receive, amplify, and forward an interfering transmission transmitted by the jamming device 1609 that is measured, at 1628, by the UE 1604 until a last (e.g., an N^{th}) configuration is applied and/or implemented at 1632 to receive, amplify, and forward the interfering transmission 1634 transmitted by the jamming device 1609 that is measured, at 1628, by the UE 1604. Once the forwarded signals (e.g., based on the received set of transmissions 1630 and 1634) have been measured at the UE 1604, the UE 1604 may prepare a report and transmit an indication 1636 of the interference measurements. The indication 1636, in some aspects, may include an indication of one or more of (1) the measurements (e.g., an SINR or RSRQ) associated with each configuration in the first set of configurations, (2) an indication of one or more configurations in the first set of configurations associated with an SINR above (or below) a threshold SINR (e.g., a per-frequency band SINR or an SINR across all monitored frequencies), or (3) other information (for instance complex valued I/Q samples of received observations) regarding the signal measured at the UE 1604).

Based on known interferer information and/or the information provided by the controller 1608 and the UE 1604 (e.g., one or more of the statistics collected at 1612 and/or the indication 1636), the base station 1602 (or an associated network entity or function) may determine an optimized configuration for communication between the base station 1602 and the UE 1604 that reduces the effects of the interference from the jamming device 1609 (or a plurality of jamming devices including jamming device 1609). The base station 1602 may transmit, and the controller 1608 may receive, an interference mitigating configuration 1638 for the NCR 1606 (e.g., a configuration of the plurality of configurable antenna elements of the NCR). In some aspects, at least one configuration in the first set of configurations may use (or be associated with) a first number of configurable (antenna) elements and the interference mitigating configuration 1638 for the NCR 1606 may use (or be associated with) a second number of configurable (antenna) elements, where the first number of configurable elements is greater than or equal to the second number of configurable elements. The controller 1608 and the NCR 1606 may, at 1640 apply the interference mitigating configuration 1638 and receive, amplify, and forward communication 1650 as forwarded communication 1652.

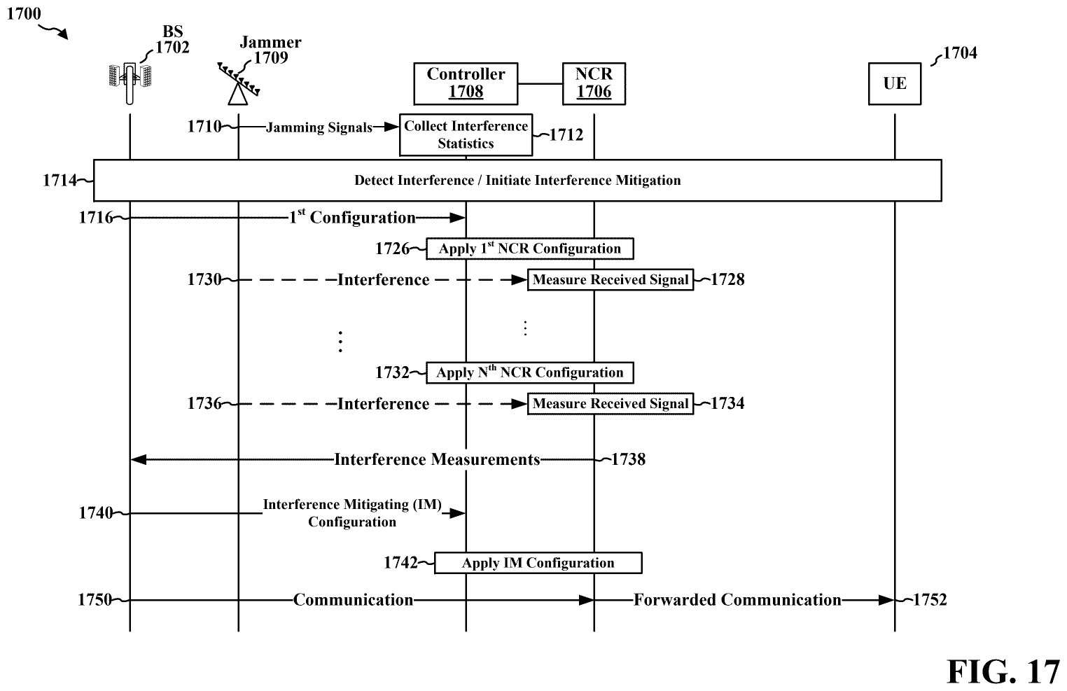

FIG. 17 is a call flow diagram 1700 illustrating a method for mitigating interference from a jamming device 1709 for a communication between a base station 1702 and a UE 1704 via an NCR 1706 in accordance with some aspects of the disclosure. The method is illustrated in relation to a base station 1702 (e.g., as an example of a network device or network node that may include one or more components of a disaggregated base station) in communication with a UE 1704 (e.g., as an example of a wireless device). The functions ascribed to the base station 1702, in some aspects, may be performed by one or more components of a network entity, a network node, or a network device (a single network entity/node/device or a disaggregated network entity/node/device as described above in relation to FIG. 1). Similarly, the functions ascribed to the UE 1704, in some aspects, may be performed by one or more components of a wireless device supporting communication with a network entity/node/device. Accordingly, references to “transmitting” in the description below may be understood to refer to a first component of the base station 1702 (or the UE 1704) outputting (or providing) an indication of the content of the transmission to be transmitted by a different component of the base station 1702 (or the UE 1704). Similarly, references to “receiving” in the description below may be understood to refer to a first component of the base station 1702 (or the UE 1704) receiving a transmitted signal and outputting (or providing) the received signal (or information based on the received signal) to a different component of the base station 1702 (or the UE 1704). As described in relation to FIG. 6, the NCR 1706 may include a first set of configurable antenna elements (e.g., NCR-MT 612) capable of receiving transmissions from a network device and a first set of configurable antenna elements (e.g., NCR-FWD or forwarding node 614) capable of transmitting (e.g., forwarding) a received (and amplified) transmission to an additional wireless device. The NCR 1706, in some aspects, may be collocated and/or included in a same device or housing as the controller 1708 (e.g., an NCR controller) and may communicate via wired or wireless communication. Accordingly, while some actions may be ascribed to the controller 1708, in some aspects, they may additionally, or alternatively, be referred to (or be considered) as being performed by the NCR 1706.

The controller 1708, in some aspects, may be connected to, or in communication with, the NCR-MT to receive wireless communication from the base station 1702. In some aspects, the controller 1708 may further be capable of measuring and/or decoding transmissions from other wireless devices including the base station 1702 and the jamming device 1709. Accordingly, in some aspects, a plurality, or an array, of configurable antenna elements of the controller may be configured to collect interference statistics at 1712 based on jamming signals 1710. In some aspects, the controller 1708 may be configured with periodic measurement and/or sensing windows to detect and/or collect statistics related to a jamming and/or interfering signal. For example, the controller 1708 may be configured to periodically determine if the controller 1708 detects, via a configured set of resources and receive beam directions, a signal with a power above a threshold power (or a BH SINR below a threshold value) and to transmit an indication of the detected interfering signal and, in some aspects, an associated direction (where the direction may be a range associated with a broad lobe of a reception beam).

At 1714, one or more of the base station 1702, the controller 1708, or the UE 1704 may detect interference and/or initiate the method for mitigating interference as discussed in relation to FIGS. 12A, 12B, and 12C. For example, in some aspects, the UE 1704 may detect an SINR below a threshold value over a threshold time period (e.g., an average power over a sensing window that is above a threshold value) and transmit an indication to the base station 1702. Alternatively, or additionally, the controller 1708 may detect an interfering signal with a power greater than a threshold power for a time greater than a threshold time (e.g., an average power over a sensing window that is above a threshold value) and transmit an indication to the base station 1702. Based on an indication received from either the UE 1704 or the controller 1708, the base station 1702 may initiate an interference mitigation operation. Based on the known configuration of the NCR 1706 (e.g., the configuration of the plurality of configurable antenna elements of the NCR), the base station 1702 may determine a first set of configurations as discussed in relation to FIGS. 12A, 12B, and 12C. The first set of configurations, in some aspects, may further be based on known characteristics of potential interfering and/or jamming devices (e.g., jamming device 1709) and/or the indication of the interference statistics collected at 1712 as described in relation to FIGS. 12A, 12B, and 12C.

For example, a first configuration experiencing interference may be associated with a first main lobe for reception from the network device directed towards the network device and a first set of side (or secondary) lobes for reception directed in a first set of directions corresponding to the first set of side lobes as described in relation to FIG. 12A. In some aspects, the first set of configurations may include one or more configurations associated with a second main lobe for reception directed in a direction in the first set of directions as described in relation to FIG. 12B. In some aspects, the first set of configurations of the plurality of configurable antenna elements may use a greater number of configurable antenna elements than the first configuration associated with the first configuration that experienced the interference. In some aspects, each configuration in the first set of configurations may be associated with a main (receive) lobe and/or direction in a set of possible lobes and/or directions that may be associated with a direction of the jamming device 1709. The different configurations of main (receive) lobes, in some aspects, may include narrower beams associated with reception and/or nulls (e.g., directions associated with a zero, or near-zero, gain). In some aspects, the different configurations of side lobes may be possible based on using the larger number of configurable antenna elements to provide additional control over the characteristics of the receive lobes and/or directions (e.g., compared to an energy-saving configuration using a smaller numbers of configurable antenna elements). The different configurations of main (receive) lobes, in some aspects, may be used to more accurately identify the direction associated with the jamming signal. The first set of configurations, in some aspects, may further be associated with a measurement of possible interfering signals at the NCR 1706 in association with the method for interference mitigation.

The base station 1702 may initiate the method for interference mitigation and may transmit, and the controller 1708 may receive, the first set of configurations 1716. In some aspects, the first set of configurations may be associated with a set of resources (frequency and/or time resources) that do not interfere with the communication between the base station 1702 and the UE 1704 as described in relation to FIG. 12B. Additionally, or alternatively, the first interference-direction sensing operation may measure a (per-frequency-band and/or per-frequency resource) power associated with a set of frequency bands and identify and/or determine the frequency bands that are associated with a power above a threshold value (e.g., a threshold power value that may be different from (or lower than) the threshold power value used for identifying and/or determining the one or more potential directions).

Based on receiving the first set of configurations 1716, the controller 1708 and the NCR 1706 may, at 1726, apply and/or implement (e.g., configure the plurality of configurable antenna elements of the NCR, or the NCR-MT, based on) a first configuration in the first set of configurations and begin monitoring for and/or measuring signals based on the first configuration. The NCR 1706 may, while in the first configuration of the first set of configurations, receive an interfering transmission 1730 (e.g., if there is an interfering signal) transmitted by the jamming device 1709 and measure, at 1728, the interfering transmission 1730 (e.g., measure a power associated with the signal).

Similarly, the controller 1708 and the NCR 1706 may, apply and/or implement (e.g., configure the plurality of configurable antenna elements of the NCR based on) additional configurations in the first set of configurations, and, while in each configuration of the first set of configurations, receive an interfering transmission transmitted by the jamming device 1709 and measure the interfering transmission until a last (e.g., an N^{th}) configuration is applied and/or implemented at 1732 to receive an interfering transmission 1736 transmitted by the jamming device 1709 and monitor for and/or measure, at 1734, the interfering transmission 1736. Once the received signals (e.g., based on the received set of transmissions 1730 and 1734) have been measured at the NCR 1706, the NCR 1706 may prepare a report and transmit an indication 1738 of the interference measurements. The indication 1738, in some aspects, may include an indication of one or more of (1) the measurements (e.g., an SINR or RSRQ) associated with each configuration in the first set of configurations, (2) an indication of one or more configurations in the first set of configurations associated with an SINR above (or below) a threshold SINR (e.g., a per-frequency band SINR or an SINR across all monitored frequencies), or (3) other information (for instance complex valued I/Q samples of received observations) regarding the signal measured at the UE 1704).

Based on known interferer information and/or the information provided by the controller 1708 (e.g., one or more of the statistics collected at 1712 and/or the indication 1738), the base station 1702 (or an associated network entity or function) may determine an optimized configuration for communication between the base station 1702 and the UE 1704 that reduces the effects of the interference from the jamming device 1709 (or a plurality of jamming devices including jamming device 1709). The base station 1702 may transmit, and the controller 1708 may receive, an interference mitigating configuration 1740 for the NCR 1706 (e.g., a configuration of the plurality of configurable antenna elements of the NCR). In some aspects, at least one configuration in the first set of configurations may use (or be associated with) a first number of configurable (antenna) elements and the interference mitigating configuration 1740 for the NCR 1706 may use (or be associated with) a second number of configurable (antenna) elements, where the first number of configurable elements is greater than or equal to the second number of configurable elements. The controller 1708 and the NCR 1706 may, at 1742 apply the interference mitigating configuration 1740 and receive, amplify, and forward communication 1750 as forwarded communication 1752.

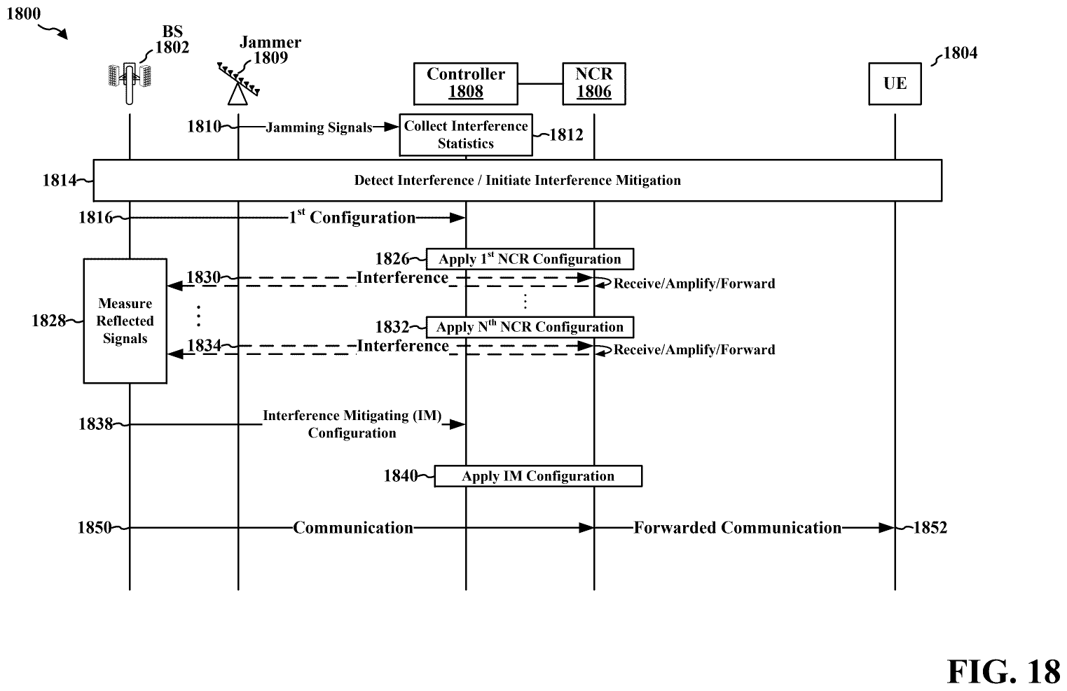

FIG. 18 is a call flow diagram 1800 illustrating a method for mitigating interference from a jamming device 1809 for a communication between a base station 1802 and a UE 1804 via an NCR 1806 in accordance with some aspects of the disclosure. The method is illustrated in relation to a base station 1802 (e.g., as an example of a network device or network node that may include one or more components of a disaggregated base station) in communication with a UE 1804 (e.g., as an example of a wireless device). The functions ascribed to the base station 1802, in some aspects, may be performed by one or more components of a network entity, a network node, or a network device (a single network entity/node/device or a disaggregated network entity/node/device as described above in relation to FIG. 1). Similarly, the functions ascribed to the UE 1804, in some aspects, may be performed by one or more components of a wireless device supporting communication with a network entity/node/device. Accordingly, references to “transmitting” in the description below may be understood to refer to a first component of the base station 1802 (or the UE 1804) outputting (or providing) an indication of the content of the transmission to be transmitted by a different component of the base station 1802 (or the UE 1804). Similarly, references to “receiving” in the description below may be understood to refer to a first component of the base station 1802 (or the UE 1804) receiving a transmitted signal and outputting (or providing) the received signal (or information based on the received signal) to a different component of the base station 1802 (or the UE 1804). As described in relation to FIG. 6, the NCR 1806 may include a first set of configurable antenna elements (e.g., NCR-MT 612) capable of receiving transmissions from a network device and a first set of configurable antenna elements (e.g., NCR-FWD or forwarding node 614) capable of transmitting (e.g., forwarding) a received (and amplified) transmission to an additional wireless device. The NCR 1806, in some aspects, may be collocated and/or included in a same device or housing as the controller 1808 (e.g., an NCR controller) and may communicate via wired or wireless communication. Accordingly, while some actions may be ascribed to the controller 1808, in some aspects, they may additionally, or alternatively, be referred to (or be considered) as being performed by the NCR 1806.

The controller 1808, in some aspects, may be connected to, or in communication with, the NCR-MT to receive wireless communication from the base station 1802. In some aspects, the controller 1808 may further be capable of measuring and/or decoding transmissions from other wireless devices including the base station 1802 and the jamming device 1809. Accordingly, in some aspects, a plurality, or an array, of configurable antenna elements of the controller may be configured to collect interference statistics at 1812 based on jamming signals 1810. In some aspects, the controller 1808 may be configured with periodic measurement and/or sensing windows to detect and/or collect statistics related to a jamming and/or interfering signal. For example, the controller 1808 may be configured to periodically determine if the controller 1808 detects, via a configured set of resources and receive beam directions, a signal with a power above a threshold power (or a BH SINR below a threshold value) and to transmit an indication of the detected interfering signal and, in some aspects, an associated direction (where the direction may be a range associated with a broad lobe of a reception beam).

At 1814, one or more of the base station 1802, the controller 1808, or the UE 1804 may detect interference and/or initiate the method for mitigating interference as discussed in relation to FIGS. 12A, 12B, and 12C. For example, in some aspects, the UE 1804 may detect an SINR below a threshold value over a threshold time period (e.g., an average power over a sensing window that is above a threshold value) and transmit an indication to the base station 1802. Alternatively, or additionally, the controller 1808 may detect an interfering signal with a power greater than a threshold power for a time greater than a threshold time (e.g., an average power over a sensing window that is above a threshold value) and transmit an indication to the base station 1802. Based on an indication received from either the UE 1804 or the controller 1808, the base station 1802 may initiate an interference mitigation operation. Based on the known configuration of the NCR 1806 (e.g., the configuration of the plurality of configurable antenna elements of the NCR), the base station 1802 may determine a first set of configurations as discussed in relation to FIGS. 12A, 12B, and 12C. The first set of configurations, in some aspects, may further be based on known characteristics of potential interfering and/or jamming devices (e.g., jamming device 1809) and/or the indication of the interference statistics collected at 1812 as described in relation to FIGS. 12A, 12B, and 12C.

For example, a first configuration experiencing interference may be associated with a first main lobe for reception from the network device directed towards the network device and a first set of side (or secondary) lobes for reception directed in a first set of directions corresponding to the first set of side lobes as described in relation to FIG. 12A. In some aspects, the first set of configurations may include one or more configurations associated with a second main lobe for reception directed in a direction in the first set of directions as described in relation to FIG. 12B. In some aspects, the first set of configurations of the plurality of configurable antenna elements may use a greater number of configurable antenna elements than the first configuration associated with the first configuration that experienced the interference. In some aspects, each configuration in the first set of configurations may be associated with a main (receive) lobe and/or direction in a set of possible lobes and/or directions that may be associated with a direction of the jamming device 1809. The different configurations of main (receive) lobes, in some aspects, may include narrower beams associated with reception and/or nulls (e.g., directions associated with a zero, or near-zero, gain). In some aspects, the different configurations of side lobes may be possible based on using the larger number of configurable antenna elements to provide additional control over the characteristics of the receive lobes and/or directions (e.g., compared to an energy-saving configuration using a smaller numbers of configurable antenna elements). The different configurations of main (receive) lobes, in some aspects, may be used to more accurately identify the direction associated with the jamming signal. The first set of configurations, in some aspects, may further be associated with a measurement of possible interfering signals at the base station 1802 in association with the method for interference mitigation.

The base station 1802 may initiate the method for interference mitigation and may transmit, and the controller 1808 may receive, the first set of configurations 1816. In some aspects, the first set of configurations may be associated with a set of resources (frequency and/or time resources) that do not interfere with the communication between the base station 1802 and the UE 1804 as described in relation to FIG. 12B. Additionally, or alternatively, the first interference-direction sensing operation may measure a (per-frequency-band and/or per-frequency resource) power associated with a set of frequency bands and identify and/or determine the frequency bands that are associated with a power above a threshold value (e.g., a threshold power value that may be different from (or lower than) the threshold power value used for identifying and/or determining the one or more potential directions).

Based on receiving the first set of configurations 1816, the controller 1808 and the NCR 1806 may, at 1826, apply and/or implement (e.g., configure the plurality of configurable antenna elements of the NCR based on) a first configuration in the first set of configurations. Additionally, based on the first set of configurations 1816, the base station 1802 may, at 1828 monitor for and/or measure and collect information regarding signals received in association with each configuration in the first set of configurations. The NCR 1806 may, while in the first configuration of the first set of configurations, receive, amplify, and forward an interfering transmission 1830 (e.g., if there is an impinging interfering signal) transmitted by the jamming device 1809 that is measured, at 1828, by the base station 1802.

Similarly, the controller 1808 and the NCR 1806 may, apply and/or implement (e.g., configure the plurality of configurable antenna elements of the NCR based on) additional configurations in the first set of configurations, and, while in each configuration of the first set of configurations, receive, amplify, and forward an interfering transmission transmitted by the jamming device 1809 that is measured, at 1828, by the base station 1802 until a last (e.g., an N^{th}) configuration is applied and/or implemented at 1832 to receive, amplify, and forward an interfering transmission 1834 transmitted by the jamming device 1809 that is measured, at 1828, by the base station 1802.

Based on the measurements performed by the base station 1802, known interferer information, and the information received from the controller 1808 (e.g., the statistics collected at 1812), the base station 1802 (or an associated network entity or function) may determine an optimized configuration for communication between the base station 1802 and the UE 1804 that reduces the effects of the interference from the jamming device 1809 (or a plurality of jamming devices including jamming device 1809. The base station 1802 may transmit, and the controller 1808 may receive, an interference mitigating configuration 1838 for the NCR 1806 (e.g., a configuration of the plurality, or array, of configurable antenna elements of the NCR). In some aspects, at least one configuration in the first set of configurations may use (or be associated with) a first number of configurable (antenna) elements and the interference mitigating configuration 1838 for the NCR 1806 may use (or be associated with) a second number of configurable (antenna) elements, where the first number of configurable elements is greater than or equal to the second number of configurable elements. The controller 1808 and the NCR 1806 may, at 1840 apply the interference mitigating configuration 1838 and reflect impinging communication 1850 as reflected communication 1852.

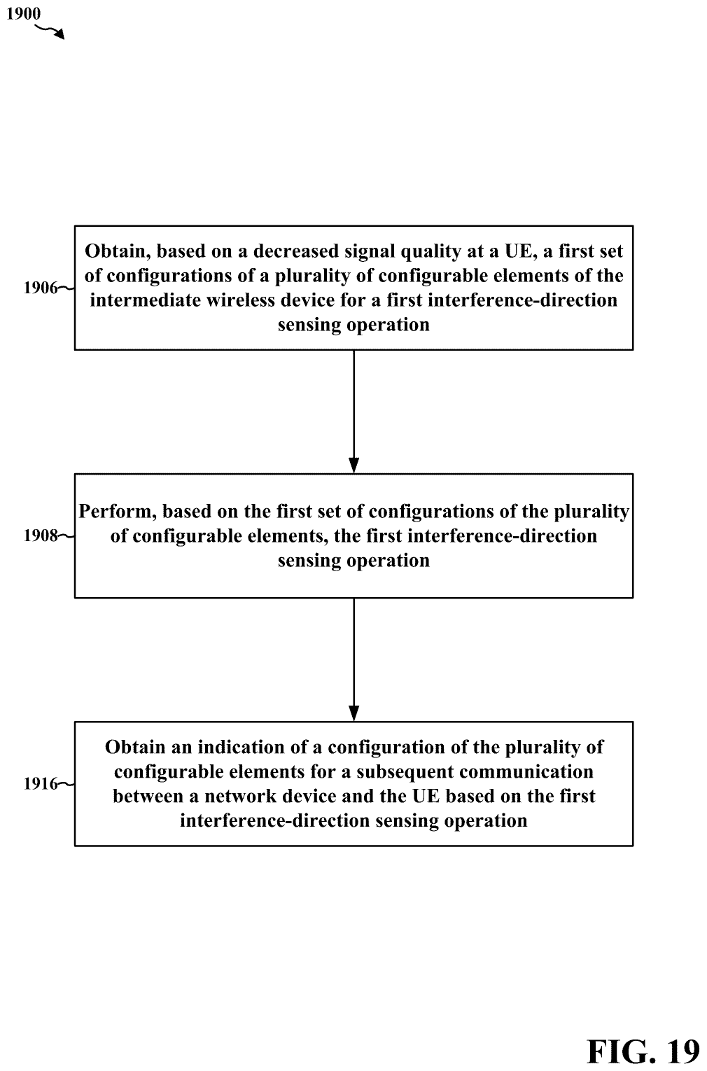

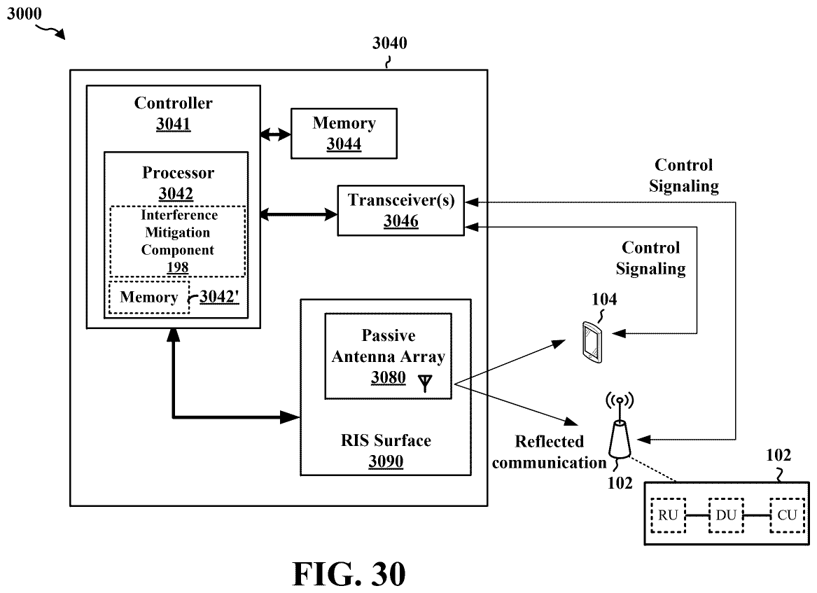

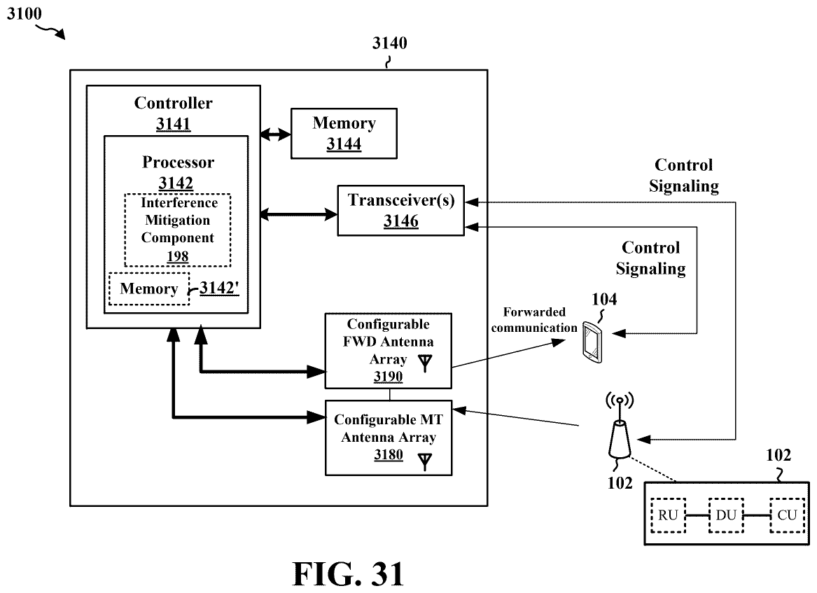

FIG. 19 is a flowchart 1900 of a method of wireless communication. The method may be performed by a RIS facilitating communication between a network device such as a base station and a UE (e.g., the RIS/Repeater 103; the RIS 406, 506, 706, 906, 1006, 1306, 1406; the RIS 3040) or by an NCR facilitating communication between the network device and the UE (e.g., the RIS/Repeater 103; the NCR 446, 806, 1106, 1206, 1506, 1606, 1706, 1806; the repeater 606; the NCR 3140). At 1906, the RIS/NCR may obtain, based on a decreased signal quality at a UE, a first set of configurations of a plurality of configurable elements of the intermediate wireless device for a first interference-direction sensing operation. For example, 1906 may be performed by controller 3041, processor(s) 3042, transceiver(s) 3046, and/or interference mitigation component 198 of FIG. 30 or by controller 3141, processor(s) 3142, transceiver(s) 3146, configurable MT antenna array 3180, configurable FWD antenna array 3190, and/or interference mitigation component 198 of FIG. 31. For example, referring to FIGS. 13-18, the RIS 1306/1406 (or the controller 1308/1408) and/or the NCR 1506/1606/1706/1806 (or the controller 1508/1608/1708/1808) may, receive the first set of configurations 1316/1416/1516/1616/1716/1816.

At 1908, the RIS/NCR may perform, based on the first set of configurations of the plurality of configurable elements, the first interference-direction sensing operation. For example, 1908 may be performed by controller 3041, processor(s) 3042, transceiver(s) 3046, passive antenna array 3080, RIS surface 3090, and/or interference mitigation component 198 of FIG. 30 or by controller 3141, processor(s) 3142, transceiver(s) 3146, configurable MT antenna array 3180, configurable FWD antenna array 3190, and/or interference mitigation component 198 of FIG. 31. In some aspects, the decreased signal quality at the UE may be associated with a first configuration of the plurality of configurable elements. The first configuration, in some aspects, may be associated with a first main lobe for reception from the network device directed towards the network device and a first set of side lobes for reception directed in a first set of directions corresponding to the first set of side lobes. For example, referring to FIGS. 9A, 10A, 11A, and 12A, a first RIS/NCR configuration may be associated with a main lobe and/or direction 914/1014/1114/1214 and at least one side lobe and/or direction 916/1016/1116/1216. The first set of configurations, in some aspects, may include one or more configurations associated with a second main lobe for reception directed in a direction in the first set of directions. In some aspects, the first set of configurations may include one or more configurations associated with a second main lobe for reception directed to the network device and at least one null for reception in a direction in the first set of directions. For example, referring to FIGS. 9B, 10B, 11B, 12B, and 13-18, the RIS 906/1006/1306/1406 (or the controller 908/1008/1308/1408) and/or the NCR 1106/1206/1506/1606/1706/1806 (or the controller 1108/1208/1508/1608/1708/1808) may perform a first interference-direction sensing operation based on the first set of configurations 1316/1416/1516/1616/1716/1816 and/or the second set of configurations 1324/1424.

In some aspects, performing the first interference-direction sensing operation may include measuring resources indicated for the first set of configurations. In some aspects, the first interference-direction sensing operation may be associated with a first set of resources that is disjoint from a second set of resources associated with the wireless communication between the network device and the UE. The measurements, in some aspects, may be for a full set of frequencies associated with the communication experiencing the interference and/or may be for a set of one or more frequency ranges (e.g., on a per-frequency-band basis). Performing the first interference-direction sensing operation, in some aspects, may include determining whether any measured signal power is above (or below) a threshold value associated with an interference that may affect the communication.

In some aspects, the RIS/NCR may provide, to the network device, information regarding the first interference-direction sensing operation. The information regarding the first interference-direction sensing operation, in some aspects, may include measurements of the jamming signals based on the first interference-direction sensing operation. In some aspects, the information regarding the first interference-direction sensing operation may include an indication of configurations in the first set of configurations that are associated with at least a threshold power.

The RIS, in some aspects, may obtain, based on the first interference-direction sensing operation and for a second interference-direction sensing operation, a second set of configurations of a second subset of the plurality of configurable elements including an array of configurable reflective elements of the RIS (e.g., the intermediate wireless device). In some aspects, the RIS may perform, based on the second set of configurations, the second interference-direction sensing operation. In some aspects, performing the second interference-direction sensing operation may include directing a received interfering signal to the UE for a measurement at the UE, or directing a received interfering signal to the network device for the measurement at the network device. In some aspects, the second interference-direction sensing operation may be associated with a third set of resources that is disjoint from the second set of resources associated with the wireless communication between the network device and the UE.

At 1916, the RIS/NCR may obtain an indication of a configuration of the plurality of configurable elements for a subsequent communication between the network device and the UE based on the first interference-direction sensing operation. For example, 1916 may be performed by controller 3041, processor(s) 3042, transceiver(s) 3046, passive antenna array 3080, RIS surface 3090, and/or interference mitigation component 198 of FIG. 30 or by controller 3141, processor(s) 3142, transceiver(s) 3146, configurable MT antenna array 3180, configurable FWD antenna array 3190, and/or interference mitigation component 198 of FIG. 31. In some aspects, the indication of the configuration of the plurality of configurable elements may also be based on the second interference-direction sensing operation. Referring to FIGS. 13-18, for example, RIS 1306/1406 (or the controller 1308/1408) and/or the NCR 1506/1606/1706/1806 (or the controller 1508/1608/1708/1808) may receive the interference mitigating configuration 1338/1438/1538/1638/1740/1838. In some aspects, the RIS/NCR may reflect/forward the subsequent communication based on the indicated configuration of the plurality of configurable elements.

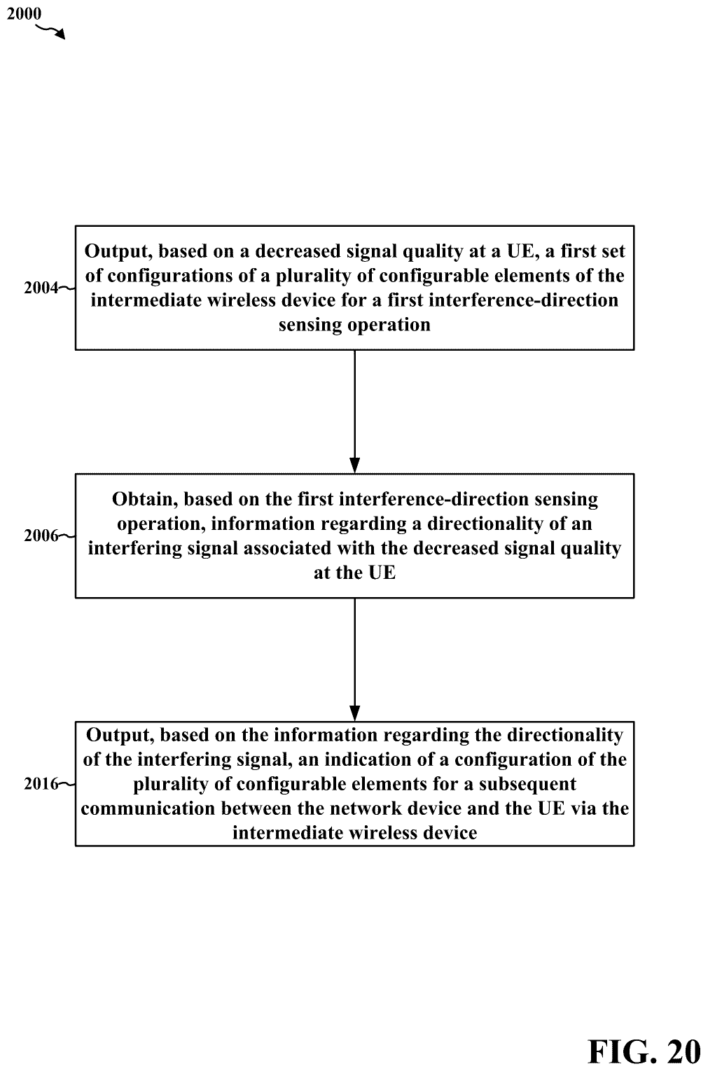

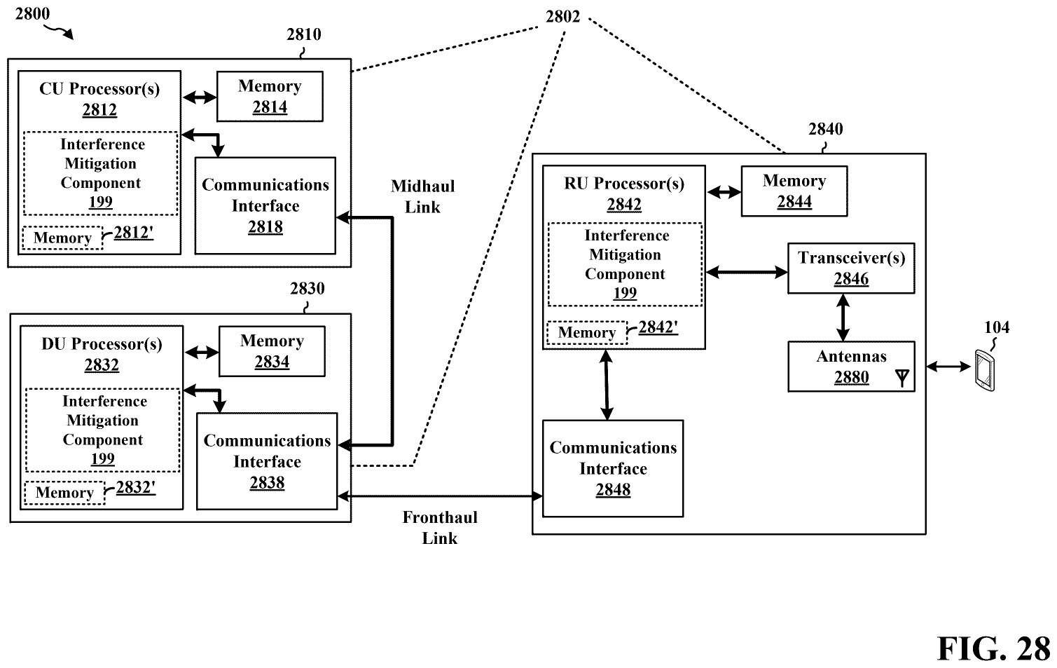

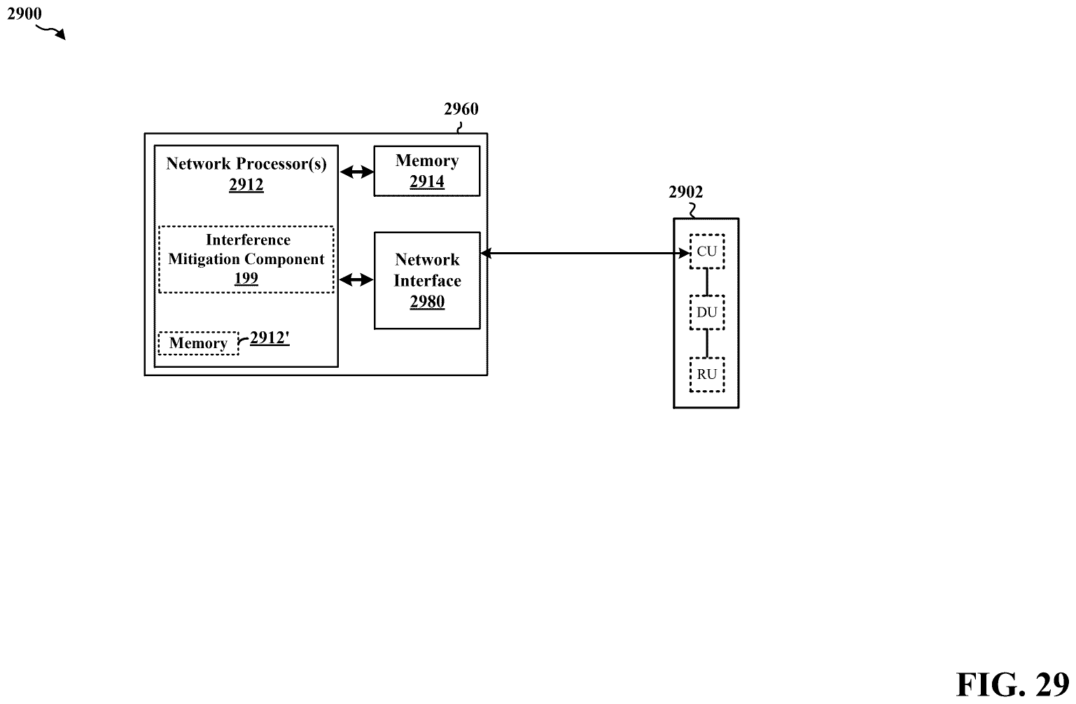

FIG. 20 is a flowchart 2000 of a method of wireless communication. The method may be performed by a base station (e.g., the base station 102, 402, 502, 702, 902, 1002, 1302, 1402; the network node 602; the network entity 2702, 2802, 2960). At 2004, the base station may output, based on a decreased signal quality at a UE, a first set of configurations of a plurality of configurable elements of the intermediate wireless device for a first interference-direction sensing operation. For example, 2004 may be performed by CU processor(s) 2812, DU processor(s) 2832, RU processor(s) 2842, transceiver(s) 2846, antenna(s) 2880, network processor 2912, network interface 2980, and/or interference mitigation component 199 of FIGS. 28 and 29. For example, referring to FIGS. 13-18, the base station 1302/1402/1502/1602/1702/1802 may, transmit the first set of configurations 1316/1416/1516/1616/1716/1816.

In some aspects, the RIS/NCR may perform, based on the first set of configurations of the plurality of configurable elements, the first interference-direction sensing operation. In some aspects, the decreased signal quality at the UE may be associated with a first configuration of the plurality of configurable elements. The first configuration, in some aspects, may be associated with a first main lobe for reception from the network device directed towards the network device and a first set of side lobes for reception directed in a first set of directions corresponding to the first set of side lobes. For example, referring to FIGS. 9A, 10A, 11A, and 12A, a first RIS/NCR configuration may be associated with a main lobe and/or direction 914/1014/1114/1214 and at least one side lobe and/or direction 916/1016/1116/1216. The first set of configurations, in some aspects, may include one or more configurations associated with a second main lobe for reception directed in a direction in the first set of directions. In some aspects, the first set of configurations may include one or more configurations associated with a second main lobe for reception directed to the network device and at least one null for reception in a direction in the first set of directions. For example, referring to FIGS. 9B, 10B, 11B, 12B, and 13-18, the RIS 906/1006/1306/1406 (or the controller 908/1008/1308/1408) and/or the NCR 1106/1206/1506/1606/1706/1806 (or the controller 1108/1208/1508/1608/1708/1808) may perform a first interference-direction sensing operation based on the first set of configurations 1316/1416/1516/1616/1716/1816 and/or the second set of configurations 1324/1424.

In some aspects, performing the first interference-direction sensing operation may include measuring resources indicated for the first set of configurations. In some aspects, the first interference-direction sensing operation may be associated with a first set of resources that is disjoint from a second set of resources associated with the wireless communication between the network device and the UE. The measurements, in some aspects, may be for a full set of frequencies associated with the communication experiencing the interference and/or may be for a set of one or more frequency ranges (e.g., on a per-frequency-band basis). Performing the first interference-direction sensing operation, in some aspects, may include determining whether any measured signal power is above (or below) a threshold value associated with an interference that may affect the communication.

In some aspects, the RIS/NCR may provide, to the network device, information regarding the first interference-direction sensing operation. The information regarding the first interference-direction sensing operation, in some aspects, may include measurements of the jamming signals based on the first interference-direction sensing operation. In some aspects, the information regarding the first interference-direction sensing operation may include an indication of configurations in the first set of configurations that are associated with at least a threshold power.

At 2006, the base station may obtain, based on the first interference-direction sensing operation, information regarding the first interference-direction sensing operation. For example, 2006 may be performed by CU processor(s) 2812, DU processor(s) 2832, RU processor(s) 2842, transceiver(s) 2846, antenna(s) 2880, network processor 2912, network interface 2980, and/or interference mitigation component 199 of FIGS. 28 and 29. The information regarding the first interference-direction sensing operation, in some aspects, may include measurements of the jamming signals based on the first interference-direction sensing operation. In some aspects, the information regarding the first interference-direction sensing operation may include an indication of configurations in the first set of configurations that are associated with at least a threshold power and/or an SINR that is above (or below) a threshold value. For example, referring to FIGS. 13-18, the base station 1302/1402/1502/1602/1702 may, receive the indication 1322/1422/1536/1636/1738 of the interference measurements or the base station 1802 may measure at 1828 the interfering transmissions 1830 and 1834.

The RIS, in some aspects, may obtain, based on the first interference-direction sensing operation and for a second interference-direction sensing operation, a second set of configurations of a second subset of the plurality of configurable elements including an array of configurable reflective elements of the RIS (e.g., the intermediate wireless device). In some aspects, the RIS may perform, based on the second set of configurations, the second interference-direction sensing operation. In some aspects, performing the second interference-direction sensing operation may include directing a received interfering signal to the UE for a measurement at the UE, or directing a received interfering signal to the network device for the measurement at the network device. In some aspects, the second interference-direction sensing operation may be associated with a third set of resources that is disjoint from the second set of resources associated with the wireless communication between the network device and the UE.

At 2016, the base station may output an indication of a configuration of the plurality of configurable elements for a subsequent communication between the network device and the UE based on the first interference-direction sensing operation. For example, 2016 may be performed by CU processor(s) 2812, DU processor(s) 2832, RU processor(s) 2842, transceiver(s) 2846, antenna(s) 2880, network processor 2912, network interface 2980, and/or interference mitigation component 199 of FIGS. 28 and 29. In some aspects, the indication of the configuration of the plurality of configurable elements may also be based on the second interference-direction sensing operation. Referring to FIGS. 13-18, for example, the base station 1302/1402/1502/1602/1702/1802 may transmit the interference mitigating configuration 1338/1438/1538/1638/1740/1838. In some aspects, the base station may transmit the subsequent communication based on the indicated configuration of the plurality of configurable elements.

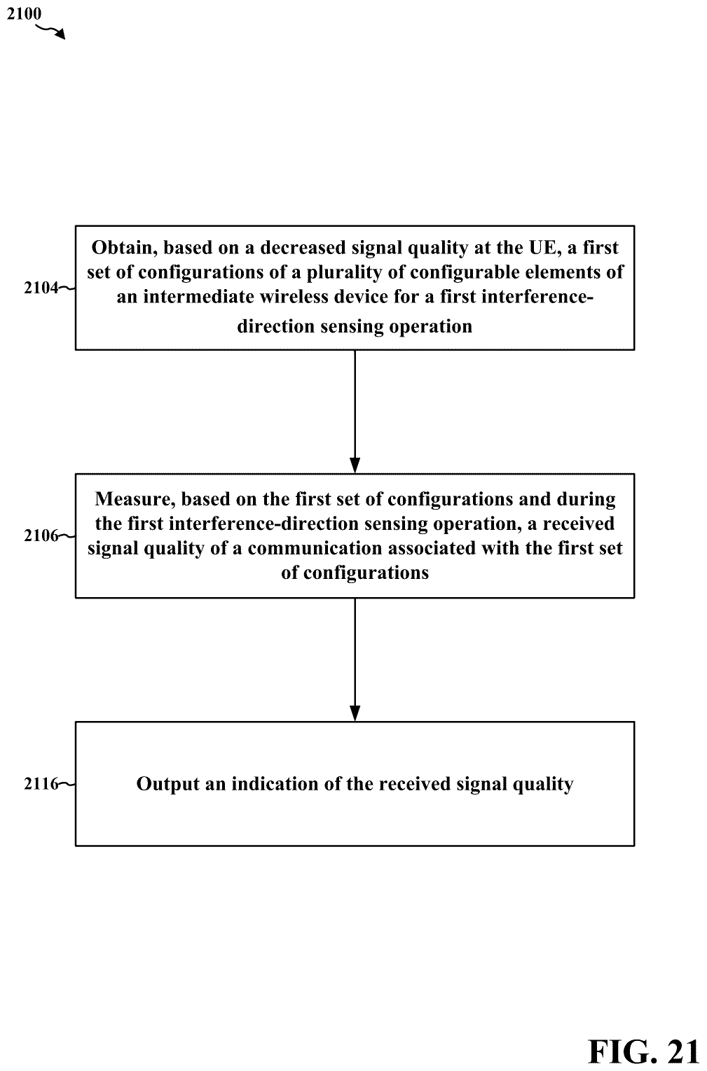

FIG. 21 is a flowchart 2100 of a method of wireless communication. The method may be performed by a UE in communication with a network device via an intermediate wireless device such as a RIS or NCR (e.g., the UE 104, 404, 504, 604, 704, 804, 904, 1004, 1104, 1204, 1304, 1404, 1504, 1604, 1704, 1804; the apparatus 2704). At 2104, the UE may obtain, based on a decreased signal quality at a UE, a first set of configurations of a plurality of configurable elements of the intermediate wireless device for a first interference-direction sensing operation. For example, 2104 may be performed by application processor(s) 2706, cellular baseband processor(s) 2724, transceiver(s) 2722, antenna(s) 2780, and/or interference mitigation component 198 of FIG. 27. For example, referring to FIGS. 9C, 11B, 12B, 13, 15, and 16, the UE 904/1104/1204/1304/1504/1604 may receive the second set of configurations 1324 or the first set of configurations 1516/1616. In some aspects, the decreased signal quality at the UE may be associated with a first configuration of the plurality of configurable elements. The first configuration, in some aspects, may be associated with a first main lobe for reception from the network device directed towards the network device and a first set of side lobes for reception directed in a first set of directions corresponding to the first set of side lobes. For example, referring to FIGS. 9A, 10A, 11A, and 12A, a first RIS or NCR configuration may be associated with a main lobe and/or direction 914/1014/1114/1214 and at least one side lobe and/or direction 916/1016/1116/1216. The first or second set of configurations, in some aspects, may include one or more configurations associated with a second main lobe for reception directed in a direction in the first set of directions.

In some aspects, the first set of configurations of the plurality of configurable antenna elements may use a greater number of configurable antenna elements than the first configuration associated with the first configuration that experienced the interference. In some aspects, each configuration in the first set of configurations may be associated with a main (receive) lobe in the direction of the base station with different configurations of side lobes (e.g., a set of side lobes in different directions including, for example, a side lobe that may be different from the side lobe associated with the first configuration experiencing the interference). The different configurations of side lobes, in some aspects, may include narrower beams associated with reception and/or nulls (e.g., directions associated with a zero, or near-zero, gain). In some aspects, the different configurations of side lobes may be possible based on using the larger number of configurable antenna elements to provide additional control over the characteristics of the receive lobes and/or directions (e.g., compared to an energy-saving configuration using a smaller numbers of configurable antenna elements). The different configurations of side lobes, in some aspects, may be used to more accurately identify the direction associated with the jamming signal. For example, referring to FIGS. 11B and 15, the UE 1104/1504/1604 and the NCR 1106/1506 may be configured according to a first set of configurations 1516.

At 2106, the UE may measure, based on the first set of configurations and during the first interference-direction sensing operation, a received signal quality (and/or power) of a communication associated with the first set of configurations. In some aspects, the communication is between a network device and the UE via the intermediate wireless device. For example, 2106 may be performed by application processor(s) 2706, cellular baseband processor(s) 2724, transceiver(s) 2722, antenna(s) 2780, and/or interference mitigation component 198 of FIG. 27. In some aspects, the first interference-direction sensing operation may be associated with a first set of resources that is disjoint from a second set of resources associated with the wireless communication between the network device and the UE. The measurements, in some aspects, may be for a full set of frequencies associated with the communication experiencing the interference and/or may be for a set of one or more frequency ranges (e.g., on a per-frequency-band basis). The first interference-direction sensing operation, in some aspects, may include determining whether any measured signal power is above (or below) a threshold value associated with an interference that may affect the communication. For example, referring to FIGS. 9C, 11B, 12B, 13, 15, and 16, the UE 904/1104/1204/1304/1504/1604, may, at 1328/1528/1628, measure, and/or monitor for, one or more of the impinging set of transmissions 1330/1530, or the interfering transmissions 1630 while implementing each configuration in the first set of configurations as described in relation to FIGS. 9C, 11B, and 12B based on the first set of configurations 1516/1616/1716/1816.

At 2116, the UE may output an indication of the received signal quality (and or received power). In some aspects, outputting the indication may include transmitting the indication. For example, 2116 may be performed by application processor(s) 2706, cellular baseband processor(s) 2724, transceiver(s) 2722, antenna(s) 2780, and/or interference mitigation component 198 of FIG. 27. The indication, in some aspects, may indicate a measurement associated with each configuration in the first (or second) set of configurations and/or a set of one or more configurations in the first (or second) set of configurations that are associated with a signal quality (e.g., an SINR) or a received power that is above (or below) a threshold value. For example, referring to FIGS. 9C, 11B, 12B, 13, 15, and 16, the UE 904/1104/1204/1304/1504/1604, may, transmit indication 1336/1536/1636.

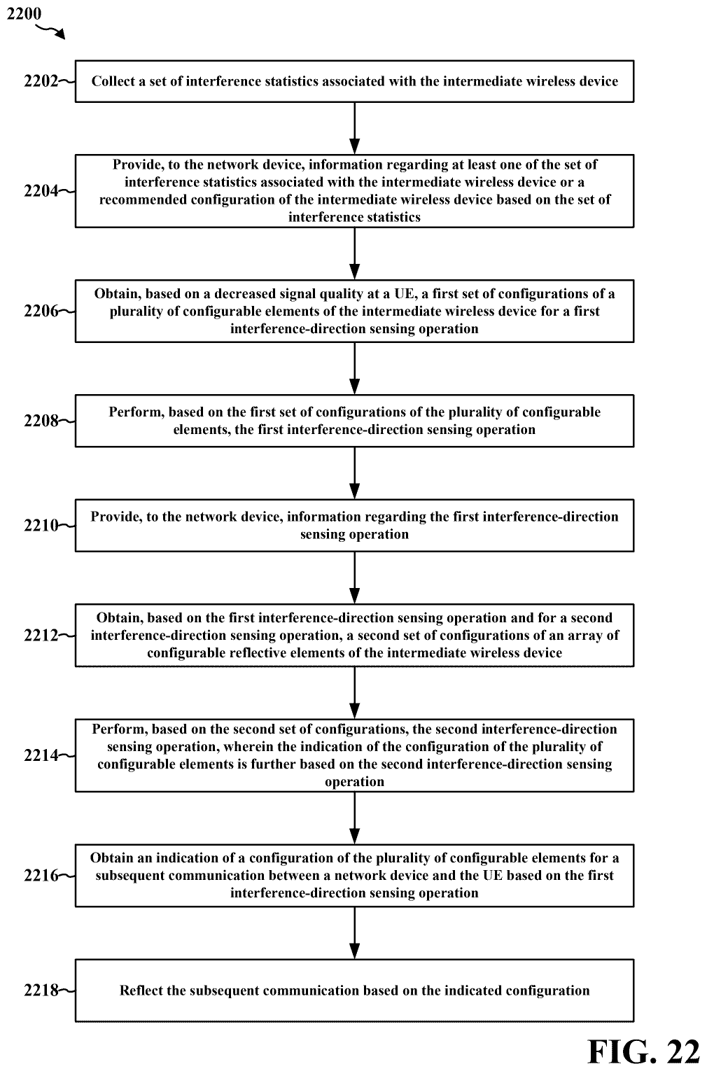

FIG. 22 is a flowchart 2200 of a method of wireless communication. The method may be performed by a RIS facilitating communication between a network device such as a base station and a UE (e.g., the RIS/Repeater 103; the RIS 406, 506, 706, 906, 1006, 1306, 1406; the RIS 3040). At 2202, the RIS may collect a set of interference statistics associated with the intermediate wireless device. For example, 2202 may be performed by controller 3041, processor(s) 3042, transceiver(s) 3046, passive antenna array 3080, RIS surface 3090, and/or interference mitigation component 198 of FIG. 30. In some aspects, collecting the set of interference statistics at 2202 may be performed prior to (detecting and/or identifying) a decreased signal quality at the UE. For example, referring to FIGS. 13 and 14, the RIS 1306/1406 (or the controller 1308/1408) may, at 1312/1412 collect interference statistics based on jamming signals 1310/1410.

At 2204, the RIS may provide, to the network device, information regarding at least one of the set of interference statistics associated with the intermediate wireless device or a recommended configuration of the intermediate wireless device based on the set of interference statistics. For example, 2204 may be performed by controller 3041, processor(s) 3042, transceiver(s) 3046, and/or interference mitigation component 198 of FIG. 30. For example, referring to FIGS. 13 and 14, the RIS 1306/1406 (or the controller 1308/1408) may, as part of detecting interference and/or initiating the method for mitigating interference at 1314/1414, provide the interference statistics or a recommendation based on the interference statistics collected at 1312/1412.

At 2206, the RIS may obtain, based on a decreased signal quality at a UE, a first set of configurations of a plurality of configurable elements of the intermediate wireless device for a first interference-direction sensing operation. For example, 2206 may be performed by controller 3041, processor(s) 3042, transceiver(s) 3046, and/or interference mitigation component 198 of FIG. 30. In some aspects, the first set of configurations is based on the information provided at 2204. For example, referring to FIGS. 13 and 14, the RIS 1306/1406 (or the controller 1308/1408) may, receive the first set of configurations 1316/1416.

At 2208, the RIS may perform, based on the first set of configurations of the plurality of configurable elements, the first interference-direction sensing operation. For example, 2208 may be performed by controller 3041, processor(s) 3042, transceiver(s) 3046, passive antenna array 3080, RIS surface 3090, and/or interference mitigation component 198 of FIG. 30. In some aspects, the decreased signal quality at the UE may be associated with a first configuration of the plurality of configurable elements. The first configuration, in some aspects, may be associated with a first main lobe for reception from the network device directed towards the network device and a first set of side lobes for reception directed in a first set of directions corresponding to the first set of side lobes. For example, referring to FIGS. 9A and 10A, a first RIS configuration may be associated with a main lobe and/or direction 914/1014 and at least one side lobe and/or direction 916/1016. The first set of configurations, in some aspects, may include one or more configurations associated with a second main lobe for reception directed in a direction in the first set of directions. For example, referring to FIGS. 9B, 10B, 13, and 14, the RIS may obtain a first set of configurations 1316/1416 indicating the lobes 921-924/1021-1024 for the RIS 906/1006/1306/1406.

In some aspects, performing the first interference-direction sensing operation may include measuring resources indicated for the first set of configurations. In some aspects, the first interference-direction sensing operation may be associated with a first set of resources that is disjoint from a second set of resources associated with the wireless communication between the network device and the UE. The measurements, in some aspects, may be for a full set of frequencies associated with the communication experiencing the interference and/or may be for a set of one or more frequency ranges (e.g., on a per-frequency-band basis). Performing the first interference-direction sensing operation, in some aspects, may include determining whether any measured signal power is above (or below) a threshold value associated with an interference that may affect the communication. For example, referring to FIGS. 9B, 10B, 13, and 14, the RIS 1306/1406 (or the controller 1308/1408) may, at 1318/1418, measure, and/or monitor for, one or more jamming signals 1320/1420 while implementing each configuration in the first set of configurations as described in relation to FIGS. 9B and 10B based on the first set of configurations 1316/1416.

At 2210, the RIS may provide, to the network device, information regarding the first interference-direction sensing operation. For example, 2210 may be performed by controller 3041, processor(s) 3042, transceiver(s) 3046, and/or interference mitigation component 198 of FIG. 30. The information regarding the first interference-direction sensing operation, in some aspects, may include measurements of the jamming signals based on the first interference-direction sensing operation. In some aspects, the information regarding the first interference-direction sensing operation may include an indication of configurations in the first set of configurations that are associated with at least a threshold power. For example, referring to FIGS. 13 and 14, the RIS 1306/1406 (or the controller 1308/1408) may, transmit the indication 1322/1422 of the interference measurements.

At 2212, the RIS may obtain, based on the first interference-direction sensing operation and for a second interference-direction sensing operation, a second set of configurations of a second subset of the plurality of configurable elements including an array of configurable reflective elements of the RIS (e.g., the intermediate wireless device). For example, 2212 may be performed by controller 3041, processor(s) 3042, transceiver(s) 3046, and/or interference mitigation component 198 of FIG. 30. Referring to FIGS. 13 and 14, for example, the RIS 1306/1406 may receive the second set of configurations 1324/1424.

At 2214, the RIS may perform, based on the second set of configurations, the second interference-direction sensing operation. For example, 2214 may be performed by controller 3041, processor(s) 3042, transceiver(s) 3046, passive antenna array 3080, RIS surface 3090, and/or interference mitigation component 198 of FIG. 30. In some aspects, performing the second interference-direction sensing operation may include directing a received interfering signal to the UE for a measurement at the UE, or directing a received interfering signal to the network device for the measurement at the network device. In some aspects, the second interference-direction sensing operation may be associated with a third set of resources that is disjoint from the second set of resources associated with the wireless communication between the network device and the UE. For example, referring to FIGS. 9C, 10C, 13, and 14, the RIS may apply the second set of configurations at 1326/1426 to 1332/1432 as illustrated in FIGS. 9C and 10C.

At 2216, the RIS may obtain an indication of a configuration of the plurality of configurable elements for a subsequent communication between the network device and the UE based on the first interference-direction sensing operation. For example, 2216 may be performed by controller 3041, processor(s) 3042, transceiver(s) 3046, and/or interference mitigation component 198 of FIG. 30. In some aspects, the indication of the configuration of the plurality of configurable elements may also be based on the second interference-direction sensing operation. Referring to FIGS. 13 and 14, for example, the RIS 1306/1406 may receive the interference mitigating configuration 1338/1438.

At 2218, the RIS may reflect the subsequent communication based on the indicated configuration of the plurality of configurable elements. For example, 2218 may be performed by controller 3041, processor(s) 3042, transceiver(s) 3046, passive antenna array 3080, RIS surface 3090, and/or interference mitigation component 198 of FIG. 30. Referring to FIGS. 13 and 14, for example, the RIS 1306/1406 may reflect the communication 1350/1450 based on the interference mitigating configuration 1338/1438 as illustrated in FIGS. 9D and 10D.

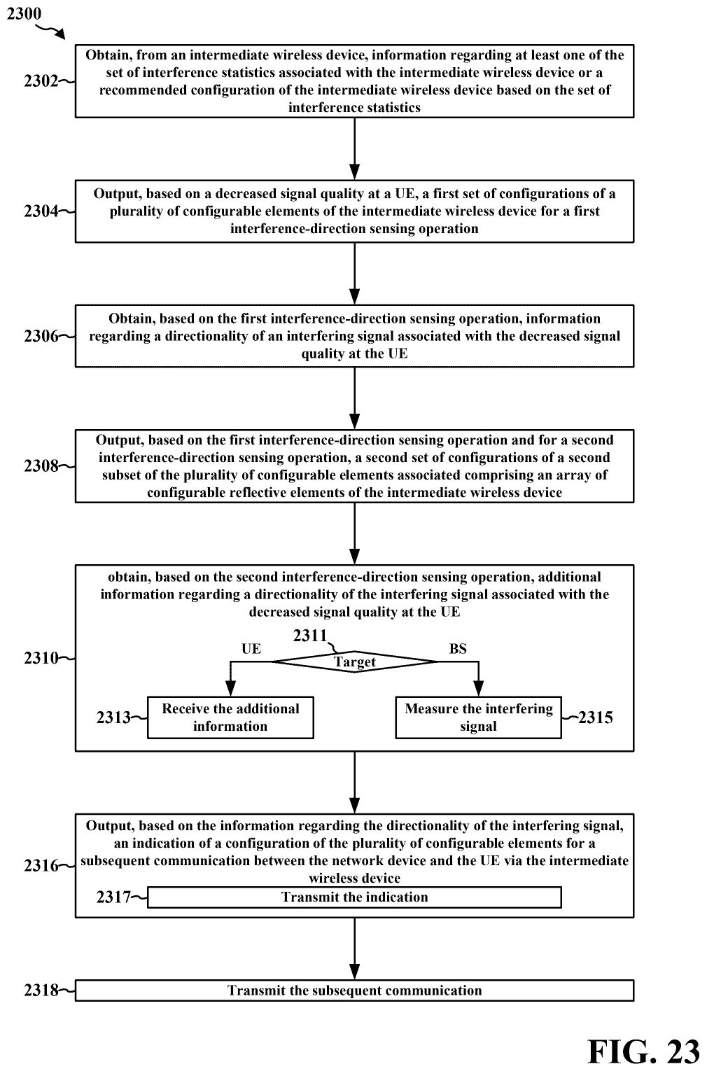

FIG. 23 is a flowchart 2300 of a method of wireless communication. The method may be performed by a base station (e.g., the base station 102, 402, 502, 702, 902, 1002, 1302, 1402; the network node 602; the network entity 2702, 2802, 2960). At 2302, the base station may obtain, from an intermediate wireless device (e.g., a RIS), information regarding at least one of a set of interference statistics associated with the intermediate wireless device or a recommended configuration of the intermediate wireless device based on the set of interference statistics. For example, 2302 may be performed by CU processor(s) 2812, DU processor(s) 2832, RU processor(s) 2842, transceiver(s) 2846, antenna(s) 2880, network processor 2912, network interface 2980, and/or interference mitigation component 199 of FIGS. 28 and 29. For example, referring to FIGS. 13 and 14, the base station 1302/1402 may, as part of detecting interference and/or initiating the method for mitigating interference at 1314/1414, obtain the interference statistics or a recommendation based on the interference statistics collected at 1312/1412 by the RIS 1306/1406 (or the controller 1308/1408).

At 2304, the base station may output, based on a decreased signal quality at a UE, a first set of configurations of a plurality of configurable elements of the intermediate wireless device for a first interference-direction sensing operation. For example, 2304 may be performed by CU processor(s) 2812, DU processor(s) 2832, RU processor(s) 2842, transceiver(s) 2846, antenna(s) 2880, network processor 2912, network interface 2980, and/or interference mitigation component 199 of FIGS. 28 and 29. For example, referring to FIGS. 13 and 14, the base station 1302/1402 may, transmit the first set of configurations 1316/1416.

The RIS may perform, based on the first set of configurations of the plurality of configurable elements, the first interference-direction sensing operation. In some aspects, the decreased signal quality at the UE may be associated with a first configuration of the plurality of configurable elements. The first configuration, in some aspects, may be associated with a first main lobe for reception from the network device directed towards the network device and a first set of side lobes for reception directed in a first set of directions corresponding to the first set of side lobes. For example, referring to FIGS. 9A and 10A, a first RIS configuration may be associated with a main lobe and/or direction 914/1014 and at least one side lobe and/or direction 916/1016. The first set of configurations, in some aspects, may include one or more configurations associated with a second main lobe for reception directed in a direction in the first set of directions. For example, referring to FIGS. 9B, 10B, 13, and 14, the RIS may obtain a first set of configurations 1316/1416 indicating the lobes 921-924/1021-1024 for the RIS 906/1006/1306/1406.

In some aspects, performing the first interference-direction sensing operation may include measuring resources indicated for the first set of configurations. In some aspects, the first interference-direction sensing operation may be associated with a first set of resources that is disjoint from a second set of resources associated with the wireless communication between the network device and the UE. The measurements, in some aspects, may be for a full set of frequencies associated with the communication experiencing the interference and/or may be for a set of one or more frequency ranges (e.g., on a per-frequency-band basis). Performing the first interference-direction sensing operation, in some aspects, may include determining whether any measured signal power is above (or below) a threshold value associated with an interference that may affect the communication. For example, referring to FIGS. 9B, 10B, 13, and 14, the RIS 1306/1406 (or the controller 1308/1408) may, at 1318/1418, measure, and/or monitor for, one or more jamming signals 1320/1420 while implementing each configuration in the first set of configurations as described in relation to FIGS. 9B and 10B based on the first set of configurations 1316/1416.

At 2306, the base station may obtain, based on the first interference-direction sensing operation, information regarding the first interference-direction sensing operation. For example, 2306 may be performed by CU processor(s) 2812, DU processor(s) 2832, RU processor(s) 2842, transceiver(s) 2846, antenna(s) 2880, network processor 2912, network interface 2980, and/or interference mitigation component 199 of FIGS. 28 and 29. The information regarding the first interference-direction sensing operation, in some aspects, may include measurements of the jamming signals based on the first interference-direction sensing operation. In some aspects, the information regarding the first interference-direction sensing operation may include an indication of configurations in the first set of configurations that are associated with at least a threshold power. For example, referring to FIGS. 13 and 14, the base station 1302/1402 may, receive the indication 1322/1422 of the interference measurements.

At 2308, the base station may output, based on the first interference-direction sensing operation and for a second interference-direction sensing operation, a second set of configurations of a second subset of the plurality of configurable elements including an array of configurable reflective elements of the RIS (e.g., the intermediate wireless device). For example, 2308 may be performed by CU processor(s) 2812, DU processor(s) 2832, RU processor(s) 2842, transceiver(s) 2846, antenna(s) 2880, network processor 2912, network interface 2980, and/or interference mitigation component 199 of FIGS. 28 and 29. For example, referring to FIGS. 13 and 14, the base station 1302/1402 may transmit the second set of configurations 1324/1424.

The RIS (and, in some aspects, the base station) may perform, based on the second set of configurations, the second interference-direction sensing operation. In some aspects, performing the second interference-direction sensing operation may include directing a received interfering signal to the UE for a measurement at the UE, or directing a received interfering signal to the network device for the measurement at the network device. In some aspects, the second interference-direction sensing operation may be associated with a third set of resources that is disjoint from the second set of resources associated with the wireless communication between the network device and the UE. For example, referring to FIGS. 9C, 10C, 13, and 14, the RIS may apply the second set of configurations at 1326/1426 to 1332/1432 as illustrated in FIGS. 9C and 10C.

At 2310, the base station may obtain, based on the second interference-direction sensing operation, additional information regarding a directionality of the interfering signal associated with the decreased signal quality at the UE. In some aspects, the base station may determine, at 2311, whether the target of the reflected signal is the UE or the base station. If the target of the reflected signal is the UE, obtaining the additional information may include receiving the additional information from the UE at 2313, but if the target of the reflected signal is the base station, obtaining the additional information may include measuring the (reflected) interfering signal at 2315. For example, 2310, 2311, 2313, and 2315 may be performed by CU processor(s) 2812, DU processor(s) 2832, RU processor(s) 2842, transceiver(s) 2846, antenna(s) 2880, network processor 2912, network interface 2980, and/or interference mitigation component 199 of FIGS. 28 and 29. The additional information, in some aspects, may include a measured power (at the UE or base station) or a measured SINR (at the UE) associated with each configuration in the second set of configurations. For example, referring to FIGS. 9C, 10C, 13, and 14, the base station 1302/1402 may, at 1428, measure a set of reflected interference signals (e.g., including interfering transmissions 1430 and 1434) or may receive the indication 1336 of the interference measurements for the configurations illustrated in relation to FIGS. 9C and 10C.

At 2316, the base station may output an indication of a configuration of the plurality of configurable elements for a subsequent communication between the network device and the UE based on the first interference-direction sensing operation. In some aspects, outputting the indication may include, at 2317, transmitting the indication. For example, 2316 and 2317 may be performed by CU processor(s) 2812, DU processor(s) 2832, RU processor(s) 2842, transceiver(s) 2846, antenna(s) 2880, network processor 2912, network interface 2980, and/or interference mitigation component 199 of FIGS. 28 and 29. In some aspects, the indication of the configuration of the plurality of configurable elements may also be based on the second interference-direction sensing operation. Referring to FIGS. 13 and 14, for example, the base station 1302/1402 may transmit the interference mitigating configuration 1338/1438.

At 2318, the base station may transmit the subsequent communication. The subsequent transmission may be transmitted while the RIS in configured based on the indicated configuration of the plurality of configurable elements. For example, 2318 may be performed by CU processor(s) 2812, DU processor(s) 2832, RU processor(s) 2842, transceiver(s) 2846, antenna(s) 2880, network processor 2912, network interface 2980, and/or interference mitigation component 199 of FIGS. 28 and 29. Referring to FIGS. 13 and 14, for example, the base station 1302/1402 may transmit the communication 1350/1450 to be reflected by the RIS 1306/1406 based on the interference mitigating configuration 1338/1438 as illustrated in FIGS. 9D and 10D.

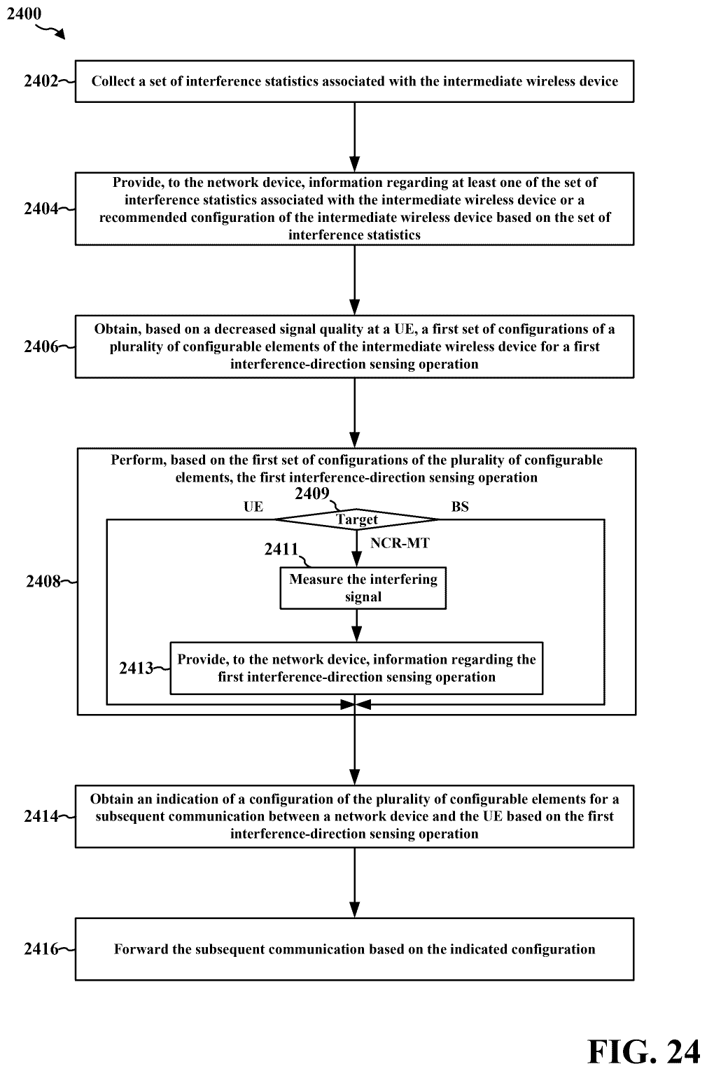

FIG. 24 is a flowchart 2400 of a method of wireless communication. The method may be performed by an NCR facilitating communication between a network device such as a base station and a UE (e.g., the RIS/Repeater 103; the repeater 606; the NCR 446, 806, 1106, 1206, 1506, 1606, 1706, 1806; the NCR 3140). At 2402, the NCR may collect a set of interference statistics associated with the intermediate wireless device. For example, 2402 may be performed by controller 3141, processor(s) 3142, transceiver(s) 3146, configurable MT antenna array 3180, configurable FWD antenna array 3190, and/or interference mitigation component 198 of FIG. 31. In some aspects, collecting the set of interference statistics at 2202 may be performed prior to (detecting and/or identifying) a decreased signal quality at the UE. For example, referring to FIGS. 15-18, the NCR 1506/1606/1706/1806 (or the controller 1508/1608/1708/1808) may, at 1512/1612/1712/1812 collect interference statistics based on jamming signals 1510/1610/1710/1810.

At 2404, the NCR may provide, to a network device (e.g., a base station), information regarding at least one of a set of interference statistics associated with the intermediate wireless device or a recommended configuration of the intermediate wireless device based on the set of interference statistics. For example, 2404 may be performed by controller 3141, processor(s) 3142, transceiver(s) 3146, configurable MT antenna array 3180, configurable FWD antenna array 3190, and/or interference mitigation component 198 of FIG. 31. For example, referring to FIGS. 15-18, the NCR 1506/1606/1706/1806 (or the controller 1508/1608/1708/1808) may, as part of detecting interference and/or initiating the method for mitigating interference at 1514/1614/1714/1814, provide the interference statistics or a recommendation based on the interference statistics collected at 1512/1612/1712/1812 to the base station 1502/1602/1702/1802.

At 2406, the NCR may obtain, based on a decreased signal quality at a UE, a first set of configurations of a plurality of configurable elements of the intermediate wireless device for a first interference-direction sensing operation. For example, 2404 may be performed by controller 3141, processor(s) 3142, transceiver(s) 3146, configurable MT antenna array 3180, configurable FWD antenna array 3190, and/or interference mitigation component 198 of FIG. 31. For example, referring to FIGS. 15-18, the NCR 1506/1606/1706/1806 (or the controller 1508/1608/1708/1808) may receive the first set of configurations 1516/1616/1716/1816. In some aspects, the decreased signal quality at the UE may be associated with a first configuration of the plurality of configurable elements. The first configuration, in some aspects, may be associated with a first main lobe for reception from the network device directed towards the network device and a first set of side lobes for reception directed in a first set of directions corresponding to the first set of side lobes. For example, referring to FIGS. 11A and 12A, a first NCR configuration may be associated with a main lobe and/or direction 1114/1214 and at least one side lobe and/or direction 1116/1216. The first set of configurations, in some aspects, may include one or more configurations associated with a second main lobe for reception directed in a direction in the first set of directions. For example, referring to FIGS. 11B, 12B, and 15-18, the NCR 1506/1606/1706/1806 (or the controller 1508/1608/1708/1808) may obtain a first set of configurations 1516/1616/1716/1816.

In some aspects, the first set of configurations of the plurality of configurable antenna elements may use a greater number of configurable antenna elements than the first configuration associated with the first configuration that experienced the interference. In some aspects, each configuration in the first set of configurations may be associated with a main (receive) lobe in the direction of the base station with different configurations of side lobes (e.g., a set of side lobes in different directions including, for example, a side lobe that may be different from the side lobe associated with the first configuration experiencing the interference). The different configurations of side lobes, in some aspects, may include narrower beams associated with reception and/or nulls (e.g., directions associated with a zero, or near-zero, gain). In some aspects, the different configurations of side lobes may be possible based on using the larger number of configurable antenna elements to provide additional control over the characteristics of the receive lobes and/or directions (e.g., compared to an energy-saving configuration using a smaller numbers of configurable antenna elements). The different configurations of side lobes, in some aspects, may be used to more accurately identify the direction associated with the jamming signal. For example, referring to FIGS. 11B and 15, the NCR 1106/1506 may obtain a first set of configurations 1516.

At 2408, the NCR may perform, based on the first set of configurations of the plurality of configurable elements, the first interference-direction sensing operation. In some aspects, performing the first interference-direction sensing operation may include one of forwarding received signals to the UE or the base station, or measuring resources indicated for the first set of configurations at the NCR. In some aspects, the first interference-direction sensing operation may be associated with a first set of resources that is disjoint from a second set of resources associated with the wireless communication between the network device and the UE. The measurements, in some aspects, may be for a full set of frequencies associated with the communication experiencing the interference and/or may be for a set of one or more frequency ranges (e.g., on a per-frequency-band basis). Performing the first interference-direction sensing operation, in some aspects, may include determining whether any measured signal power is above (or below) a threshold value associated with an interference that may affect the communication. For example, referring to FIGS. 11B, 12B, and 15-18, the base station 1502/1602/1702/1802, the UE 1504/1604/1704/1804, or the NCR 1506/1606/1706/1806 (or the controller 1508/1608/1708/1808) may, at 1528/1628/1728 (or 1732)/1828, measure, and/or monitor for, one or more of the impinging set of transmissions 1530, or the interfering transmissions 1630/1730/1830 while implementing each configuration in the first set of configurations as described in relation to FIGS. 11B and 12B based on the first set of configurations 1516/1616/1716/1816.

In some aspects, to perform the first interference-direction sensing operation at 2408, the NCR may determine, at 2409, whether the target of the forwarded signal is the UE, the base station, or whether the signals are to be measured at the NCR based on the first set of configurations. If the target of the reflected signal is the UE or the base station, performing the first interference-direction sensing operation at 2408 may include applying and/or implementing the configurations in the first set of configurations to forward (or direct) the transmissions to a selected target and/or destination for measurement. If the target of the interfering signals (e.g., the device meant to measure the interfering signals) is the NCR, performing the first interference-direction sensing operation at 2408 may include measuring the (received) interfering signals at 2411. Performing the first interference-direction sensing operation at 2408, in some aspects, may, at 2413, further include providing, to the network device, information regarding the first interference-direction sensing operation. For example, 2408, 2409, 2411, and 2413 may be performed by controller 3141, processor(s) 3142, transceiver(s) 3146, configurable MT antenna array 3180, configurable FWD antenna array 3190, and/or interference mitigation component 198 of FIG. 31. The information, in some aspects, may include a measured power (at the UE, NCR-MT, or base station) or a measured SINR (at the UE) associated with each configuration in the first set of configurations. For example, referring to FIGS. 11B, 12B, and 15-18, the UE 1504/1604, the NCR 1706, and the base station 1802, may, at 1528/1628/1728 (and 1734)/1828, measure a set of received (and, in some aspects, forwarded) interference signals (e.g., including interfering transmissions 1830 and 1834) and the base station 1502/1602/1702 may receive the indication 1536/1636/1738 of the interference measurements for the configurations illustrated in relation to FIGS. 11B and 12B.

At 2414, the NCR may obtain an indication of a configuration of the plurality of configurable elements for a subsequent communication between the network device and the UE based on the first interference-direction sensing operation. In some aspects, obtaining the indication may include receiving the indication from the network device. For example, 2414 may be performed by controller 3141, processor(s) 3142, transceiver(s) 3146, configurable MT antenna array 3180, configurable FWD antenna array 3190, and/or interference mitigation component 198 of FIG. 31. In some aspects, the indication of the configuration of the plurality of configurable elements may also be based on the second interference-direction sensing operation. Referring to FIGS. 15-18, for example, the base station 1502/1602/1702/1802 may transmit and the NCR 1506/1606/1706/1806 (or the controller 1508/1608/1708/1808) may receive the interference mitigating configuration 1538/1638/1740/1838.

At 2416, the NCR may forward the subsequent communication. The subsequent transmission may be transmitted while the NCR in configured based on the indicated configuration of the plurality of configurable elements. For example, 2416 may be performed by controller 3141, processor(s) 3142, transceiver(s) 3146, configurable MT antenna array 3180, configurable FWD antenna array 3190, and/or interference mitigation component 198 of FIG. 31. Referring to FIGS. 15-18, for example, the base station 1502/1602/1702/1802 may transmit the communication 1550/1650/1750/1850 to be forwarded by the NCR 1506/1606/1706/1806 based on the interference mitigating configuration 1538/1638/1740/1838 as illustrated in FIGS. 11C and 12C.

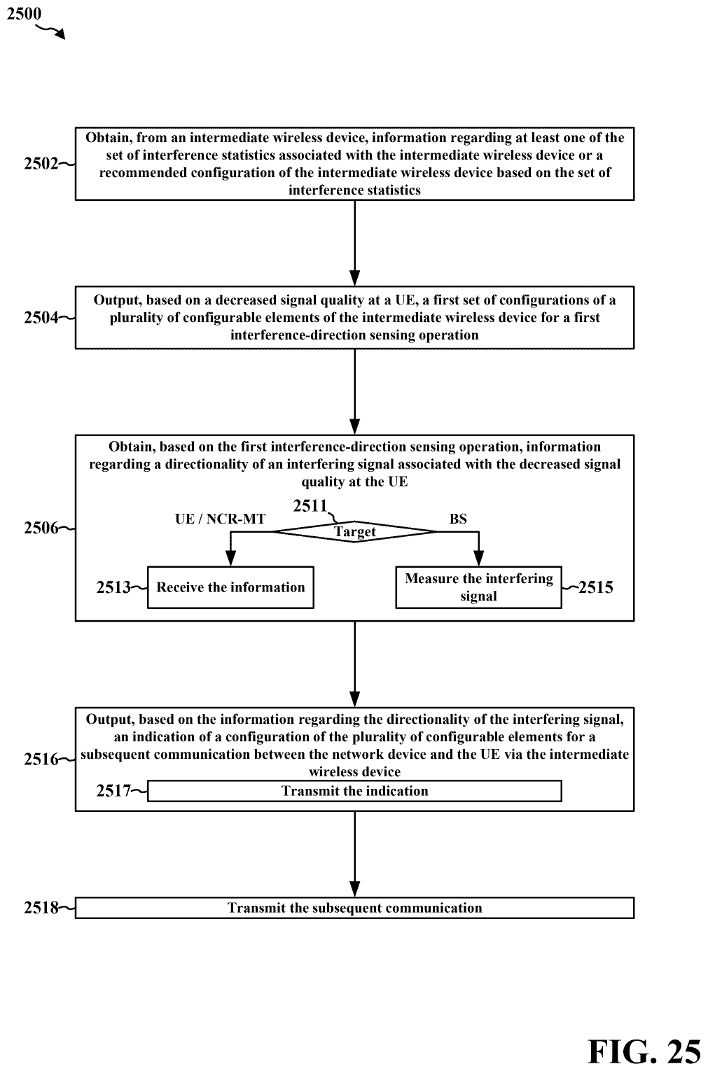

FIG. 25 is a flowchart 2500 of a method of wireless communication. The method may be performed by a base station (e.g., the base station 102, 402, 502, 702, 902, 1002, 1502, 1602; the network node 602; the network entity 2702, 2802, 2960). At 2502, the base station may obtain, from an intermediate wireless device (e.g., an NCR), information regarding at least one of a set of interference statistics associated with the intermediate wireless device or a recommended configuration of the intermediate wireless device based on the set of interference statistics. For example, 2502 may be performed by CU processor(s) 2812, DU processor(s) 2832, RU processor(s) 2842, transceiver(s) 2846, antenna(s) 2880, network processor 2912, network interface 2980, and/or interference mitigation component 199 of FIGS. 28 and 29. For example, referring to FIGS. 15-18, the base station 1502/1602/1702/1802 may, as part of detecting interference and/or initiating the method for mitigating interference at 1514/1614/1714/1814, obtain the interference statistics or a recommendation based on the interference statistics collected at 1512/1612/1712/1812 by the NCR 1506/1606/1706/1806 (or the controller 1508/1608/1708/1808).

At 2504, the base station may output, based on a decreased signal quality at a UE, a first set of configurations of a plurality of configurable elements of the intermediate wireless device for a first interference-direction sensing operation. For example, 2504 may be performed by CU processor(s) 2812, DU processor(s) 2832, RU processor(s) 2842, transceiver(s) 2846, antenna(s) 2880, network processor 2912, network interface 2980, and/or interference mitigation component 199 of FIGS. 28 and 29. For example, referring to FIGS. 15-18, the base station 1502/1602/1702/1802 may, transmit the first set of configurations 1516/1616/1716/1816.

The NCR and/or base station may perform, based on the first set of configurations of the plurality of configurable elements, the first interference-direction sensing operation. In some aspects, the decreased signal quality at the UE may be associated with a first configuration of the plurality of configurable elements. The first configuration, in some aspects, may be associated with a first main lobe for reception from the network device directed towards the network device and a first set of side lobes for reception directed in a first set of directions corresponding to the first set of side lobes. For example, referring to FIGS. 11A and 12A, a first NCR configuration may be associated with a main lobe and/or direction 1114/1214 and at least one side lobe and/or direction 1116/1216. The first set of configurations, in some aspects, may include one or more configurations associated with a second main lobe for reception directed in a direction in the first set of directions. For example, referring to FIGS. 11B, 12B, and 15-18, the NCR may obtain a first set of configurations 1516/1616/1716/1816.

In some aspects, performing the first interference-direction sensing operation may include measuring resources indicated for the first set of configurations at one of the UE, the base station, or the NCR. In some aspects, the first interference-direction sensing operation may be associated with a first set of resources that is disjoint from a second set of resources associated with the wireless communication between the network device and the UE. The measurements, in some aspects, may be for a full set of frequencies associated with the communication experiencing the interference and/or may be for a set of one or more frequency ranges (e.g., on a per-frequency-band basis). Performing the first interference-direction sensing operation, in some aspects, may include determining whether any measured signal power is above (or below) a threshold value associated with an interference that may affect the communication. For example, referring to FIGS. 11B, 12B, and 15-18, the base station 1502/1602/1702/1802, the UE 1504/1604/1704/1804, or the NCR 1506/1606/1706/1806 (or the controller 1508/1608/1708/1808) may, at 1528/1628/1728 (or 1732)/1828, measure, and/or monitor for, one or more of the impinging set of transmissions 1530, or the interfering transmissions 1630/1730/1830 while implementing each configuration in the first set of configurations as described in relation to FIGS. 11B and 12B based on the first set of configurations 1516/1616/1716/1816.

At 2506, the base station may obtain, based on the first interference-direction sensing operation, information regarding a directionality of the interfering signal associated with the decreased signal quality at the UE. In some aspects, the base station may determine, at 2511, whether the target of the forwarded signal is the UE, the NCR-MT, or the base station. If the target of the forwarded signal is the UE or the NCR-MT, obtaining the information may include receiving the information from the UE or the NCR at 2513, but if the target of the forwarded signal is the base station, obtaining the information may include measuring the (forwarded) interfering signal at 2515. For example, 2506, 2511, 2513, and 2515 may be performed by CU processor(s) 2812, DU processor(s) 2832, RU processor(s) 2842, transceiver(s) 2846, antenna(s) 2880, network processor 2912, network interface 2980, and/or interference mitigation component 199 of FIGS. 28 and 29. The information, in some aspects, may include a measured power (at the UE, NCR-MT, or base station) or a measured SINR (at the UE) associated with each configuration in the first set of configurations. For example, referring to FIGS. 11B, 12B, and 15-18, the base station 1502/1602/1702/1802 may, at 1828, measure a set of reflected interference signals (e.g., including interfering transmissions 1830 and 1834) or may receive the indication 1536/1636/1738 of the interference measurements for the configurations illustrated in relation to FIGS. 11B and 12B.

At 2516, the base station may output an indication of a configuration of the plurality of configurable elements for a subsequent communication between the network device and the UE based on the first interference-direction sensing operation. In some aspects, outputting the indication may include, at 2517, transmitting the indication. For example, 2516 and 2517 may be performed by CU processor(s) 2812, DU processor(s) 2832, RU processor(s) 2842, transceiver(s) 2846, antenna(s) 2880, network processor 2912, network interface 2980, and/or interference mitigation component 199 of FIGS. 28 and 29. In some aspects, the indication of the configuration of the plurality of configurable elements may also be based on the second interference-direction sensing operation. Referring to FIGS. 15-18, for example, the base station 1502/1602/1702/1802 may transmit the interference mitigating configuration 1538/1638/1740/1838.

At 2518, the base station may transmit the subsequent communication. The subsequent transmission may be transmitted while the RIS in configured based on the indicated configuration of the plurality of configurable elements. For example, 2518 may be performed by CU processor(s) 2812, DU processor(s) 2832, RU processor(s) 2842, transceiver(s) 2846, antenna(s) 2880, network processor 2912, network interface 2980, and/or interference mitigation component 199 of FIGS. 28 and 29. Referring to FIGS. 15-18, for example, the base station 1502/1602/1702/1802 may transmit the communication 1550/1650/1750/1850 to be forwarded by the NCR 1506/1606/1706/1806 based on the interference mitigating configuration 1538/1638/1740/1838 as illustrated in FIGS. 11C and 12C.

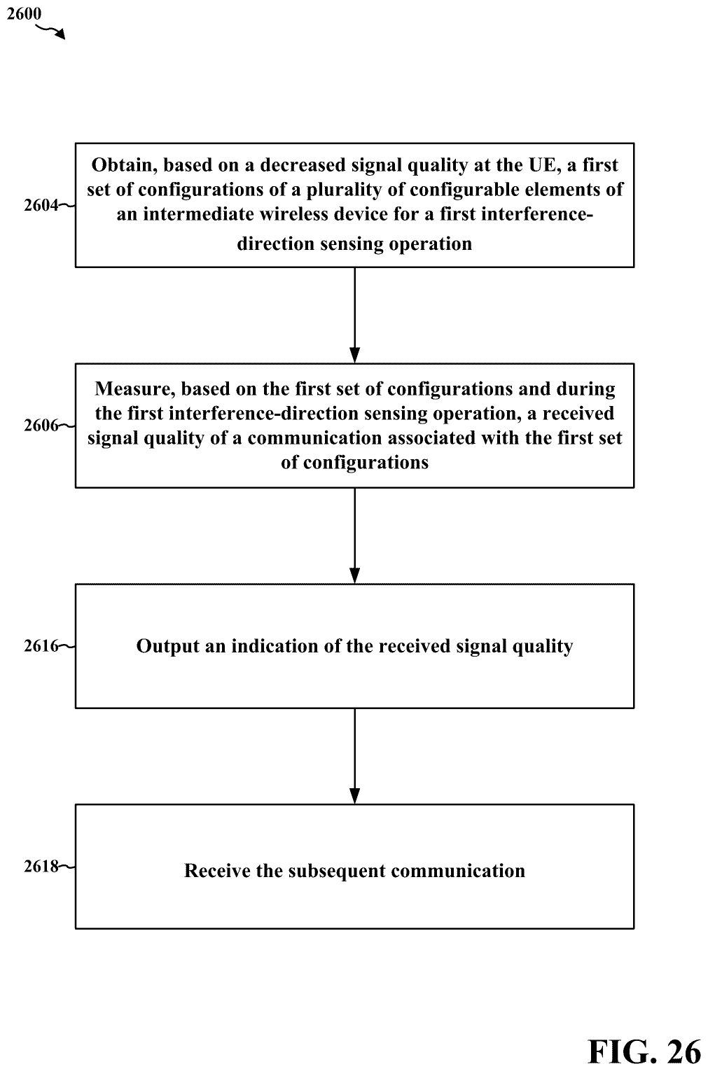

FIG. 26 is a flowchart 2600 of a method of wireless communication. The method may be performed by a UE in communication with a network device via an intermediate wireless device such as a RIS or NCR (e.g., the UE 104, 404, 504, 604, 704, 804, 904, 1004, 1104, 1204, 1304, 1404, 1504, 1604, 1704, 1804; the apparatus 2704). At 2604, the UE may obtain, based on a decreased signal quality at a UE, a first set of configurations of a plurality of configurable elements of the intermediate wireless device for a first interference-direction sensing operation. For example, 2604 may be performed by application processor(s) 2706, cellular baseband processor(s) 2724, transceiver(s) 2722, antenna(s) 2780, and/or interference mitigation component 198 of FIG. 27. For example, referring to FIGS. 9C, 11B, 12B, 13, 15, and 16, the UE 904/1104/1204/1304/1504/1604 may receive the second set of configurations 1324 or the first set of configurations 1516/1616. In some aspects, the decreased signal quality at the UE may be associated with a first configuration of the plurality of configurable elements. The first configuration, in some aspects, may be associated with a first main lobe for reception from the network device directed towards the network device and a first set of side lobes for reception directed in a first set of directions corresponding to the first set of side lobes. For example, referring to FIGS. 9A, 10A, 11A, and 12A, a first RIS or NCR configuration may be associated with a main lobe and/or direction 914/1014/1114/1214 and at least one side lobe and/or direction 916/1016/1116/1216. The first or second set of configurations, in some aspects, may include one or more configurations associated with a second main lobe for reception directed in a direction in the first set of directions.

In some aspects, the first set of configurations of the plurality of configurable antenna elements may use a greater number of configurable antenna elements than the first configuration associated with the first configuration that experienced the interference. In some aspects, each configuration in the first set of configurations may be associated with a main (receive) lobe in the direction of the base station with different configurations of side lobes (e.g., a set of side lobes in different directions including, for example, a side lobe that may be different from the side lobe associated with the first configuration experiencing the interference). The different configurations of side lobes, in some aspects, may include narrower beams associated with reception and/or nulls (e.g., directions associated with a zero, or near-zero, gain). In some aspects, the different configurations of side lobes may be possible based on using the larger number of configurable antenna elements to provide additional control over the characteristics of the receive lobes and/or directions (e.g., compared to an energy-saving configuration using a smaller numbers of configurable antenna elements). The different configurations of side lobes, in some aspects, may be used to more accurately identify the direction associated with the jamming signal. For example, referring to FIGS. 11B and 15, the UE 1104/1504/1604 and the NCR 1106/1506 may be configured according to a first set of configurations 1516.

At 2606, the UE may measure, based on the first set of configurations and during the first interference-direction sensing operation, a received signal quality (and/or power) of a communication associated with the first set of configurations. In some aspects, the communication is between a network device and the UE via the intermediate wireless device. For example, 2606 may be performed by application processor(s) 2706, cellular baseband processor(s) 2724, transceiver(s) 2722, antenna(s) 2780, and/or interference mitigation component 198 of FIG. 27. In some aspects, the first interference-direction sensing operation may be associated with a first set of resources that is disjoint from a second set of resources associated with the wireless communication between the network device and the UE. The measurements, in some aspects, may be for a full set of frequencies associated with the communication experiencing the interference and/or may be for a set of one or more frequency ranges (e.g., on a per-frequency-band basis). The first interference-direction sensing operation, in some aspects, may include determining whether any measured signal power is above (or below) a threshold value associated with an interference that may affect the communication. For example, referring to FIGS. 9C, 11B, 12B, 13, 15, and 16, the UE 904/1104/1204/1304/1504/1604, may, at 1328/1528/1628, measure, and/or monitor for, one or more of the impinging set of transmissions 1330/1530, or the interfering transmissions 1630 while implementing each configuration in the first set of configurations as described in relation to FIGS. 9C, 11B, and 12B based on the first set of configurations 1516/1616/1716/1816.

At 2616, the UE may output an indication of the received signal quality (and or received power). In some aspects, outputting the indication may include transmitting the indication. For example, 2616 may be performed by application processor(s) 2706, cellular baseband processor(s) 2724, transceiver(s) 2722, antenna(s) 2780, and/or interference mitigation component 198 of FIG. 27. The indication, in some aspects, may indicate a measurement associated with each configuration in the first (or second) set of configurations and/or a set of one or more configurations in the first (or second) set of configurations that are associated with a signal quality (e.g., an SINR) or a received power that is above (or below) a threshold value. For example, referring to FIGS. 9C, 11B, 12B, 13, 15, and 16, the UE 904/1104/1204/1304/1504/1604, may, transmit indication 1336/1536/1636.

At 2618, the UE may receive the subsequent communication. The subsequent transmission may be received while the RIS or the NCR is configured based on an indicated configuration of the plurality of configurable elements. For example, 2618 may be performed by application processor(s) 2706, cellular baseband processor(s) 2724, transceiver(s) 2722, antenna(s) 2780, and/or interference mitigation component 198 of FIG. 27. Referring to FIGS. 9C, 11B, 12B, 13, 15, and 16, for example, the UE 904/1104/1204/1304/1504/1604, may, receive the reflected communication 1352 or the forwarded communication 1552/1652 based on the interference mitigating configuration 1538/1638/1740/1838 as illustrated in FIGS. 11C and 12C.

FIG. 27 is a diagram 2700 illustrating an example of a hardware implementation for an apparatus 2704. The apparatus 2704 may be a UE, a component of a UE, or may implement UE functionality. In some aspects, the apparatus 2704 may include at least one cellular baseband processor 2724 (also referred to as a modem) coupled to one or more transceivers 2722 (e.g., cellular RF transceiver). The cellular baseband processor(s) 2724 may include at least one on-chip memory 2724′. In some aspects, the apparatus 2704 may further include one or more subscriber identity modules (SIM) cards 2720 and at least one application processor 2706 coupled to a secure digital (SD) card 2708 and a screen 2710. The application processor(s) 2706 may include on-chip memory 2706′. In some aspects, the apparatus 2704 may further include a Bluetooth module 2712, a WLAN module 2714, an SPS module 2716 (e.g., GNSS module), one or more sensor modules 2718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2726, a power supply 2730, and/or a camera 2732. The Bluetooth module 2712, the WLAN module 2714, and the SPS module 2716 may include an on-chip transceiver (TRX) (or in some cases, just a receiver (RX)). The Bluetooth module 2712, the WLAN module 2714, and the SPS module 2716 may include their own dedicated antennas and/or utilize one or more antennas 2780 for communication. The cellular baseband processor(s) 2724 communicates through the transceiver(s) 2722 via the one or more antennas 2780 with the UE 104 and/or with an RU associated with a network entity 2702. The cellular baseband processor(s) 2724 and the application processor(s) 2706 may each include a computer-readable medium/memory 2724′, 2706′, respectively. The additional memory modules 2726 may also be considered a computer-readable medium/memory. Each computer-readable medium/memory 2724′, 2706′, 2726 may be non-transitory. The cellular baseband processor(s) 2724 and the application processor(s) 2706 are each responsible for general processing, including the execution of software stored on the computer-readable medium/memory. The software, when executed by the cellular baseband processor(s) 2724/application processor(s) 2706, causes the cellular baseband processor(s) 2724/application processor(s) 2706 to perform the various functions described supra. The computer-readable medium/memory may also be used for storing data that is manipulated by the cellular baseband processor(s) 2724/application processor(s) 2706 when executing software. The cellular baseband processor(s) 2724/application processor(s) 2706 may be a component of the UE 350 and may include the at least one memory 360 and/or at least one of the TX processor 368, the RX processor 356, and the controller/processor 359. In one configuration, the apparatus 2704 may be at least one processor chip (modem and/or application) and include just the cellular baseband processor(s) 2724 and/or the application processor(s) 2706, and in another configuration, the apparatus 2704 may be the entire UE (e.g., see UE 350 of FIG. 3) and include the additional modules of the apparatus 2704.

As discussed supra, the interference mitigation component 198 may be configured to obtain, based on a decreased signal quality at the UE, a first set of configurations of a plurality of configurable elements of an intermediate wireless device for a first interference-direction sensing operation, measure, based on the first set of configurations and during the first interference-direction sensing operation, a received signal quality of a communication associated with the first set of configurations, where the communication is between a network device and the UE via the intermediate wireless device, and output an indication of the received signal quality. The interference mitigation component 198 may be within the cellular baseband processor(s) 2724, the application processor(s) 2706, or both the cellular baseband processor(s) 2724 and the application processor(s) 2706. The interference mitigation component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 2704 may include a variety of components configured for various functions. In one configuration, the apparatus 2704, and in particular the cellular baseband processor(s) 2724 and/or the application processor(s) 2706, may include means for obtaining, based on a decreased signal quality at the UE, a first set of configurations of a plurality of configurable elements of an intermediate wireless device for a first interference-direction sensing operation. In one configuration, the apparatus 2704, and in particular the cellular baseband processor(s) 2724 and/or the application processor(s) 2706, may include means for measuring, based on the first set of configurations and during the first interference-direction sensing operation, a received signal quality of a communication associated with the first set of configurations. In one configuration, the apparatus 2704, and in particular the cellular baseband processor(s) 2724 and/or the application processor(s) 2706, may include means for outputting an indication of the received signal quality. The apparatus 2704 may further include means for performing any of the aspects described in connection with the flowcharts in FIG. 21 or 26, and/or performed by the UE in the communication flow of FIGS. 13-18. The means may be the interference mitigation component 198 of the apparatus 2704 configured to perform the functions recited by the means. As described supra, the apparatus 2704 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 28 is a diagram 2800 illustrating an example of a hardware implementation for a network entity 2802. The network entity 2802 may be a BS, a component of a BS, or may implement BS functionality. The network entity 2802 may include at least one of a CU 2810, a DU 2830, or an RU 2840. For example, depending on the layer functionality handled by the interference mitigation component 199, the network entity 2802 may include the CU 2810; both the CU 2810 and the DU 2830; each of the CU 2810, the DU 2830, and the RU 2840; the DU 2830; both the DU 2830 and the RU 2840; or the RU 2840. The CU 2810 may include at least one CU processor 2812. The CU processor(s) 2812 may include on-chip memory 2812′. In some aspects, the CU 2810 may further include additional memory modules 2814 and a communications interface 2818. The CU 2810 communicates with the DU 2830 through a midhaul link, such as an F1 interface. The DU 2830 may include at least one DU processor 2832. The DU processor(s) 2832 may include on-chip memory 2832′. In some aspects, the DU 2830 may further include additional memory modules 2834 and a communications interface 2838. The DU 2830 communicates with the RU 2840 through a fronthaul link. The RU 2840 may include at least one RU processor 2842. The RU processor(s) 2842 may include on-chip memory 2842′. In some aspects, the RU 2840 may further include additional memory modules 2844, one or more transceivers 2846, one or more antennas 2880, and a communications interface 2848. The RU 2840 communicates with the UE 104. The on-chip memory 2812′, 2832′, 2842′ and the additional memory modules 2814, 2834, 2844 may each be considered a computer-readable medium/memory. Each computer-readable medium/memory may be non-transitory. Each of the processors 2812, 2832, 2842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the interference mitigation component 199 may be configured to output, based on a decreased signal quality at a UE, a first set of configurations of a plurality of configurable elements of an intermediate wireless device for a first interference-direction sensing operation, obtain, based on the first interference-direction sensing operation, information regarding a directionality of an interfering signal associated with the decreased signal quality at the UE, and output, based on the information regarding the directionality of the interfering signal, an indication of a configuration of the plurality of configurable elements for a subsequent communication between the network device and the UE via the intermediate wireless device. The interference mitigation component 199 may be within one or more processors of one or more of the CU 2810, DU 2830, and the RU 2840. The interference mitigation component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2802 may include a variety of components configured for various functions. In one configuration, the network entity 2802 may include means for outputting, based on a decreased signal quality at a UE, a first set of configurations of a plurality of configurable elements of an intermediate wireless device for a first interference-direction sensing operation. In one configuration, the network entity 2802 may include means for obtaining, based on the first interference-direction sensing operation, information regarding a directionality of an interfering signal associated with the decreased signal quality at the UE. In one configuration, the network entity 2802 may include means for outputting, based on the information regarding the directionality of the interfering signal, an indication of a configuration of the plurality of configurable elements for a subsequent communication between the network device and the UE via the intermediate wireless device. In one configuration, the network entity 2802 may include means for outputting, based on the first interference-direction sensing operation and for a second interference-direction sensing operation, a second set of configurations of a second subset of the plurality of configurable elements associated comprising an array of configurable reflective elements of the intermediate wireless device. In one configuration, the network entity 2802 may include means for obtaining, based on the second interference-direction sensing operation, additional information regarding a directionality of the interfering signal associated with the decreased signal quality at the UE. In one configuration, the network entity 2802 may include means for obtaining, from the intermediate wireless device and based on a set of interference statistics collected by the intermediate wireless device, additional information regarding at least one of the set of interference statistics associated with the intermediate wireless device or a recommended configuration of the intermediate wireless device based on the set of interference statistics, where the first set of configurations is based on the additional information. In one configuration, the network entity 2802 may include means for obtaining interferer information regarding one or more of possible interference signals or possible interference sources. In one configuration, the network entity 2802 may include means for transmitting the subsequent communication between the network device and the UE with an increased power. The network entity 2802 may further include means for performing any of the aspects described in connection with the flowcharts in FIGS. 20, 23, and 25, and/or performed by the base station in the communication flow of FIGS. 13-18. The means may be the interference mitigation component 199 of the network entity 2802 configured to perform the functions recited by the means. As described supra, the network entity 2802 may include the TX processor 316, the RX processor 370, and the controller/processor 375. As such, in one configuration, the means may be the TX processor 316, the RX processor 370, and/or the controller/processor 375 configured to perform the functions recited by the means or as described in relation to FIGS. 20, 23, and 25.

FIG. 29 is a diagram 2900 illustrating an example of a hardware implementation for a network entity 2960. In one example, the network entity 2960 may be within the core network 120. The network entity 2960 may include at least one network processor 2912. The network processor(s) 2912 may include on-chip memory 2912′. In some aspects, the network entity 2960 may further include additional memory modules 2914. The network entity 2960 communicates via the network interface 2980 directly (e.g., backhaul link) or indirectly (e.g., through a RIC) with the CU 2902. The on-chip memory 2912′ and the additional memory modules 2914 may each be considered a computer-readable medium/memory. Each computer-readable medium/memory may be non-transitory. The network processor(s) 2912 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the interference mitigation component 199 may be configured to output, based on a decreased signal quality at a UE, a first set of configurations of a plurality of configurable elements of an intermediate wireless device for a first interference-direction sensing operation, obtain, based on the first interference-direction sensing operation, information regarding a directionality of an interfering signal associated with the decreased signal quality at the UE, and output, based on the information regarding the directionality of the interfering signal, an indication of a configuration of the plurality of configurable elements for a subsequent communication between the network device and the UE via the intermediate wireless device. The interference mitigation component 199 may be within the network processor(s) 2912. The interference mitigation component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2960 may include a variety of components configured for various functions. In one configuration, the network entity 2960 may include means for outputting, based on a decreased signal quality at a UE, a first set of configurations of a plurality of configurable elements of an intermediate wireless device for a first interference-direction sensing operation. In one configuration, the network entity 2960 may include means for obtaining, based on the first interference-direction sensing operation, information regarding a directionality of an interfering signal associated with the decreased signal quality at the UE. In one configuration, the network entity 2960 may include means for outputting, based on the information regarding the directionality of the interfering signal, an indication of a configuration of the plurality of configurable elements for a subsequent communication between the network device and the UE via the intermediate wireless device. In one configuration, the network entity 2960 may include means for outputting, based on the first interference-direction sensing operation and for a second interference-direction sensing operation, a second set of configurations of a second subset of the plurality of configurable elements associated comprising an array of configurable reflective elements of the intermediate wireless device. In one configuration, the network entity 2960 may include means for obtaining, based on the second interference-direction sensing operation, additional information regarding a directionality of the interfering signal associated with the decreased signal quality at the UE. In one configuration, the network entity 2960 may include means for obtaining, from the intermediate wireless device and based on a set of interference statistics collected by the intermediate wireless device, additional information regarding at least one of the set of interference statistics associated with the intermediate wireless device or a recommended configuration of the intermediate wireless device based on the set of interference statistics, where the first set of configurations is based on the additional information. In one configuration, the network entity 2960 may include means for obtaining interferer information regarding one or more of possible interference signals or possible interference sources. In one configuration, the network entity 2960 may include means for transmitting the subsequent communication between the network device and the UE with an increased power. The network entity 2960 may further include means for performing any of the aspects described in connection with the flowcharts in FIGS. 20, 23, and 25, and/or performed by the base station in the communication flow of FIGS. 13-18. The means may be the interference mitigation component 199 of the network entity 2960 configured to perform the functions recited by the means. As described supra, the network entity 2960 may include the TX processor 316, the RX processor 370, and the controller/processor 375. As such, in one configuration, the means may be the TX processor 316, the RX processor 370, and/or the controller/processor 375 configured to perform the functions recited by the means or as described in relation to FIGS. 20, 23, and 25.

FIG. 30 is a diagram 3000 illustrating an example of a hardware implementation for a RIS 3040. The RIS 3040 includes a RIS surface 3090 that includes a passive antenna array 3080. The RIS surface 3090 includes a surface with a large number of densely placed reconfigurable elements that can reflect or refract an electromagnetic wave in target directions. FIG. 30 illustrates an example of the RIS surface 3090 reflecting communication between a UE 104 and a base station 102. The RIS 3040 includes a controller 3041 that controls an incident angle and an angle of reflection, e.g., by controlling reflection coefficients of (or phase shifts introduced by) the antenna elements of the RIS surface 3090. The controller 3041 may exchange communication, including control signaling or other signaling with a network node such as a base station 102 or a component of a base station 102 and/or a UE 104. The controller 3041 may exchange the communication via at least one transceiver 3046. The controller 3041 may include at least one processor 3042. The processor(s) 3042 may include on-chip memory 3042′. In some aspects, the controller 3041 may further include additional memory modules 3044. The on-chip memory 3042′ and the additional memory modules 3044 may each be considered a computer-readable medium/memory. Each computer-readable medium/memory may be non-transitory. The processor(s) 3042 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the interference mitigation component 198 may be configured to obtain, based on a decreased signal quality at a UE, a first set of configurations of a plurality of configurable elements of the intermediate wireless device for a first interference-direction sensing operation, perform, based on the first set of configurations of the plurality of configurable elements, the first interference-direction sensing operation, and obtain an indication of a configuration of the plurality of configurable elements for a subsequent communication between a network device and the UE based on the first interference-direction sensing operation. The interference mitigation component 198 may be within the processor(s) 3042. The interference mitigation component 198 may be one or more hardware components specifically configured to carry out the stated processes/algorithm, implemented by one or more processors configured to perform the stated processes/algorithm, stored within a computer-readable medium for implementation by one or more processors, or some combination thereof. The RIS 3040 may include a variety of components configured for various functions. In one configuration, the RIS 3040 may include means for obtaining, based on a decreased signal quality at a UE, a first set of configurations of a plurality of configurable elements of the intermediate wireless device for a first interference-direction sensing operation. In one configuration, the RIS 3040 may include means for performing, based on the first set of configurations of the plurality of configurable elements, the first interference-direction sensing operation. In one configuration, the RIS 3040 may include means for obtaining an indication of a configuration of the plurality of configurable elements for a subsequent communication between a network device and the UE based on the first interference-direction sensing operation. In one configuration, the RIS 3040 may include means for directing a received interfering signal to the UE for a measurement at the UE. In one configuration, the RIS 3040 may include means for directing the received interfering signal to the network device for the measurement at the network device. In one configuration, the RIS 3040 may include means for measuring the received interfering signal at the intermediate wireless device. In one configuration, the RIS 3040 may include means for obtaining, based on the first interference-direction sensing operation and for a second interference-direction sensing operation, a second set of configurations of a second subset of the plurality of configurable elements comprising an array of configurable reflective elements of the intermediate wireless device. In one configuration, the RIS 3040 may include means for performing, based on the second set of configurations, the second interference-direction sensing operation. In one configuration, the RIS 3040 may include means for collecting, prior to the decreased signal quality at the UE, a set of interference statistics associated with the intermediate wireless device. In one configuration, the RIS 3040 may include means for providing, to the network device, information regarding at least one of the set of interference statistics associated with the intermediate wireless device or a recommended configuration of the intermediate wireless device based on the set of interference statistics. The means may be the interference mitigation component 198 of the RIS 3040 configured to perform any of the aspects described in connection with the flowcharts in FIGS. 19 and 22, and/or performed by the RIS in the communication flow of FIGS. 13 and 14.

FIG. 31 is a diagram 3100 illustrating an example of a hardware implementation for an NCR 3140. The NCR 3140 includes a configurable MT antenna array 3180 and a configurable FWD antenna array 3190. The configurable MT antenna array 3180 and the configurable FWD antenna array 3190 include a plurality of reconfigurable antenna elements that can modify a received, amplify, and forward an electromagnetic wave in target directions. FIG. 31 illustrates an example of the configurable MT antenna array 3180 and the configurable FWD antenna array 3190 repeating and/or forwarding communication between a UE 104 and a base station 102. The NCR 3140 includes a controller 3141 that controls a receive beam, an amplification, and a forwarding beam, e.g., by controlling phase coefficients of (or phase shifts introduced by) the antenna elements of the configurable MT antenna array 3180 and the configurable FWD antenna array 3190. The controller 3141 may exchange communication, including control signaling or other signaling with a network node such as a base station 102 or a component of a base station 102 and/or a UE 104. The controller 3141 may exchange the communication via at least one transceiver 3146. The controller 3141 may include at least one processor 3142. The processor(s) 3142 may include on-chip memory 3142′. In some aspects, the controller 3141 may further include additional memory modules 3144. The on-chip memory 3142′ and the additional memory modules 3144 may each be considered a computer-readable medium/memory. Each computer-readable medium/memory may be non-transitory. The processor(s) 3142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the interference mitigation component 198 may be configured to obtain, based on a decreased signal quality at a UE, a first set of configurations of a plurality of configurable elements of the intermediate wireless device for a first interference-direction sensing operation, perform, based on the first set of configurations of the plurality of configurable elements, the first interference-direction sensing operation, and obtain an indication of a configuration of the plurality of configurable elements for a subsequent communication between a network device and the UE based on the first interference-direction sensing operation. The interference mitigation component 198 may be within the processor(s) 3142. The interference mitigation component 198 may be one or more hardware components specifically configured to carry out the stated processes/algorithm, implemented by one or more processors configured to perform the stated processes/algorithm, stored within a computer-readable medium for implementation by one or more processors, or some combination thereof. The NCR 3140 may include a variety of components configured for various functions. In one configuration, the NCR 3140 may include means for obtaining, based on a decreased signal quality at a UE, a first set of configurations of a plurality of configurable elements of the intermediate wireless device for a first interference-direction sensing operation. In one configuration, the NCR 3140 may include means for performing, based on the first set of configurations of the plurality of configurable elements, the first interference-direction sensing operation. In one configuration, the NCR 3140 may include means for obtaining an indication of a configuration of the plurality of configurable elements for a subsequent communication between a network device and the UE based on the first interference-direction sensing operation. In one configuration, the NCR 3140 may include means for directing a received interfering signal to the UE for a measurement at the UE. In one configuration, the NCR 3140 may include means for directing the received interfering signal to the network device for the measurement at the network device. In one configuration, the NCR 3140 may include means for measuring the received interfering signal at the intermediate wireless device. In one configuration, the NCR 3140 may include means for collecting, prior to the decreased signal quality at the UE, a set of interference statistics associated with the intermediate wireless device. In one configuration, the NCR 3140 may include means for providing, to the network device, information regarding at least one of the set of interference statistics associated with the intermediate wireless device or a recommended configuration of the intermediate wireless device based on the set of interference statistics. The means may be the interference mitigation component 198 of the NCR 3140 configured to perform any of the aspects described in connection with the flowcharts in FIGS. 19 and 24, and/or performed by the NCR in the communication flow of FIGS. 15-18.

Various aspects relate generally to a beam sweeping procedure and signaling for a RIS or NCR to select a beam pattern that maximizes a SINR at a communication destination (a UE) by reducing the interference from an unknown jamming device (or jammer). Some aspects more specifically relate to multiple options for determining the beam pattern based on measurements for different Rx beam patterns that puts a null or reduces a sidelobe towards a jammer at one of a UE, a network device, or NCR-based measurements. In some examples, an intermediate wireless device comprising an array of configurable elements (e.g., an array of configurable reflective elements or a plurality of configurable antenna elements) may be configured to obtain, based on a decreased signal quality at a UE, a first set of configurations of a plurality of configurable elements of the intermediate wireless device for a first interference-direction sensing operation, perform, based on the first set of configurations of the plurality of configurable elements, the first interference-direction sensing operation, and obtain an indication of a configuration of the plurality of configurable elements for a subsequent communication between a network device and the UE based on the first interference-direction sensing operation. Similarly, a network device may be configured to output, based on a decreased signal quality at a UE, a first set of configurations of a plurality of configurable elements of an intermediate wireless device for a first interference-direction sensing operation, obtain, based on the first interference-direction sensing operation, information regarding a directionality of an interfering signal associated with the decreased signal quality at the UE, and output, based on the information regarding the directionality of the interfering signal, an indication of a configuration of the plurality of configurable elements for a subsequent communication between the network device and the UE via the intermediate wireless device. Additionally, a UE or wireless device may be configured to obtain, based on a decreased signal quality at the UE, a first set of configurations of a plurality of configurable elements of an intermediate wireless device for a first interference-direction sensing operation, measure, based on the first set of configurations and during the first interference-direction sensing operation, a received signal quality of a communication associated with the first set of configurations, where the communication is between a network device and the UE via the intermediate wireless device, and output an indication of the received signal quality.

Particular aspects of the subject matter described in this disclosure can be implemented to realize one or more of the following potential advantages. In some examples, by determining a beam pattern based on measurements for different Rx beam patterns that puts a null or reduces a sidelobe towards a jammer at one of a UE, a network device, or NCR-based measurements, the described techniques can be used to improve jamming resilience (e.g., to mitigate the effect of interfering signals from a jamming device).

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at an intermediate wireless device, comprising: obtaining, based on a decreased signal quality at a user equipment (UE), a first set of configurations of a plurality of configurable elements of the intermediate wireless device for a first interference-direction sensing operation; performing, based on the first set of configurations of the plurality of configurable elements, the first interference-direction sensing operation; and obtaining an indication of a configuration of the plurality of configurable elements for a subsequent communication between a network device and the UE based on the first interference-direction sensing operation.

Aspect 2 is the method of aspect 1, wherein: the decreased signal quality at the UE is associated with a first configuration of the plurality of configurable elements, the first configuration is associated with a first main lobe for reception from the network device directed towards the network device and a first set of side lobes for reception directed in a first set of directions corresponding to the first set of side lobes, and the first set of configurations comprises one or more configurations associated with a second main lobe for reception directed in a direction in the first set of directions.

Aspect 3 is the method of aspect 2, wherein the one or more configurations are further associated with one of: directing a received interfering signal to the UE for a measurement at the UE, directing the received interfering signal to the network device for the measurement at the network device, or measuring the received interfering signal at the intermediate wireless device, and wherein obtaining the indication of the configuration of the plurality of configurable elements for the subsequent communication is based on the measurement of the received interfering signal.

Aspect 4 is the method of aspect 1, wherein: the decreased signal quality at the UE is associated with a first configuration of the plurality of configurable elements, the first configuration is associated with a first main lobe for reception from the network device directed towards the network device and a first set of side lobes for reception directed in a first set of directions corresponding to the first set of side lobes, and the first set of configurations comprises one or more configurations associated with a second main lobe for reception directed to the network device and at least one null for reception in a direction in the first set of directions.

Aspect 5 is the method of aspect 4, wherein the one or more configurations are further associated with one of: directing a received signal to the UE for measurement at the UE, or measuring the received signal at the intermediate wireless device, and wherein obtaining the indication of the configuration of the plurality of configurable elements for the subsequent communication is based on the measurement of the received signal.

Aspect 6 is the method of any of aspects 1 to 5, wherein the first set of configurations is for a first subset of the plurality of configurable elements comprising an array of configurable antenna elements of the intermediate wireless device, the method further comprising: obtaining, based on the first interference-direction sensing operation and for a second interference-direction sensing operation, a second set of configurations of a second subset of the plurality of configurable elements comprising an array of configurable reflective elements of the intermediate wireless device; and performing, based on the second set of configurations, the second interference-direction sensing operation, wherein the indication of the configuration of the plurality of configurable elements is further based on the second interference-direction sensing operation.

Aspect 7 is the method of any of aspects 1 to 5, wherein the intermediate wireless device is a repeating device and the plurality of configurable elements comprises a plurality of antenna elements, wherein at least one configuration in the first set of configurations of the plurality of configurable elements is for a first number of configurable elements and the configuration of the plurality of configurable elements for the subsequent communication is for a second number of configurable elements, wherein the first number of configurable elements is greater than or equal to the second number of configurable elements.

Aspect 8 is the method of any of aspects 1 to 7, wherein the first interference-direction sensing operation is associated with a first set of resources that is disjoint from a second set of resources associated with the wireless communication between the network device and the UE.

Aspect 9 is the method of any of aspects 1 to 8, further comprising: collecting, prior to the decreased signal quality at the UE, a set of interference statistics associated with the intermediate wireless device; and providing, to the network device, information regarding at least one of the set of interference statistics associated with the intermediate wireless device or a recommended configuration of the intermediate wireless device based on the set of interference statistics, wherein the first set of configurations is based on the information.

Aspect 10 is the method of any of aspects 1, 8, and 9, wherein: the decreased signal quality at the UE is associated with a first configuration of the plurality of configurable elements, the first configuration is associated with a first main lobe for reception from the network device directed towards the network device and a first set of side lobes for reception directed in a first set of directions corresponding to the first set of side lobes, and the first set of configurations comprises one or more configurations associated with a second main lobe for reception in a reception direction in the first set of directions and a third main lobe for outputting a received signal in an output direction towards the network device.

Aspect 11 is a method of wireless communication at a network device, comprising: outputting, based on a decreased signal quality at a user equipment (UE), a first set of configurations of a plurality of configurable elements of an intermediate wireless device for a first interference-direction sensing operation; obtain, based on the first interference-direction sensing operation, information regarding a directionality of an interfering signal associated with the decreased signal quality at the UE; and outputting, based on the information regarding the directionality of the interfering signal, an indication of a configuration of the plurality of configurable elements for a subsequent communication between the network device and the UE via the intermediate wireless device.

Aspect 12 is the method of aspect 11, wherein: the decreased signal quality at the UE is associated with a first configuration of the plurality of configurable elements, the first configuration is associated with a first main lobe for reception from the network device directed towards the network device and a first set of side lobes for reception directed in a first set of directions corresponding to the first set of side lobes, and the first set of configurations comprises one or more configurations associated with a second main lobe for reception directed in a direction in the first set of directions.

Aspect 13 is the method of aspect 12, wherein the one or more configurations are further associated with one of: directing a received interfering signal to the UE for measurement at the UE, directing the received interfering signal to the network device for the measurement at the network device, or measuring the received interfering signal at the intermediate wireless device, and wherein obtaining (outputting) the indication of the configuration of the plurality of configurable elements for the subsequent communication is based on the measurement of the received interfering signal.

Aspect 14 is the method of aspect 11, wherein: the decreased signal quality at the UE is associated with a first configuration of the plurality of configurable elements, the first configuration is associated with a first main lobe for reception from the network device directed towards the network device and a first set of side lobes for reception directed in a first set of directions corresponding to the first set of side lobes, and the first set of configurations comprises one or more configurations associated with a second main lobe for reception directed to the network device and at least one null for reception in a direction in the first set of directions.

Aspect 15 is the method of aspect 14, wherein the one or more configurations are further associated with one of: directing a received signal to the UE for measurement at the UE, or measuring the received signal at the intermediate wireless device, and wherein obtaining the indication of the configuration of the plurality of configurable elements for the subsequent communication is based on the measurement of the received signal.

Aspect 16 is the method of any of aspects 11 to 15, wherein the first set of configurations is for a first subset of the plurality of configurable elements comprising an array of configurable antenna elements of the intermediate wireless device, the method further comprising: outputting, based on the first interference-direction sensing operation and for a second interference-direction sensing operation, a second set of configurations of a second subset of the plurality of configurable elements comprising an array of configurable reflective elements of the intermediate wireless device; and obtaining, based on the second set of configurations, the second interference-direction sensing operation, wherein the indication of the configuration of the plurality of configurable elements is further based on the second interference-direction sensing operation.

Aspect 17 is the method of any of aspects 11 to 15, wherein the intermediate wireless device is a repeating device and the plurality of configurable elements comprises a plurality of antenna elements, wherein at least one configuration in the first set of configurations of the plurality of configurable elements is for a first number of configurable elements and the configuration of the plurality of configurable elements for the subsequent communication is for a second number of configurable elements, wherein the first number of configurable elements is greater than or equal to the second number of configurable elements.

Aspect 18 is the method of any of aspects 11 to 17, wherein the first interference-direction sensing operation is associated with a first set of resources that is disjoint from a second set of resources associated with the wireless communication between the network device and the UE.

Aspect 19 is the method of any of aspects 11 to 18, further comprising: obtaining, from the intermediate wireless device and based on a set of interference statistics collected by the intermediate wireless device, additional information regarding at least one of the set of interference statistics associated with the intermediate wireless device or a recommended configuration of the intermediate wireless device based on the set of interference statistics, wherein the first set of configurations is based on the additional information.

Aspect 20 is the method of any of aspects 11, 18, and 19, wherein: the decreased signal quality at the UE is associated with a first configuration of the plurality of configurable elements, the first configuration is associated with a first main lobe for reception from the network device directed towards the network device and a first set of side lobes for reception directed in a first set of directions corresponding to the first set of side lobes, and the first set of configurations comprises one or more configurations associated with a second main lobe for reception in a reception direction in the first set of directions and a third main lobe for outputting a received signal in an output direction towards the network device.

Aspect 21 is the method of any of aspects 11 to 20, further comprising: obtaining interferer information regarding one or more of possible interference signals or possible interference sources, wherein the first set of configurations is based on the interferer information regarding one or more of the possible interference signals or the possible interference sources.

Aspect 22 is the method of any of aspects 11 to 21, further comprising: transmitting the subsequent communication between the network device and the UE with an increased power.

Aspect 23 is a method of wireless communication at a user equipment (UE), comprising: obtaining, based on a decreased signal quality at the UE, a first set of configurations of a plurality of configurable elements of an intermediate wireless device for a first interference-direction sensing operation; measuring, based on the first set of configurations and during the first interference-direction sensing operation, a received signal quality of a communication associated with the first set of configurations, wherein the communication is between a network device and the UE via the intermediate wireless device; and outputting an indication of the received signal quality.

Aspect 24 is the method of aspect 23, wherein: the decreased signal quality at the UE is associated with a first configuration of the plurality of configurable elements, the first configuration is associated with a first main lobe for reception from the network device directed towards the network device and a first set of side lobes for reception directed in a first set of directions corresponding to the first set of side lobes, and the first set of configurations comprises one or more configurations associated with a second main lobe for reception directed in a direction in the first set of directions and a third main lobe for outputting a received signal in an output direction towards the UE.

Aspect 25 is the method of aspect 23, wherein: the decreased signal quality at the UE is associated with a first configuration of the plurality of configurable elements, the first configuration is associated with a first main lobe for reception from the network device directed towards the network device and a first set of side lobes for reception directed in a first set of directions corresponding to the first set of side lobes, and the first set of configurations comprises one or more configurations associated with a second main lobe for reception directed to the network device and at least one null for reception in a direction in the first set of directions and a third main lobe for outputting a received signal in an output direction towards the UE.

Aspect 26 is the method of aspect 23, further comprising: receiving a subsequent communication from the network device via the intermediate wireless device configured based on the indication of the received signal quality.

Aspect 27 is an apparatus for wireless communication at a device including a memory and at least one processor coupled to the memory and, based at least in part on information stored in the memory, the at least one processor is configured to implement any of aspects 1 to 10.

Aspect 28 is the apparatus of aspect 27, further including a transceiver or an antenna coupled to the at least one processor.

Aspect 29 is an apparatus for wireless communication at a device including means for implementing any of aspects 1 to 10.

Aspect 30 is a computer-readable medium (e.g., a non-transitory computer-readable medium) storing computer executable code, where the code when executed by a processor causes the processor to implement any of aspects 1 to 10.

Aspect 31 is an apparatus for wireless communication at a device including a memory and at least one processor coupled to the memory and, based at least in part on information stored in the memory, the at least one processor is configured to implement any of aspects 11 to 22.

Aspect 32 is the apparatus of aspect 31, further including a transceiver or an antenna coupled to the at least one processor.

Aspect 33 is an apparatus for wireless communication at a device including means for implementing any of aspects 11 to 22.

Aspect 34 is a computer-readable medium (e.g., a non-transitory computer-readable medium) storing computer executable code, where the code when executed by a processor causes the processor to implement any of aspects 11 to 22.

Aspect 35 is an apparatus for wireless communication at a device including a memory and at least one processor coupled to the memory and, based at least in part on information stored in the memory, the at least one processor is configured to implement any of aspects 23 to 26.

Aspect 36 is the apparatus of aspect 35, further including a transceiver or an antenna coupled to the at least one processor.

Aspect 37 is an apparatus for wireless communication at a device including means for implementing any of aspects 23 to 26.

Aspect 38 is a computer-readable medium (e.g., a non-transitory computer-readable medium) storing computer executable code, where the code when executed by a processor causes the processor to implement any of aspects 23 to 26.

What is claimed is:

1. An apparatus for wireless communication at an intermediate wireless device, comprising:
at least one memory; and
at least one processor coupled to the at least one memory and, based at least in part on stored information that is stored in the at least one memory, the at least one processor, individually or in any combination, is configured to:
obtain, based on a decreased signal quality at a user equipment (UE), a first set of configurations of a plurality of configurable elements of the intermediate wireless device for a first interference-direction sensing operation;
perform, based on the first set of configurations of the plurality of configurable elements, the first interference-direction sensing operation; and
obtain an indication of a configuration of the plurality of configurable elements for a subsequent communication between a network device and the UE based on the first interference-direction sensing operation.

2. The apparatus of claim 1, wherein:
the decreased signal quality at the UE is associated with a first configuration of the plurality of configurable elements,
the first configuration is associated with a first main lobe for reception from the network device directed towards the network device and a first set of side lobes for reception directed in a first set of directions corresponding to the first set of side lobes, and
the first set of configurations comprises one or more configurations associated with a second main lobe for reception directed in a direction in the first set of directions.

3. The apparatus of claim 2, wherein the one or more configurations are further associated with one of:
directing a received interfering signal to the UE for a measurement at the UE,
directing the received interfering signal to the network device for the measurement at the network device, or
measuring the received interfering signal at the intermediate wireless device, and wherein obtaining the indication of the configuration of the plurality of configurable elements for the subsequent communication is based on the measurement of the received interfering signal.

4. The apparatus of claim 1, wherein:
the decreased signal quality at the UE is associated with a first configuration of the plurality of configurable elements,
the first configuration is associated with a first main lobe for reception from the network device directed towards the network device and a first set of side lobes for reception directed in a first set of directions corresponding to the first set of side lobes, and
the first set of configurations comprises one or more configurations associated with a second main lobe for reception directed to the network device and at least one null for reception in a direction in the first set of directions.

5. The apparatus of claim 4, wherein the one or more configurations are further associated with one of:
directing a received signal to the UE for measurement at the UE, or
measuring the received signal at the intermediate wireless device, and wherein obtaining the indication of the configuration of the plurality of configurable elements for the subsequent communication is based on the measurement of the received signal.

6. The apparatus of claim 1, wherein the first set of configurations is for a first subset of the plurality of configurable elements comprising an array of configurable antenna elements of the intermediate wireless device, and the at least one processor, individually or in any combination, is further configured to:
obtain, based on the first interference-direction sensing operation and for a second interference-direction sensing operation, a second set of configurations of a second subset of the plurality of configurable elements comprising an array of configurable reflective or refractive elements of the intermediate wireless device; and
perform, based on the second set of configurations, the second interference-direction sensing operation, wherein the indication of the configuration of the plurality of configurable elements is further based on the second interference-direction sensing operation.

7. The apparatus of claim 1, wherein the intermediate wireless device is a repeating device and the plurality of configurable elements comprises a plurality of antenna elements, wherein at least one configuration in the first set of configurations of the plurality of configurable elements is for a first number of configurable elements and the configuration of the plurality of configurable elements for the subsequent communication is for a second number of configurable elements, wherein the first number of configurable elements is greater than or equal to the second number of configurable elements.

8. The apparatus of claim 1, wherein the first interference-direction sensing operation is associated with a first set of resources that is disjoint from a second set of resources associated with the wireless communication between the network device and the UE.

9. The apparatus of claim 1, further comprising a transceiver coupled to the at least one processor, wherein the at least one processor, individually or in any combination, is further configured to:
collect, prior to the decreased signal quality at the UE, a set of interference statistics associated with the intermediate wireless device; and
provide, to the network device via the transceiver, information regarding at least one of the set of interference statistics associated with the intermediate wireless device or a recommended configuration of the intermediate wireless device based on the set of interference statistics, wherein the first set of configurations is based on the information.

10. The apparatus of claim 1, wherein:
the decreased signal quality at the UE is associated with a first configuration of the plurality of configurable elements,
the first configuration is associated with a first main lobe for reception from the network device directed towards the network device and a first set of side lobes for reception directed in a first set of directions corresponding to the first set of side lobes, and
the first set of configurations comprises one or more configurations associated with a second main lobe for reception in a reception direction in the first set of directions and a third main lobe for outputting a received signal in an output direction towards the network device.

11. An apparatus for wireless communication at a network device, comprising:
at least one memory; and
at least one processor coupled to the at least one memory and, based at least in part on stored information that is stored in the at least one memory, the at least one processor, individually or in any combination, is configured to:
output, based on a decreased signal quality at a user equipment (UE), a first set of configurations of a plurality of configurable elements of an intermediate wireless device for a first interference-direction sensing operation;
obtain, based on the first interference-direction sensing operation, information regarding a directionality of an interfering signal associated with the decreased signal quality at the UE; and
output, based on the information regarding the directionality of the interfering signal, an indication of a configuration of the plurality of configurable elements for a subsequent communication between the network device and the UE via the intermediate wireless device.

12. The apparatus of claim 11, wherein:
the decreased signal quality at the UE is associated with a first configuration of the plurality of configurable elements,
the first configuration is associated with a first main lobe for reception from the network device directed towards the network device and a first set of side lobes for reception directed in a first set of directions corresponding to the first set of side lobes, and
the first set of configurations comprises one or more configurations associated with a second main lobe for reception directed in a direction in the first set of directions.

13. The apparatus of claim 12, wherein the one or more configurations are further associated with one of:
directing a received interfering signal to the UE for measurement at the UE,
directing the received interfering signal to the network device for the measurement at the network device, or
measuring the received interfering signal at the intermediate wireless device, and wherein obtaining (outputting) the indication of the configuration of the plurality of configurable elements for the subsequent communication is based on the measurement of the received interfering signal.

14. The apparatus of claim 11, wherein:
the decreased signal quality at the UE is associated with a first configuration of the plurality of configurable elements,
the first configuration is associated with a first main lobe for reception from the network device directed towards the network device and a first set of side lobes for reception directed in a first set of directions corresponding to the first set of side lobes, and
the first set of configurations comprises one or more configurations associated with a second main lobe for reception directed to the network device and at least one null for reception in a direction in the first set of directions.

15. The apparatus of claim 14, wherein the one or more configurations are further associated with one of:
directing a received signal to the UE for measurement at the UE, or
measuring the received signal at the intermediate wireless device, and wherein obtaining the indication of the configuration of the plurality of configurable elements for the subsequent communication is based on the measurement of the received signal.

16. The apparatus of claim 11, wherein the first set of configurations is for a first subset of the plurality of configurable elements comprising an array of configurable antenna elements of the intermediate wireless device, and the at least one processor, individually or in any combination, is further configured to:
output, based on the first interference-direction sensing operation and for a second interference-direction sensing operation, a second set of configurations of a second subset of the plurality of configurable elements comprising an array of configurable reflective or refractive elements of the intermediate wireless device; and
obtain, based on the second set of configurations, the second interference-direction sensing operation, wherein the indication of the configuration of the plurality of configurable elements is further based on the second interference-direction sensing operation.

17. The apparatus of claim 11, wherein the intermediate wireless device is a repeating device and the plurality of configurable elements comprises a plurality of antenna elements, wherein at least one configuration in the first set of configurations of the plurality of configurable elements is for a first number of configurable elements and the configuration of the plurality of configurable elements for the subsequent communication is for a second number of configurable elements, wherein the first number of configurable elements is greater than or equal to the second number of configurable elements.

18. The apparatus of claim 11, wherein the first interference-direction sensing operation is associated with a first set of resources that is disjoint from a second set of resources associated with the wireless communication between the network device and the UE.

19. The apparatus of claim 11, wherein the at least one processor, individually or in any combination, is further configured to:
obtain, from the intermediate wireless device and based on a set of interference statistics collected by the intermediate wireless device, additional information regarding at least one of the set of interference statistics associated with the intermediate wireless device or a recommended configuration of the intermediate wireless device based on the set of interference statistics, wherein the first set of configurations is based on the additional information.

20. The apparatus of claim 11, wherein:
the decreased signal quality at the UE is associated with a first configuration of the plurality of configurable elements,
the first configuration is associated with a first main lobe for reception from the network device directed towards the network device and a first set of side lobes for reception directed in a first set of directions corresponding to the first set of side lobes, and
the first set of configurations comprises one or more configurations associated with a second main lobe for reception in a reception direction in the first set of directions and a third main lobe for outputting a received signal in an output direction towards the network device.

21. The apparatus of claim 11, wherein the at least one processor, individually or in any combination, is further configured to:
obtain interferer information regarding one or more of possible interference signals or possible interference sources, wherein the first set of configurations is based on the interferer information regarding one or more of the possible interference signals or the possible interference sources.

22. The apparatus of claim 11, further comprising a transceiver coupled to the at least one processor, wherein the at least one processor, individually or in any combination, is further configured to:
transmit, via the transceiver, the subsequent communication between the network device and the UE with an increased power.

23. An apparatus for wireless communication at a user equipment (UE), comprising:
at least one memory; and
at least one processor coupled to the at least one memory and, based at least in part on stored information that is stored in the at least one memory, the at least one processor, individually or in any combination, is configured to:
obtain, based on a decreased signal quality at the UE, a first set of configurations of a plurality of configurable elements of an intermediate wireless device for a first interference-direction sensing operation;
measure, based on the first set of configurations and during the first interference-direction sensing operation, a received signal quality of a communication associated with the first set of configurations, wherein the communication is between a network device and the UE via the intermediate wireless device; and
output an indication of the received signal quality.

24. The apparatus of claim 23, wherein:
the decreased signal quality at the UE is associated with a first configuration of the plurality of configurable elements,
the first configuration is associated with a first main lobe for reception from the network device directed towards the network device and a first set of side lobes for reception directed in a first set of directions corresponding to the first set of side lobes, and
the first set of configurations comprises one or more configurations associated with a second main lobe for reception directed in a direction in the first set of directions and a third main lobe for outputting a received signal in an output direction towards the UE.

25. The apparatus of claim 23, wherein:
the decreased signal quality at the UE is associated with a first configuration of the plurality of configurable elements,
the first configuration is associated with a first main lobe for reception from the network device directed towards the network device and a first set of side lobes for reception directed in a first set of directions corresponding to the first set of side lobes, and
the first set of configurations comprises one or more configurations associated with a second main lobe for reception directed to the network device and at least one null for reception in a direction in the first set of directions and a third main lobe for outputting a received signal in an output direction towards the UE.

26. The apparatus of claim 23, further comprising a transceiver coupled to the at least one processor, wherein the at least one processor, individually or in any combination, is further configured to:
receive, via the transceiver, a subsequent communication from the network device via the intermediate wireless device configured based on the indication of the received signal quality.

27. A method of wireless communication at an intermediate wireless device, comprising:
obtaining, based on a decreased signal quality at a user equipment (UE), a first set of configurations of a plurality of configurable elements of the intermediate wireless device for a first interference-direction sensing operation;
performing, based on the first set of configurations of the plurality of configurable elements, the first interference-direction sensing operation; and
obtaining an indication of a configuration of the plurality of configurable elements for a subsequent communication between a network device and the UE based on the first interference-direction sensing operation.

28. The method of claim 27, wherein:
the decreased signal quality at the UE is associated with a first configuration of the plurality of configurable elements,
the first configuration is associated with a first main lobe for reception from the network device directed towards the network device and a first set of side lobes for reception directed in a first set of directions corresponding to the first set of side lobes, and
the first set of configurations comprises one or more configurations associated with a second main lobe for reception directed in a direction in the first set of directions.

29. The method of claim 27, wherein:
the decreased signal quality at the UE is associated with a first configuration of the plurality of configurable elements,
the first configuration is associated with a first main lobe for reception from the network device directed towards the network device and a first set of side lobes for reception directed in a first set of directions corresponding to the first set of side lobes, and
the first set of configurations comprises one or more configurations associated with a second main lobe for reception directed to the network device and at least one null for reception in a direction in the first set of directions.

30. The method of claim 27, wherein the first set of configurations is for a first subset of the plurality of configurable elements comprising an array of configurable antenna elements of the intermediate wireless device, further comprising:
obtaining, based on the first interference-direction sensing operation and for a second interference-direction sensing operation, a second set of configurations of a second subset of the plurality of configurable elements comprising an array of configurable reflective or refractive elements of the intermediate wireless device; and
performing, based on the second set of configurations, the second interference-direction sensing operation, wherein the indication of the configuration of the plurality of configurable elements is further based on the second interference-direction sensing operation.
